(19) United States
(12) Patent Application Publication
(10) Pub. No.: US 2023/0061531 A1
(43) Pub. Date: Mar. 2, 2023

(54) SYSTEMS AND METHODS FOR CIRCULATING ELECTROLYTE AND ELECTRIC CURRENT IN SERIES COUPLED REDOX FLOW BATTERY CELLS

(71) Applicant: ESS TECH, INC., Wilsonville, OR (US)

(72) Inventors: Yang Song, West Linn, OR (US); Craig Evans, West Linn, OR (US)

(21) Appl. No.: 17/816,256

(22) Filed: Jul. 29, 2022

Related U.S. Application Data
(60) Provisional application No. 63/260,794, filed on Aug. 31, 2021.

(51) Int. Cl. H01M 8/18; H01M 8/04082

(52) U.S. Cl. CPC H01M 8/188; H01M 8/04201

(57) ABSTRACT

Systems and methods are provided for electrolyte and current circulation in a redox flow battery system. In one example, the redox flow battery system may include a plurality of redox flow battery cells electrically coupled in series. In this way, a potential difference across the plurality of redox flow battery cells may be ramped up, such that relatively high voltage external loads may be powered by the redox flow battery system. In some examples, each of the plurality of redox flow battery cells may be fluidically isolated from one another. As such, in one example, the redox flow battery system may further include a plurality of electrolyte storage tanks respectively fluidically coupled to the plurality of redox flow battery cells. Such fluidic isolation of each of the plurality of redox flow battery cells may eliminate stack-to-stack shunting in the redox flow battery system, as well as improve a modularity thereof.

### CROSS REFERENCE TO RELATED APPLICATIONS

The present application claims priority to U.S. Provisional Application No. 63/260,794 entitled “SYSTEMS AND METHODS FOR CIRCULATING ELECTROLYTE AND ELECTRIC CURRENT IN SERIES COUPLED REDOX FLOW BATTERY CELLS” filed Aug. 31, 2021. The entire contents of the above identified application is hereby incorporated by reference for all purposes.

### FIELD

The present description relates generally to systems and methods for circulating, rebalancing, and storing an electrolyte in a plurality of series coupled redox flow battery cells and for circulating an electric current between the plurality of series coupled redox flow battery cells and an external load, and more particularly, between the plurality of series coupled redox flow battery cells and an electrical grid.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e⁻↔½H₂ (proton reduction) (1)

Fe⁰+2H⁺↔Fe²⁺+H₂ (iron corrosion) (2)

2Fe³⁺+Fe⁰↔3Fe²⁺ (iron plating oxidation) (3)

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe′) from equation (3) and ion crossover via equation (4):

Fe³⁺+½H₂→Fe²⁺+H⁺ (electrolyte rebalancing) (4)

In some examples, the electrolyte rebalancing of equation (4) may be realized via a fuel cell setup, wherein the H₂ gas and the electrolyte may be contacted at catalyst surfaces while applying a direct current (DC) across positive and negative electrode pairs. However, reliability issues may arise in fuel cells as a result of inadvertent reverse current spikes interrupting DC flow. In other examples, a trickle bed or jelly roll reactor setup may similarly contact the H₂ gas and the electrolyte at catalyst surfaces. However, lower Fe³⁺ reduction rates of such setups may result in insufficiently rebalanced electrolyte during higher performance IFB operation, and a source of H₂ gas may be provided to supply excess (H₂ gas) reductant of equation (4). The source of H₂ gas may include a standalone H₂ gas storage tank and/or a head space storing H₂ gas directly above or physically partitioned from the electrolyte in an electrolyte storage tank. In either case, to supply the H₂ gas reductant in sufficient excess to overcome the lower Fe³⁺ reduction rates, the H₂ gas and/or electrolyte storage tank may be rated for relatively high pressures, e.g., up to an upper threshold gauge pressure, such as 20 psi. As such, the H₂ gas and/or electrolyte storage tank may be relatively expensive to manufacture in order to meet such pressure specifications. Further, such high pressures may limit an overall shape and configuration of the H₂ gas and/or electrolyte storage tank. For example, high-pressure storage tanks are typically configured as cylindrical storage tanks, which may have relatively low packing densities and may therefore be less space effective for IFBs having rectangular prismatic or cuboidal components (e.g., outer casings, cell assembly stacks, etc.). Specifically, sides and ends of the (cylindrical) H₂ gas and/or electrolyte storage tanks may include rounded corners and/or edges (e.g., in order to withstand hydrostatically induced pressure of contained gases), which may physically limit the packing densities of such H₂ gas and/or electrolyte storage tanks.

In some examples, each cell assembly stack of the IFB may be fluidically coupled to the electrolyte storage tank. Each cell assembly stack may further charge and discharge in parallel within an operating voltage range (e.g., from 40 to 75 V). When electrically coupling the IFB to an external load, such as an electrical grid, operating in a significantly larger voltage range (e.g., up to 1000 V), boost converters may be installed between each cell assembly stack and the external load to step up the voltage generated by each cell assembly stack. Such boost converters may further increase an overall cost and a complexity of the redox flow battery system. Further, stack-to-stack shunting via the electrolyte may arise during operation of the redox flow battery system as a result of each cell assembly stack being fluidically coupled to each other cell assembly stack (e.g., via the electrolyte storage tank or shared pipelines fluidically coupling the cell assembly stacks to the electrolyte storage tank).

In one example, the issues described above may be addressed by a redox flow battery system, including a plurality of redox flow battery cells electrically coupled in series, such that each of the plurality of redox flow battery cells may be directly electrically coupled to at least one adjacent redox flow battery cell, wherein each of the plurality of redox flow battery cells comprises positive and negative electrode compartments respectively housing redox and plating electrodes. In this way, a potential difference may be ramped up across the plurality of redox flow battery cells such that relatively high voltage external loads may be powered by the redox flow battery system without expensive or complex circuit arrangements including boost converters. In some examples, the redox flow battery system may further include a plurality of electrolyte storage tanks respectively fluidically coupled to the plurality of redox flow battery cells (e.g., to the positive and negative electrode compartments thereof), such that each of the plurality of redox flow battery cells may be fluidically isolated from each other of the plurality of redox flow battery cells. Configuring the redox flow battery system in this way may improve a modularity thereof, such that further redox flow battery cells (e.g., in respective fluidic communication with further electrolyte storage tanks) may be electrically coupled in series with the plurality of redox flow battery cells. Further, fluidic isolation of each of the plurality of redox flow battery cells may eliminate stack-to-stack shunting in the redox flow battery system.

In some examples, each of the plurality of electrolyte storage tanks may further be respectively fluidically coupled to a plurality of rebalancing cells configured to perform electrolyte rebalancing at relatively high Fe³⁺ reduction rates under relatively low partial pressures of H₂ gas (e.g., as low as 25%). In this way, an amount of H₂ gas supplied to each of the plurality of rebalancing cells may be significantly less than for typical rebalancing cell setups and each of the plurality of electrolyte storage tanks may therefore continually operate below 2 psi. Accordingly, costs in manufacturing the plurality of electrolyte storage tanks may be less than for electrolyte storage tanks rated for higher pressure ranges (as the plurality of prismatic electrolyte storage tanks may be constructed with materials and shapes limited to relatively low upper threshold gauge pressures, such as 2 psi or less, in some examples). Further, each of the plurality of electrolyte storage tanks may be configured with increased packing density compared to typical (e.g., relatively large non-prismatic/curvilinear) electrolyte and/or hydrogen gas storage tank configurations.

In some examples, to achieve relatively high rebalancing performance with relatively low amounts of H₂ gas, a rebalancing cell (e.g., one of the plurality of rebalancing cells described above) may include a stack of electrode assemblies, each electrode assembly including positive and negative electrodes in face-sharing contact with one another such that the positive and negative electrodes may be continuously electrically conductive (e.g., at surfaces of the positive and negative electrodes in face-sharing contact). In additional or alternative examples, no electric current may be directed away from the rebalancing cell. In this way, electrolyte rebalancing in the rebalancing cell may be driven via internal electrical shorting of interfacing pairs of the positive and negative electrodes therein. Further, in some examples, the rebalancing cell may be configured to draw each of the liquid electrolyte and H₂ gas (e.g., via forced convection, gravity feeding, capillary action, etc.) therethrough. By managing electrolyte and H₂ gas flows in this way, in combination with the internal electrical shorting, the Fe³⁺ reduction rate of the rebalancing cell may be significantly improved over typical rebalancing cell setups (e.g., by a factor of 20 or more).

Further, in some examples, by internally shorting the interfacing pairs of the positive and negative electrodes in the rebalancing cell, each electrode assembly of the stack of electrode assemblies may be electrically decoupled from one another, such that no reverse electric current may be driven from one electrode assembly through the stack of electrode assemblies and degrade other electrode assemblies. In additional or alternative examples, internal electrical shorting of the interfacing pairs of the positive and negative electrodes may reduce electrical resistance relative to non-internally shorted electrode pairs and thereby increase respective redox reaction rates at the positive and negative electrodes. A cell potential of each electrode assembly may be concomitantly reduced, decreasing side reaction rates (e.g., rates of the reactions of equations (1)-(3)) therewith. In this way, both useful life and electrochemical performance may be improved in the rebalancing cell relative to a non-internally shorted cell.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a battery cell with redox and plating electrodes fluidically coupled to respective rebalancing reactors.

FIGS. 2A and 2B show perspective views of a rebalancing cell including a stack of internally shorted electrode assemblies.

FIG. 3 shows an exploded view of an electrode assembly for the rebalancing cell of FIGS. 2A and 2B.

FIGS. 4A and 4B show a cross-sectional view and a magnified inset view, respectively, of H₂ gas flow in the rebalancing cell of FIGS. 2A and 2B.

FIGS. 5A-5D show schematic views of respective exemplary flow field configurations for convecting H₂ gas across negative electrodes of a rebalancing cell, such as the rebalancing cell of FIGS. 2A and 2B.

FIGS. 6A and 6B show a cross-sectional view and a magnified inset view, respectively, of electrolyte flow in the rebalancing cell of FIGS. 2A and 2B.

FIGS. 7A and 7B show perspective views of electrolyte flow in an exemplary electrode assembly of a rebalancing cell, such as the rebalancing cell of FIGS. 2A and 2B.

FIGS. 8A-8C show perspective views of an exemplary flow field plate of an electrode assembly of a rebalancing cell, such as the rebalancing cell of FIGS. 2A and 2B.

FIG. 8D shows a cross-sectional view of the flow field plate of FIGS. 8A-8C.

FIGS. 9A and 9B show perspective views of an exemplary sloped support for tilting a cell enclosure of a rebalancing cell, as the rebalancing cell of FIGS. 2A and 2B.

FIG. 10 shows a plot of Fe³⁺ reduction rate as a function of a total amount of Fe³⁺ reduced for three exemplary rebalancing cells in respective all-iron hybrid redox flow battery systems.

FIG. 11A shows a flow chart of a method for operating a redox flow battery pack electrically coupled to an electrical grid.

FIG. 11B shows a flow chart of a method for circulating electrolyte and H₂ gas through a redox flow battery of a redox flow battery pack.

FIG. 11C shows a flow chart of a method for operating a rebalancing cell of a redox flow battery, the rebalancing cell including a stack of internally shorted electrode assemblies.

FIG. 12 shows a plot of a normalized Fe³⁺ reduction rate as a function of a partial pressure of H₂ gas for an exemplary rebalancing cell in an all-iron hybrid redox flow battery system.

FIGS. 13A-13D show schematic perspective views of respective exemplary electrolyte storage tank configurations for a redox flow battery system, such as the redox flow battery system of FIG. 1.

FIG. 14 shows a first exemplary redox flow battery system, such as the redox flow battery system of FIG. 1, electrically coupled to an electrical grid via a plurality of boost converters and a power inverter.

FIG. 15 shows a second exemplary redox flow battery system, such as the redox flow battery system of FIG. 1, electrically coupled to an electrical grid via a power inverter.

### DETAILED DESCRIPTION

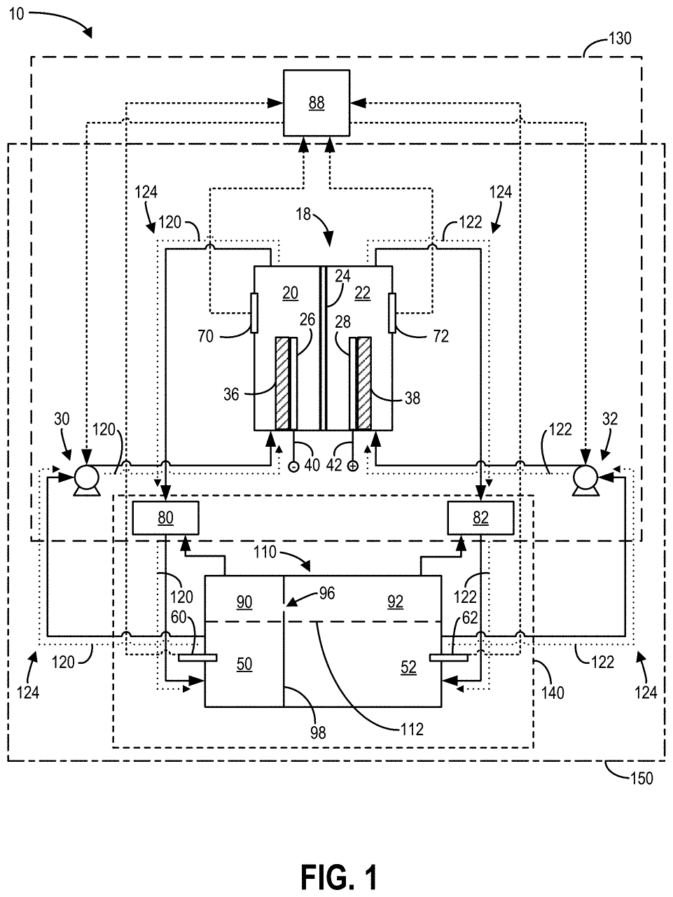

The following description relates to systems and methods for electrolyte distribution, rebalancing, and storage, for example, in a redox flow battery system including a rebalancing cell driven via internal electrical shorting of electrode assemblies included therein, and for electric current circulation between the redox flow battery system and an external load, such as an electrical grid. In an exemplary embodiment, the rebalancing cell may be fluidically coupled to an electrolyte subsystem of the redox flow battery system. The redox flow battery system is depicted schematically in FIG. 1 with an integrated multi-chambered tank having separate positive and negative electrolyte chambers (e.g., for respectively storing positive and negative electrolytes) and respective gas head spaces (e.g., for storing H₂ gas). In some examples, the redox flow battery system may include an all-iron flow battery (IFB) utilizing iron redox chemistry at both a positive (redox) electrode and the negative (plating) electrode of the IFB. The electrolyte chambers may be coupled to one or more battery cells, each cell including the positive and negative electrodes. Therefrom, electrolyte may be pumped through positive and negative electrode compartments respectively housing the positive and negative electrodes.

In some examples, the redox flow battery system may include a hybrid redox flow battery. Hybrid redox flow batteries are redox flow batteries which may be characterized by deposition of one or more electroactive materials as a solid layer on an electrode (e.g., the negative electrode). Hybrid redox flow batteries may, for instance, include a chemical species which may plate via an electrochemical reaction as a solid on a substrate throughout a battery charge process. During battery discharge, the plated species may ionize via a further electrochemical reaction, becoming soluble in the electrolyte. In hybrid redox flow battery systems, a charge capacity (e.g., a maximum amount of energy stored) of the redox flow battery may be limited by an amount of metal plated during battery charge and may accordingly depend on an efficiency of the plating system as well as volume and surface area available for plating.

In some examples, electrolytic imbalances in the redox flow battery system may result from numerous side reactions competing with desired redox chemistry, including hydrogen (H₂) gas generating reactions such as proton reduction and iron corrosion:

H⁺+e⁻↔½H₂ (proton reduction) (1)

Fe⁰+2H⁺↔Fe²⁺+H₂ (iron corrosion) (2)

and charge imbalances from excess ferric iron (Fe³⁺) generated during oxidation of iron plating:

2Fe³⁺+Fe⁰↔3Fe²⁺ (iron plating oxidation) (3)

The reactions of equations (1) to (3) may limit iron plating and thereby decrease overall battery capacity. To address such imbalances, electrolyte rebalancing may be leveraged to both reduce Fe³⁺ and eliminate excess H₂ gas via a single redox reaction:

Fe³⁺+½H₂→Fe²⁺+H⁺(electrolyte rebalancing) (4)

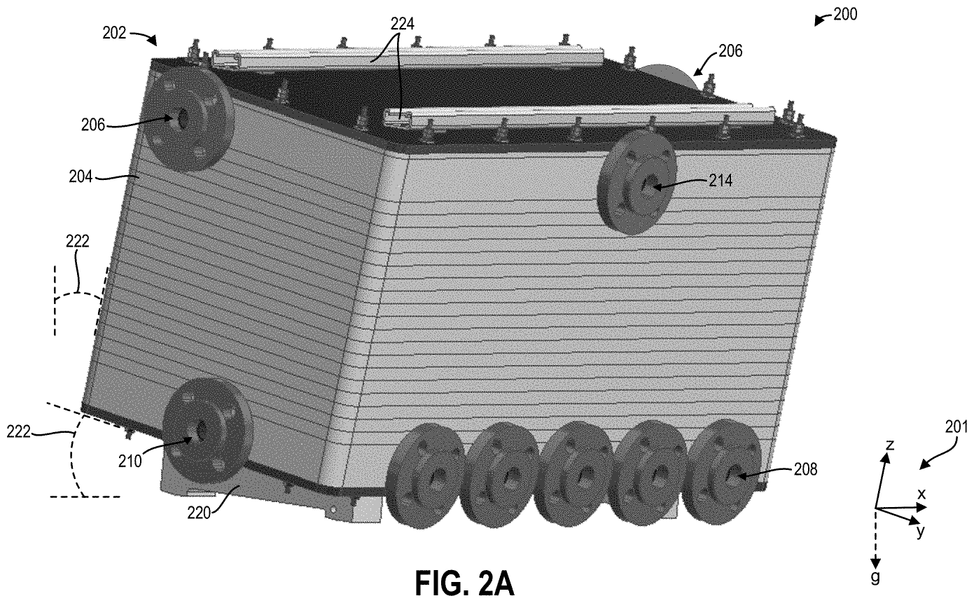

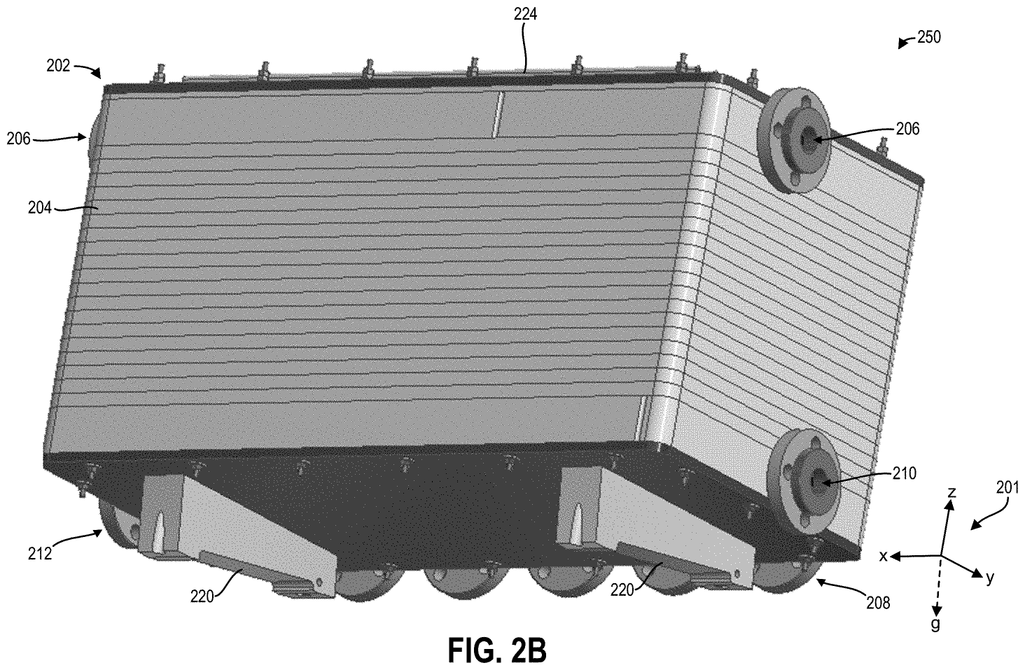

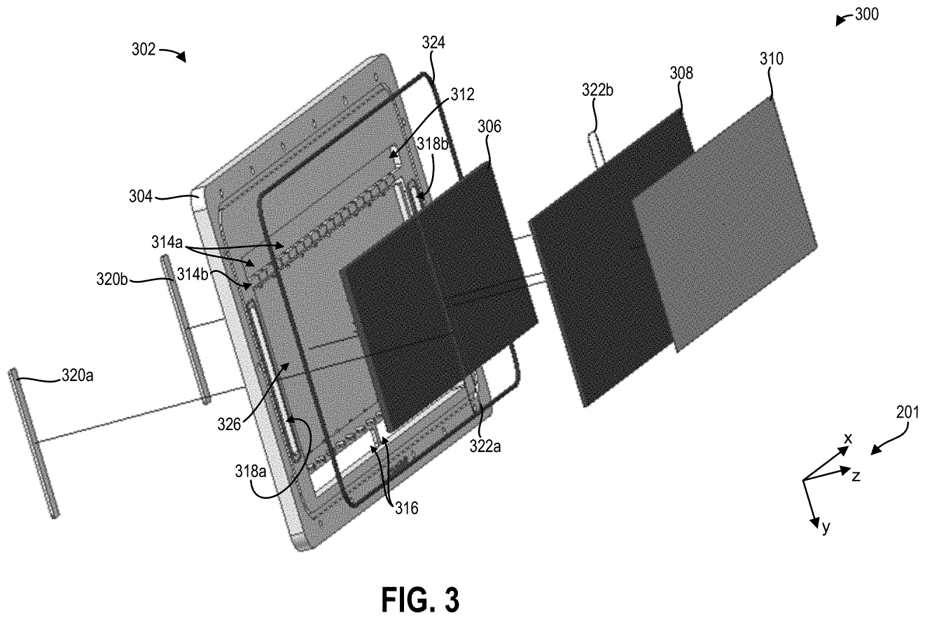

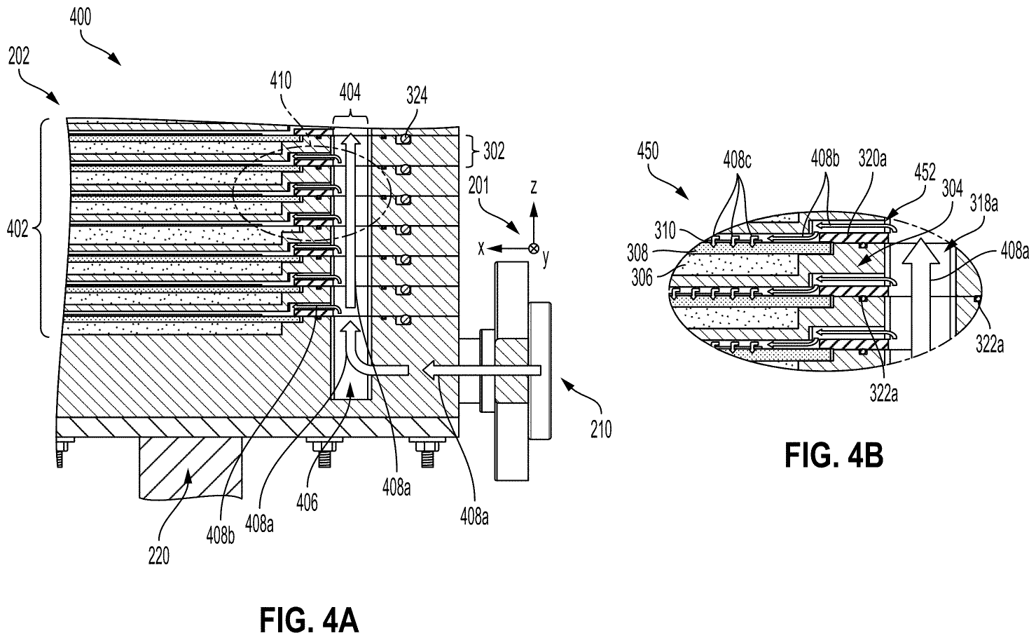

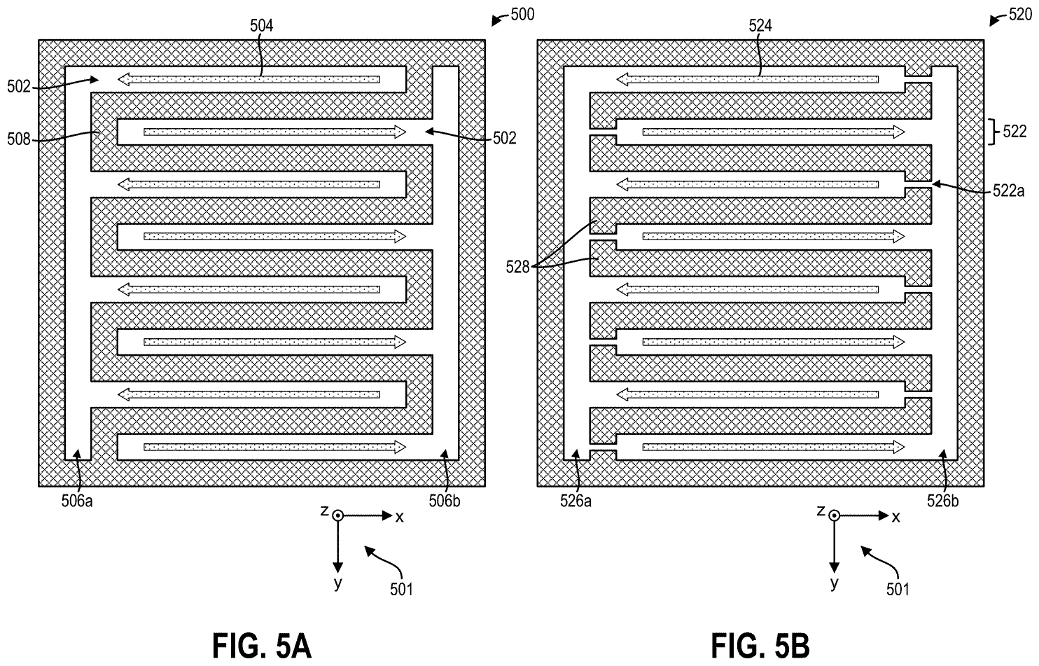

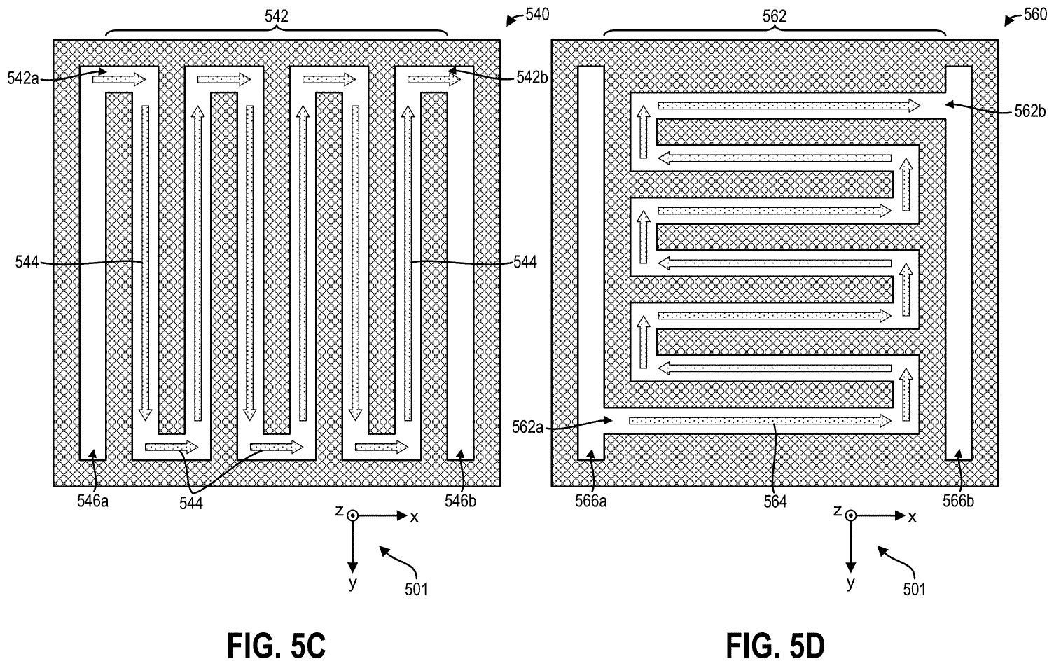

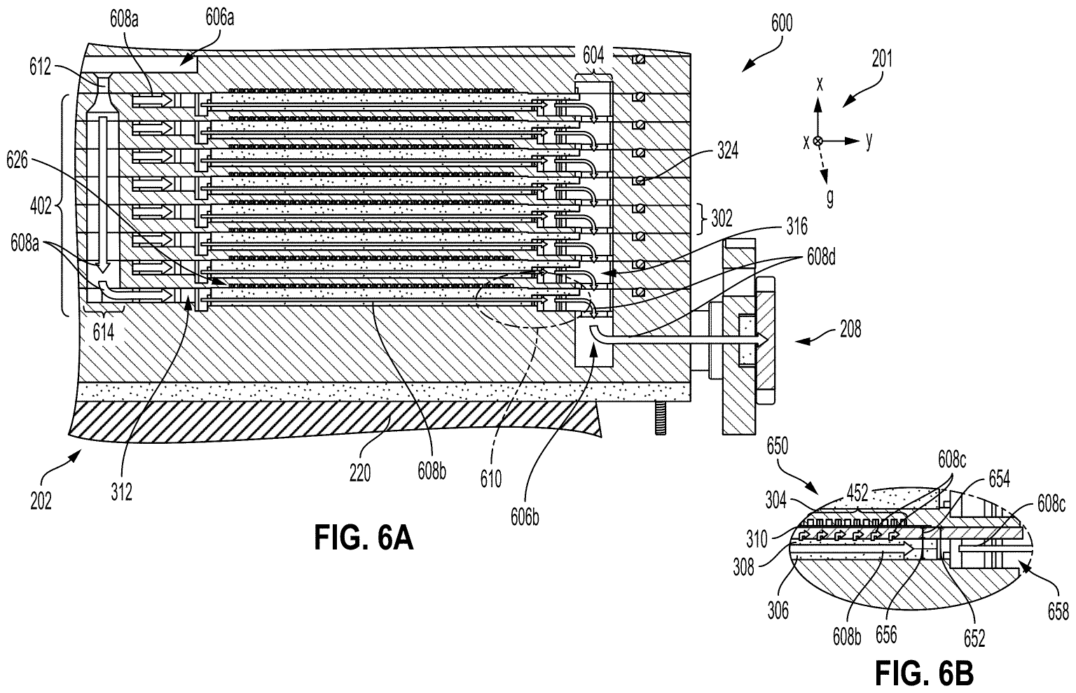

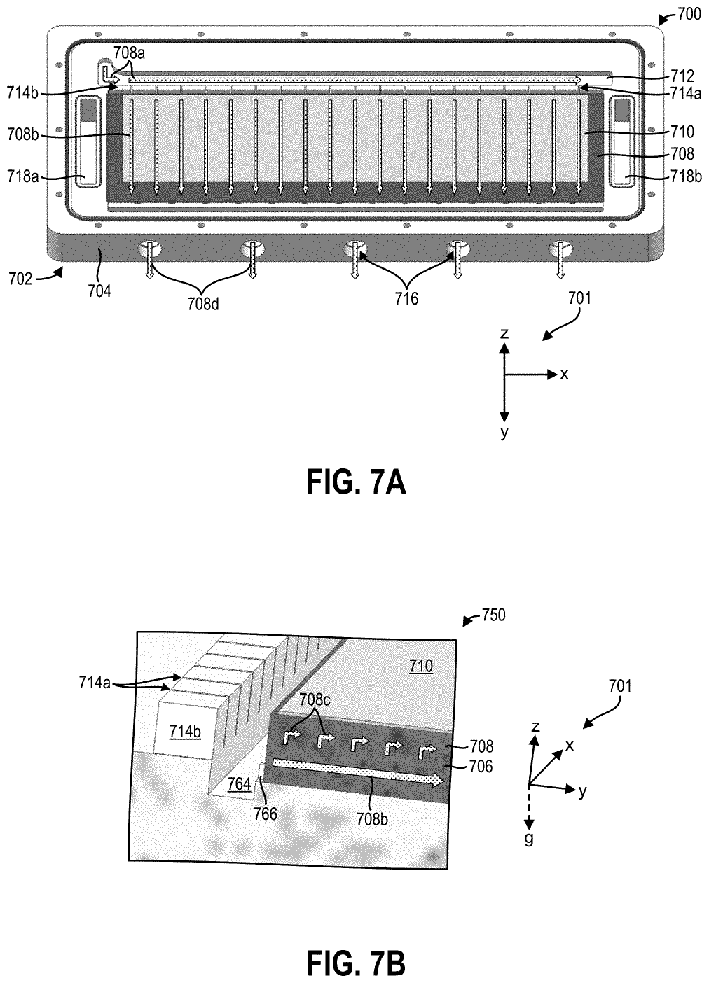

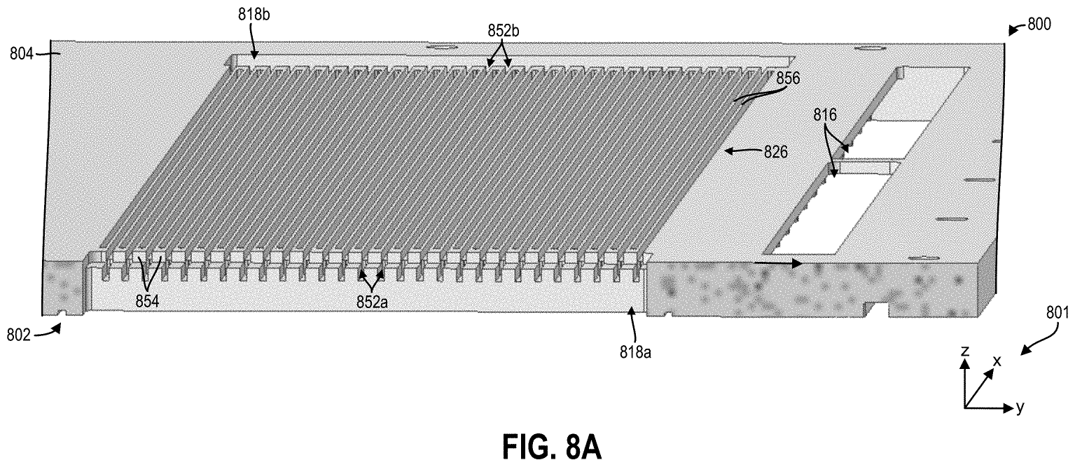

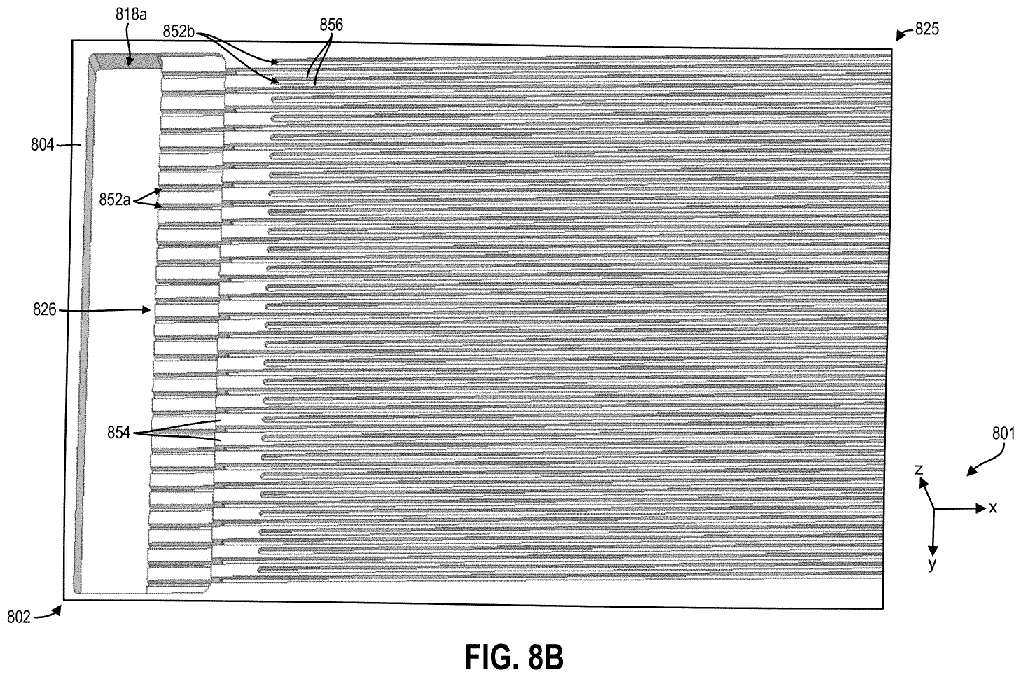

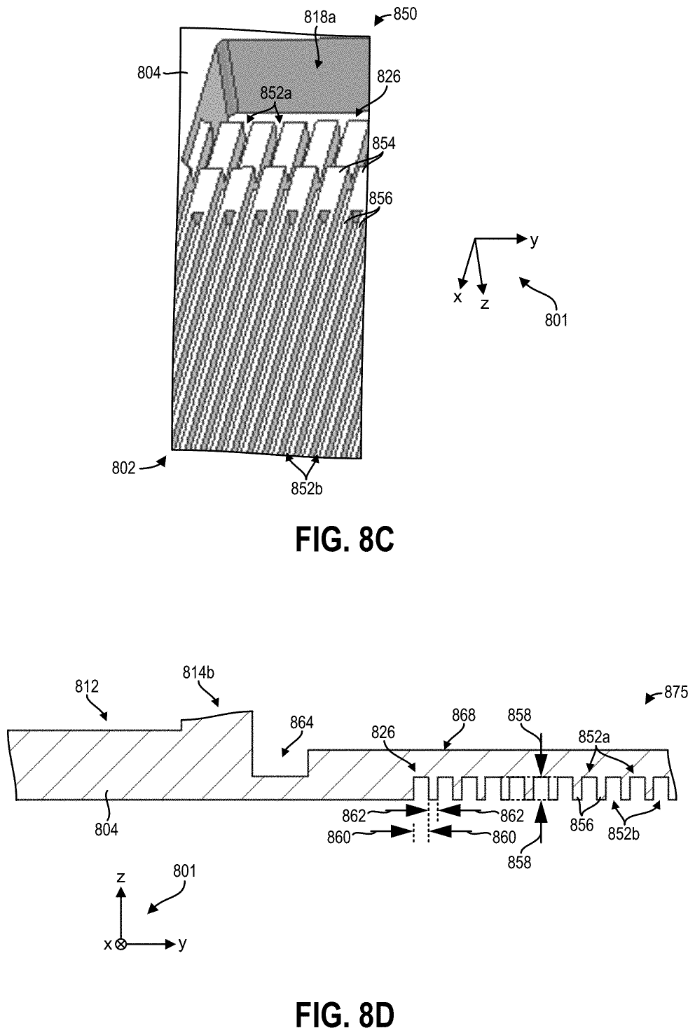

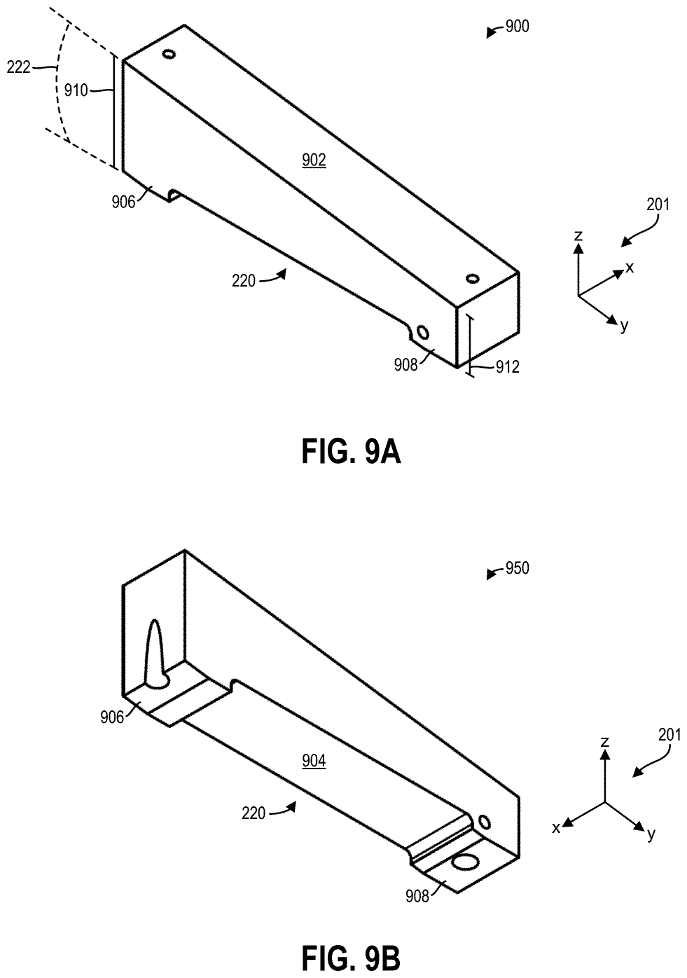

As described by embodiments herein, Fe³⁺ reduction rates sufficient for higher performance applications may be reliably achieved at lower H₂ gas partial pressures via a rebalancing cell, such as the exemplary rebalancing cell of FIGS. 2A and 2B, including a stack of internally shorted electrode assemblies, such as the exemplary electrode assembly of FIG. 3. FIGS. 4A and 4B depict aspects of H₂ gas flow in the rebalancing cell, wherein the H₂ gas may be convected across negative electrodes of the internally shorted electrode assemblies via flow field plates, such as the exemplary flow field plate of FIGS. 8A-8D, including respective flow field configurations, such as the exemplary flow field configurations of FIGS. 5A-5D. Similarly, FIGS. 6A-7B depict aspects of electrolyte flow in the rebalancing cell, wherein the electrolyte may be distributed across positive electrodes of the internally shorted electrode assemblies via a combination of gravity feeding and capillary action (additionally or alternatively, and similar to convection of the H₂ gas across the negative electrodes, the electrolyte may be convected across the positive electrodes via flow field plates, such as the exemplary flow field plate of FIGS. 8A-8D, including respective flow field configurations, such as the exemplary flow field configurations of FIGS. 5A-5D). In some examples, gravity feeding may be assisted by coupling of a sloped support, such as the exemplary sloped support of FIGS. 9A and 9B, to a cell enclosure of the rebalancing cell, such that the cell enclosure may rest on an incline with respect to a direction of gravity.

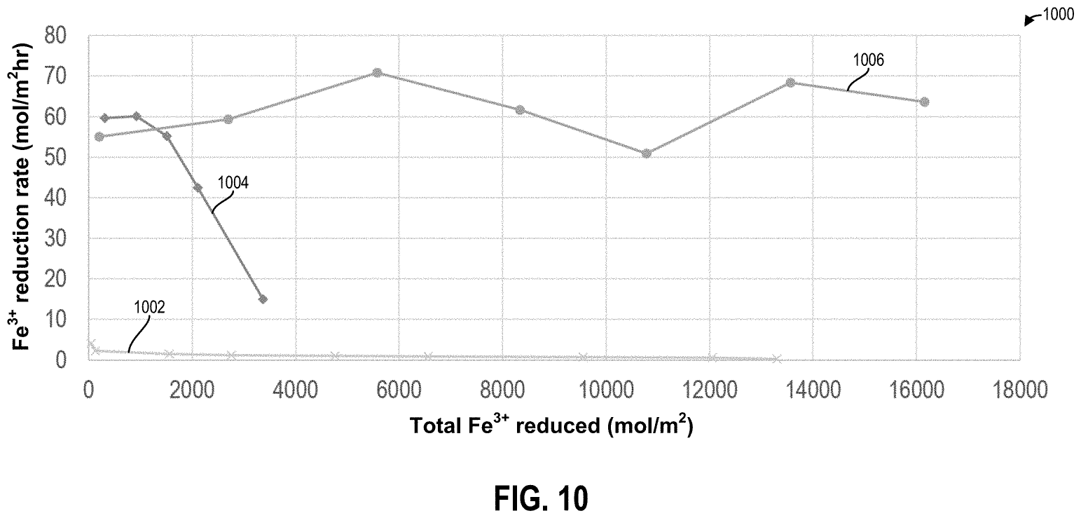

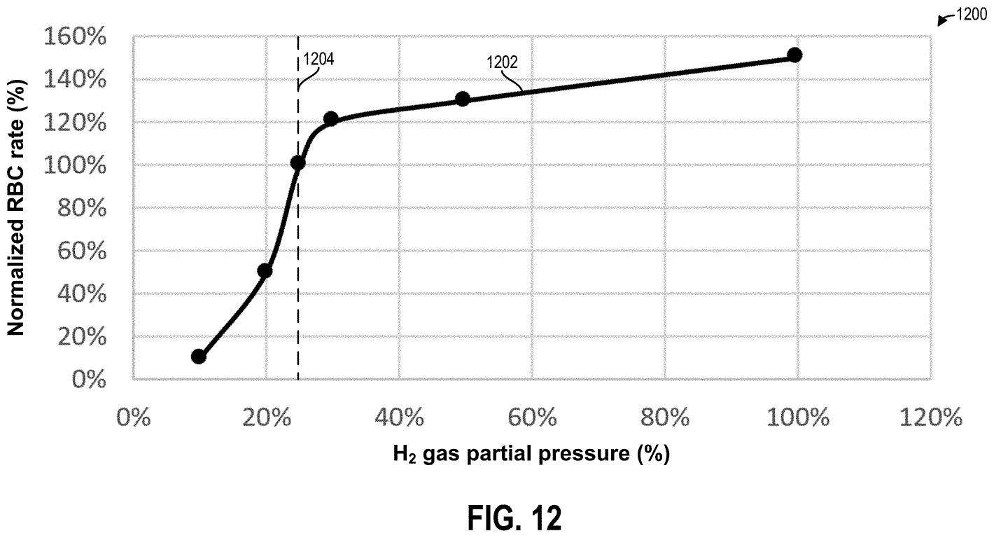

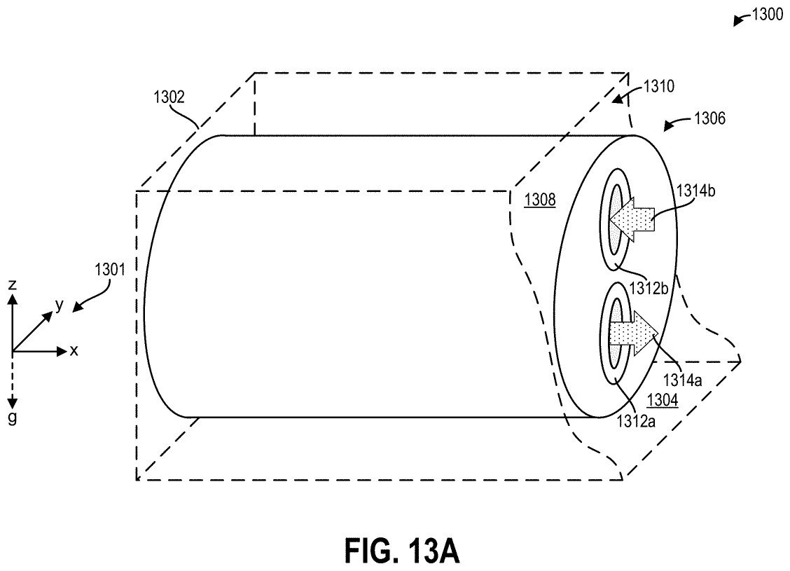

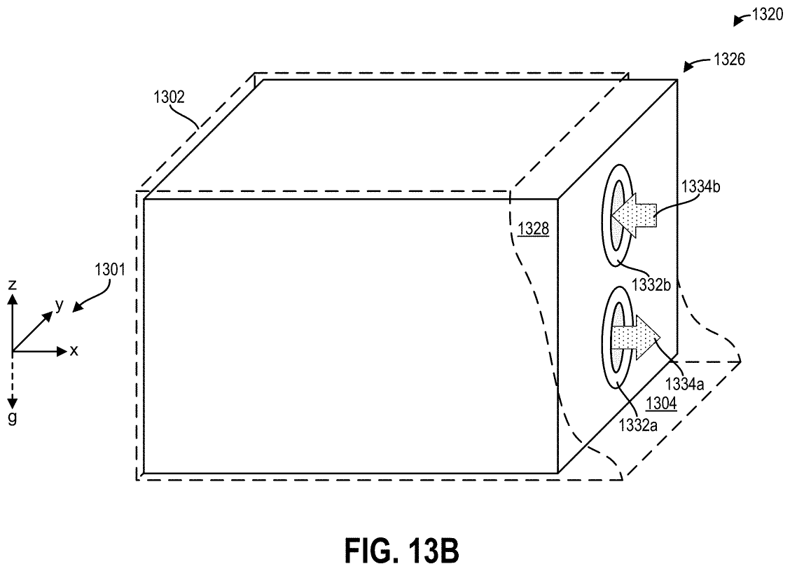

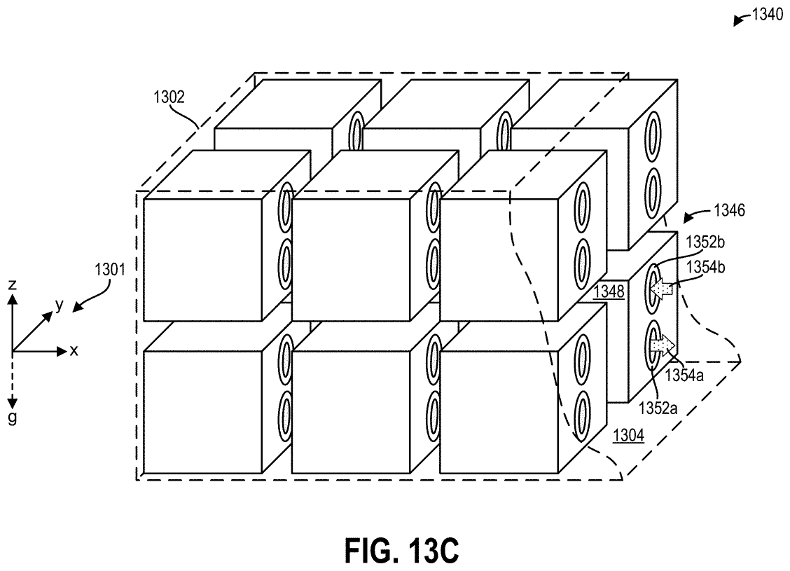

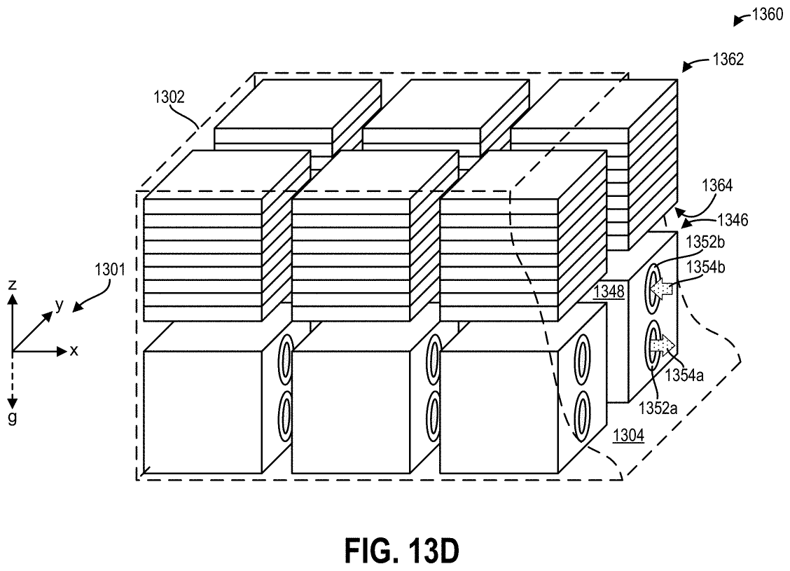

FIG. 10 plots Fe³⁺ reduction rates as a function of a total amount of Fe³⁺ reduced during operation of exemplary rebalancing cells, indicating increased Fe³⁺ reduction for rebalancing cells including internally shorted electrode assemblies. In achieving such increased Fe³⁺ reduction, the rebalancing cell may be operated at relatively low H₂ gas partial pressures. For example, and as plotted in FIG. 12, an exemplary rebalancing cell may be operated to H₂ partial pressures as low as 25% with substantially minimal impact on the Fe³⁺ reduction rate (“substantially” may be used herein as a qualifier meaning “effectively”). Accordingly, the integrated multi-chambered tank providing the H₂ gas for electrolyte rebalancing may be rated for lower H₂ partial pressures than storage tanks typically employed in redox flow battery systems. Exemplary storage tanks configured for lower pressure, higher performance electrolyte rebalancing is depicted schematically in FIGS. 13A-13D. In one example, and as shown in FIG. 13A, the integrated multi-chambered tank may be configured as a cylindrical or modified cylindrical shape. Alternatively, and as shown in FIG. 13B, the integrated multi-chambered tank may be configured as a more space-effective, non-cylindrical shape, such as a rectangular prism or a cube (though “rectangular prism”/“rectangular prismatic” and “cube”/“cuboidal” may be presented herein in the alternative in some examples, it will be appreciated that a “cube” may be a special case of a “rectangular prism”). In some examples, and as depicted schematically in FIGS. 13C and 13D, the integrated multi-chambered tank may be configured as a plurality of storage tanks which may be configured in non-cylindrical shapes so as to be stacked and/or distributed throughout the redox flow battery system with relatively high space utilization.

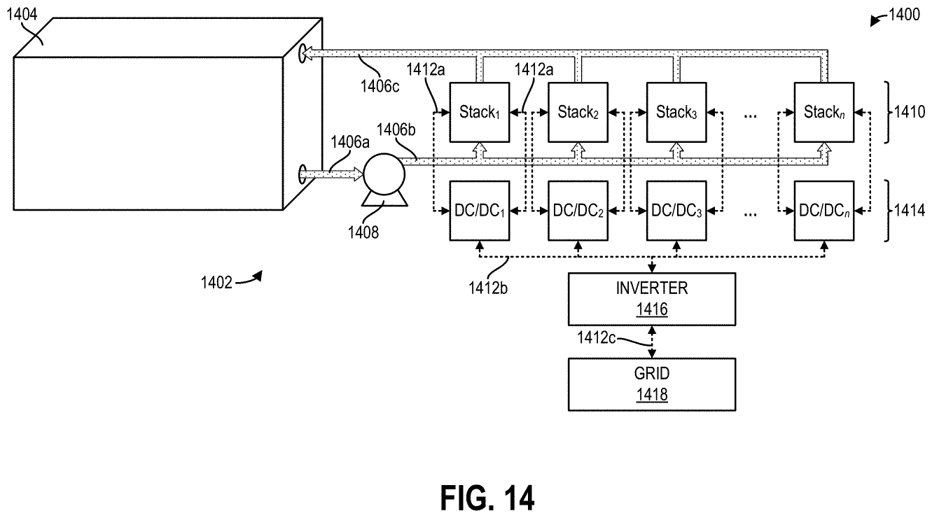

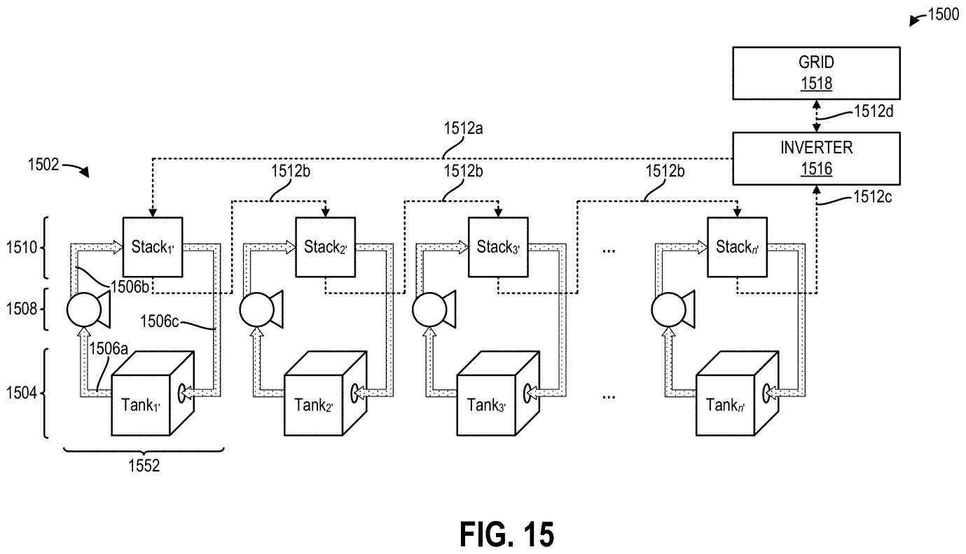

As one example, FIG. 14 depicts a first exemplary redox flow battery system electrically coupled to an electrical grid via a plurality of boost converters and a power inverter, the first redox flow battery system including a plurality of cell assembly stacks, each of the plurality of cell assembly stacks including a redox flow battery cell and a rebalancing cell, and a single non-cylindrical storage tank for distributing the electrolyte and the H₂ gas to the plurality of cell assembly stacks. As another example, FIG. 15 depicts a second exemplary redox flow battery system electrically coupled to an electrical grid via a power inverter, the second exemplary redox flow battery system including a plurality of cell assembly stacks, each of the plurality of cell assembly stacks including a redox flow battery cell and a rebalancing cell, and a plurality of non-cylindrical storage tanks for respectively distributing the electrolyte and the H₂ gas to the plurality of cell assembly stacks, the plurality of storage tanks having an overall volume substantially equivalent to the single storage tank of the first exemplary redox flow battery system of FIG. 14. Accordingly, and as further depicted in FIG. 15, the redox flow battery cells of the second exemplary redox flow battery system may be electrically coupled in series such that direct current (DC) voltage may accumulate across the redox flow battery cells and no (DC-to-DC) boost converters may be included in the second redox flow battery system.

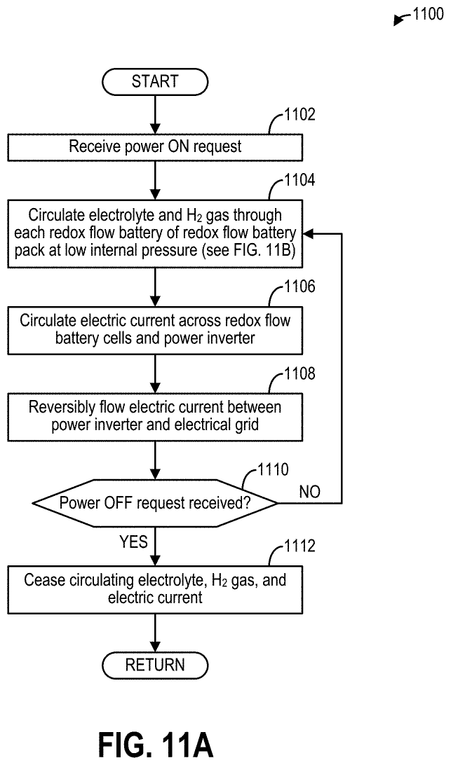

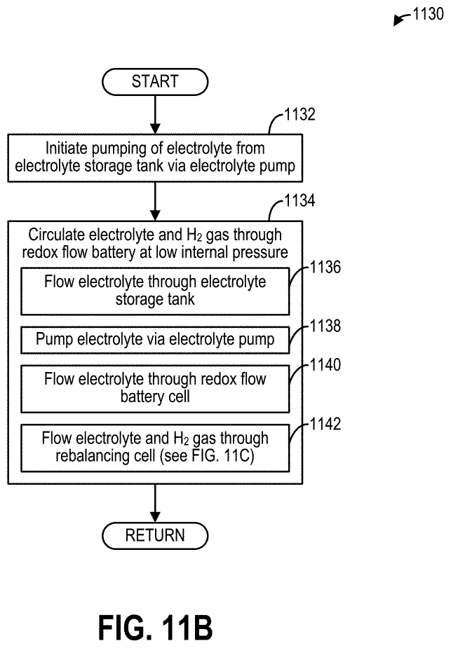

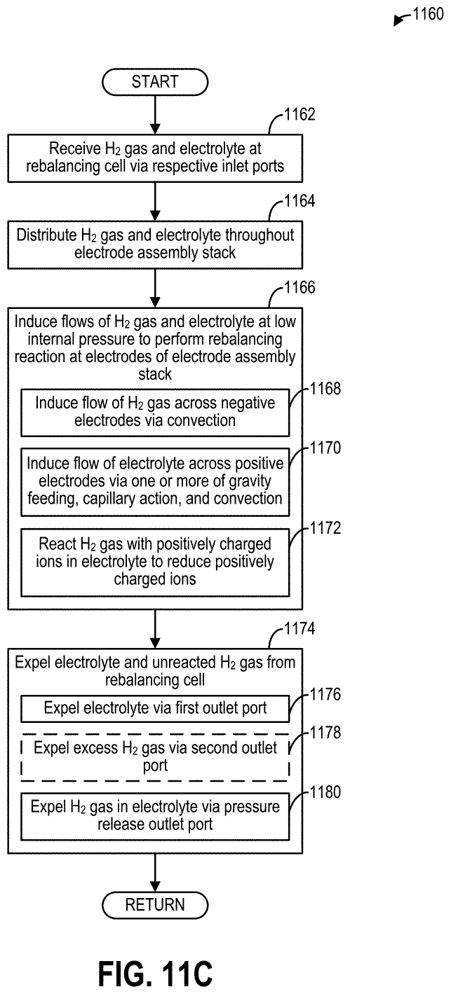

Exemplary methods of operating the redox flow battery system are depicted at FIGS. 11A-11C. Specifically, an exemplary method of operating a redox flow battery pack (e.g., a redox flow battery system configured as an electrically coupled pack of redox flow batteries) to power an electrical grid is depicted in FIG. 11A. Operation of the redox flow battery pack may include circulating the electrolyte and the H₂ gas throughout each redox flow battery included in the redox flow battery pack, as depicted by the method of FIG. 11B, including rebalancing of the electrolyte with the H₂ gas via operation of the rebalancing cell, as depicted by the method of FIG. 11C.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (5) and (6), wherein the forward reactions (left to right) indicate electrochemical reactions during battery charge, while the reverse reactions (right to left) indicate electrochemical reactions during battery discharge:

Fe²⁺+2e⁻↔Fe⁰ −0.44 V (negative electrode) (5)

Fe²⁺↔2Fe³⁺+2e⁻ +0.77 V (positive electrode) (6)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110 via an electrolyte flow path 124. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10 via the electrolyte flow path 124. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82, such that the rebalancing reactors or cells 80 and 82 may be respectively fluidically coupled to the gas head spaces 90 and 92.

As shown, the electrolyte flow path 124 may fluidically couple the integrated multi-chambered electrolyte storage tank 110 to the redox flow battery cell 18 and each of the rebalancing reactors 80 and 82. In some examples, the electrolyte flow path 124 may be a closed flow path in the sense that, during operation of the redox flow battery system 10, the negative and positive electrolytes may be circulated through only one redox flow battery cell 18 along the electrolyte flow path without entering any other redox flow battery cell or being otherwise expelled from the redox flow battery system 10. In such examples, when the redox flow battery system 10 includes a plurality of redox flow battery cells 18, a plurality of (closed) electrolyte flow paths 124 may be included in the redox flow battery system 10, a number of the plurality of electrolyte flow paths 124 being equivalent to a number of the plurality of redox flow battery cells 18. In this way, and as described in greater detail below with reference to FIG. 15, each of the redox flow battery cells 18 may be fluidically isolated from one another, thereby eliminating stack-to-stack shunting via the negative and positive electrolytes. In other examples, the redox flow battery system 10 may include the plurality of redox flow battery cells 18 fluidically coupled to one another via the electrolyte flow path 124 (see FIG. 14).

The electrolyte flow path 124 may include a negative electrolyte flow loop 120 and a positive electrolyte flow loop 122, where the negative and positive electrolytes may be cycled through the negative and positive electrolyte flow loops 120 and 122, respectively. The negative and positive electrolyte flow loops 120 and 122 may be fully or almost fully fluidically decoupled from one another (e.g., fluidic coupling may occur only via the spillover hole 96, when included in the bulkhead 98 of the integrated multi-chambered electrolyte storage tank 110). As shown, the negative electrolyte flow loop 120 may sequentially cycle through the negative electrolyte chamber 50 of the integrated multi-chambered electrolyte storage tank 110, the negative electrolyte pump 30, the negative electrode compartment 20 of the redox flow battery cell 18, and the (negative) rebalancing reactor 80, flowing therefrom back to the negative electrolyte chamber 50 of the integrated multi-chambered electrolyte storage tank 110. As further shown, the positive electrolyte flow loop 122 may sequentially pass through the positive electrolyte chamber 52 of the integrated multi-chambered electrolyte storage tank 110, the positive electrolyte pump 32, the positive electrode compartment 22 of the redox flow battery cell 18, and the (positive) rebalancing reactor 82, flowing therefrom back to the positive electrolyte chamber 52 of the integrated multi-chambered electrolyte storage tank 110. Accordingly, electrolyte solutions primarily stored in the multi-chambered electrolyte storage tank 110 may be pumped via the negative and positive electrolyte pumps 30 and 32 throughout the redox flow battery system 10: electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18. In this way, during operation of the redox flow battery system 10, the negative and positive electrolytes may be cycled through the redox flow battery cell 18 largely independently of one another via the negative and positive electrolyte flow loops 120 and 122, respectively.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively. The electrolyte rebalancing reactors 80 and 82 may serve to rebalance electrolyte charge imbalances in the redox flow battery system 10 occurring due to side reactions, ion crossover, and the like, as described herein.

In some examples, one or both of the rebalancing reactors 80 and 82 may include trickle bed reactors, where the H₂ gas and the (liquid) electrolyte may be contacted at catalyst surfaces in a packed bed for carrying out the electrolyte rebalancing reaction. Additionally or alternatively, one or both of the rebalancing reactors 80 and 82 may have catalyst beds configured in a jelly roll. In additional or alternative examples, one or both of the rebalancing reactors 80 and 82 may include flow-through type reactors that are capable of contacting the H₂ gas and the electrolyte and carrying out the electrolyte rebalancing reactions absent a packed catalyst bed. However, lower Fe³⁺ reduction rates (e.g., on the order of ˜1-3 mol/m² hr) during electrolyte rebalancing may preclude implementation of such rebalancing reactor configurations in higher performance applications.

In other examples, one or both of the rebalancing reactors 80 and 82 may include fuel cells, where the H₂ gas and the electrolyte may be contacted at catalyst surfaces for carrying out the electrolyte rebalancing reaction and where a closed circuit may be formed by directing electric current from the fuel cells through an external load. However, reverse current spikes [e.g., transient increases in reverse electric current, where “reverse electric current” may be used herein to refer to any electric current traveling along an electrical pathway in a direction opposite from expected (that is, opposite from a “forward” direction)] in such fuel cells may be unavoidable in certain circumstances, undermining a reliability of such rebalancing reaction configurations.

To increase the Fe³⁺ reduction rate without sacrificing an overall reliability of the rebalancing reactors 80 and 82, embodiments of the present disclosure provide a rebalancing cell, such as the rebalancing cell of FIGS. 2A and 2B, including a stack of internally shorted electrode assemblies, such as the electrode assembly of FIG. 3, configured to drive the H₂ gas and the electrolyte to react at catalyst surfaces via a combination of internal electric current, convection, gravity feeding, and capillary action. In embodiments described herein, the electrode assemblies of the stack of internally shorted electrode assemblies may be referred to as “internally shorted,” in that no electric current may be directed away from the stack of internally shorted electrode assemblies during operation of the rebalancing cell. Such internal electrical shorting may reduce or obviate reverse current spikes while drastically increasing the Fe³⁺ reduction rate (e.g., to as high as ˜50-70 mol/m² hr, or by a factor of 20 or more relative to rebalancing reactor configurations which are not internally electrically shorted) and concomitantly decreasing side reaction rates (e.g., rates of the reactions of equation (1)-(3)). Further, each electrode assembly of the stack of internally shorted electrode assemblies may be electrically decoupled from each other electrode assembly of the stack of internally shorted electrode assemblies, such that degradation to the stack of internally shorted electrode assemblies during a current spike at one electrode assembly may be limited thereto (e.g., reverse electric current may not be driven from one electrode assembly through the other electrode assemblies). In such cases, the single, degraded electrode assembly may be easily removed from the stack of internally shorted electrode assemblies and replaced with a non-degraded electrode assembly.

To realize the internally shorted circuit, each electrode assembly of the stack of internally shorted electrode assemblies may include an interfacing pair of positive and negative electrodes (e.g., configured in face-sharing contact with one another so as to be continuously electrically conductive). As used herein, a pair of first and second components (e.g., positive and negative electrodes of an electrode assembly) may be described as “interfacing” with one another when the first component is arranged adjacent to the second component such that the first and second components are in face-sharing contact with one another (where “adjacent” is used herein to refer to any two components having no intervening components therebetween). Further, as used herein, “continuously” when describing electrical conductivity of multiple electrodes may refer to an electrical pathway therethrough having effectively or practically zero resistance at any face-sharing interfaces of the multiple electrodes.

In an exemplary embodiment, the (positive) rebalancing reactor 82 may be the rebalancing cell including the stack of internally shorted electrode assemblies. Higher Fe′ reduction rates may be desirable to rebalance the positive electrolyte, as significant amounts of Fe³⁺ may be generated at the positive electrode 28 during battery charging (see equation (6)). In additional or alternative embodiments, the (negative) rebalancing reactor 80 may be of like configuration [Fe³⁺ may be generated at the negative electrode 26 during iron plating oxidation (see equation (3))].

In such rebalancing cell configurations, the higher Fe³⁺ reduction rates may be accomplished with relatively low H₂ gas partial pressures with minimal impact on performance. As such, in some examples, the H₂ gas may be flowed from the integrated multi-chambered electrolyte storage tank 110 to the rebalancing reactors 80 and 82 at a partial pressure of less than an upper partial pressure threshold, such as 80%. In one example, the upper partial pressure threshold may be 25%, and the rebalancing cell including the stack of internally shorted electrode assemblies as described herein may accordingly be operated at least down to 25% H₂ gas partial pressure (see FIG. 12). In such an example, at 50° C. [e.g., within an operating temperature range of the redox flow battery system 10 of room temperature (20° C., for example) to 60° C.], where water pressure is ˜20 kPa, the electrolyte flow path 124 may be subjected to pressures as low as ˜7 kPa from the H₂ gas.

By configuring the rebalancing reactors 80 and/or 82 in this way, less H₂ gas may be included in the gas head spaces 90 and 92 for electrolyte rebalancing, and the integrated multi-chambered electrolyte storage tank 110 may be constructed with fewer considerations as to pressurized containment, such that a shape and/or an overall size of the integrated multi-chambered electrolyte storage tank 110 may be selected for overall space and packing density rather than for containing high storage pressures. As such, and as discussed in detail below with reference to FIGS. 13A-13D, though the integrated multi-chambered electrolyte storage tank 110 may be rated up to an upper threshold gauge pressure of 20 psi and configured as a cylindrical storage tank with domed ends (e.g., in place of flat circular faces), other pressure ratings and shapes may be used in embodiments herein. For example, the upper threshold gauge pressure may be 2 psi (e.g., the integrated multi-chambered electrolyte storage tank 110 may be rated up to 2 psi and may not be rated for pressures higher than 5 psi) and configured as a non-cylindrical storage tank (e.g., a rectangular prismatic storage tank, such as a cuboidal storage tank). As such, in one example, a gauge pressure in the integrated multi-chambered electrolyte storage tank 110 may be maintained below 5 psi (e.g., during operation of the redox flow battery system 10). In another example, the gauge pressure in the integrated multi-chambered electrolyte storage tank 110 may be maintained below 2 psi (e.g., during operation of the redox flow battery system 10). In another example, the gauge pressure in the integrated multi-chambered electrolyte storage tank 110 may be maintained below 1 psi (e.g., during operation of the redox flow battery system 10). Further, a thickness of each wall of the integrated multi-chambered electrolyte storage tank 110 may be reduced (e.g., to less than an upper threshold thickness, such as 5 mm) and a wider range of compositions therefor may be employed [e.g., from relatively stronger materials, such as metal coated with polytetrafluoroethylene (PTFE) or reinforced fiberglass, to relatively weaker materials, such as polypropylene or polyethylene (high-density polyethylene or other polyethylene classifications)]. In this way, a packing density of the integrated multi-chambered electrolyte storage tank 110 (e.g., which may be proportional to a ratio of a volume of stored electrolyte to a volume utilized for housing the integrated multi-chambered electrolyte storage tank 110) may be increased as compared to cylindrical storage tanks, while cost may be decreased (e.g., by 50-75%) as compared to high-pressure storage tanks (e.g., rated higher than 20 psi).

Moreover, by selecting a more space-effective, low-pressure configuration, a volume of the electrolyte solution utilized in the redox flow battery system 10 may be partitioned into multiple, smaller integrated multi-chambered electrolyte storage tanks 110 (e.g., one integrated multi-chambered electrolyte storage tank 110 respectively fluidically coupled to each redox flow battery cell 18), thereby further increasing the packing density, while providing a greater flexibility in component placement within the redox flow battery system 10. For example, by partitioning the volume of the electrolyte solution in this way, a plurality of fluidically isolated redox flow battery subsystems 150 may be formed (each with an integrated multi-chambered electrolyte storage tank 110 fluidically coupled to a redox flow battery cell 18) which may operate substantially independently of one another. Accordingly, the redox flow battery system 10 may be configured as a modular redox flow battery pack including a plurality of redox flow batteries (e.g., the plurality of fluidically isolated redox flow battery subsystems 150), wherein redox flow batteries may be added or removed with relative ease and simplicity. For example, and as described in detail below with reference to FIG. 15, each of the redox flow batteries of the modular redox flow battery pack may be electrically coupled in series, whereby only additional electrical wiring and external housing may be necessitated in coupling additional redox flow batteries to the redox flow batteries already included in the modular redox flow battery pack. In this way, an overall expense and complexity of the redox flow battery system 10 may be reduced without sacrificing electrochemical performance and output.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate (e.g., the Fe³⁺ reduction rate) is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIGS. 11B and 11C, in tandem with controlling flow of the H₂ gas to the rebalancing reactors 80 and 82 as described above, the controller 88 may control flows of the negative and positive electrolytes through the rebalancing reactors 80 and 82, respectively, during charging and discharging of the redox flow battery cell 18 so as to simultaneously rid the redox flow battery system 10 of excess H₂ gas and reduce Fe³⁺ ion concentration. After electrolyte rebalancing, the controller 88 may direct flow of any excess or unreacted H₂ along with the rebalanced negative and positive electrolytes (e.g., including a decreased concentration of Fe³⁺ and an increased concentration of Fe²⁺) from the rebalancing reactors 80 and 82 back into the respective electrolyte chambers 50 and 52 of the multi-chambered electrolyte storage tank 110 [additionally or alternatively, the unreacted H₂ gas may be returned to the separate dedicated hydrogen gas storage tank (not shown at FIG. 1)].

In examples wherein the rebalancing reactors 80 and 82 are configured as rebalancing cells including stacks of internally shorted electrode assemblies, the controller 88 may control operation of the redox flow battery system 10 at relatively low H₂ gas partial pressures, such that multiple, space-effective, low-pressure storage tanks (e.g., integrated multi-chambered electrolyte storage tanks 110) may be included for electrolyte storage and distribution. Accordingly, the redox flow battery cells 18 included in the redox flow battery system 10 may be fluidically decoupled from one another such that a modularity of the redox flow battery system 10 may be increased (e.g., fewer coupling elements and less complex configurations may be employed to add on further redox flow battery cells 18). Moreover, by fluidically isolating the redox flow battery cells 18 from one another, the redox flow battery cells 18 may be electrically coupled in series such that a potential difference thereacross may be ramped up and relatively high voltage external loads may be powered by the redox flow battery system 10 absent any DC-to-DC boost converter(s). For example, and as discussed in detail with reference to FIG. 11A, the controller 88 may direct circulation of an electric current across a power inverter (e.g., electrically coupled to a high-voltage electrical grid) and the redox flow battery cells 18 in series in tandem with directing circulation of each of the electrolyte and the H₂ gas within the redox flow battery system 10.

As yet another example, the controller 88 may further control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 130. As such, the redox flow battery system 10 may be described as including the power module 130 fluidly coupled to the integrated multi-chambered electrolyte storage tank 110 and communicably coupled to the sensors 60 and 62. In some examples, each of the power module 130 and the multi-chambered electrolyte storage tank 110 may be included in a single housing or packaging (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 140. As such, the electrolyte subsystem 140 may supply one or more electrolytes to the redox flow battery cell 18 (and components included therein).

In some examples, and as discussed above, the redox flow battery system 10 may be configured as a redox flow battery pack including a plurality of fluidically isolated redox flow battery subsystems 150. In such examples, each of the plurality of fluidically isolated redox flow battery subsystems 150 may include all components of the redox flow battery system 10 apart from the controller 88. More specifically, each of the plurality of fluidically isolated redox flow battery subsystems 150 may include a separate integrated multi-chambered electrolyte storage tank 110, separate electrolyte pumps 30 and 32, a separate redox flow battery cell 18, separate rebalancing reactors 80 and 82, etc. Accordingly, each of the plurality of fluidically isolated redox flow battery subsystems 150 may be referred to herein as a redox flow battery, where each redox flow battery may be independently configured to output electrical power during discharge. In such configurations, the controller 88 may be communicably coupled to each of the redox flow batteries and may therefore control operating states of each of the redox flow batteries in tandem or individually, as determined based on a given application.

Referring now to FIGS. 2A and 2B, perspective views 200 and 250 are respectively shown, each of the perspective views 200 and 250 depicting a rebalancing cell 202 for a redox flow battery system, such as redox flow battery system 10 of FIG. 1. In an exemplary embodiment, the rebalancing cell 202 may include a stack of internally shorted electrode assemblies, such as the electrode assembly described in detail below with reference to FIG. 3, which may drive an electrolyte rebalancing reaction by contacting H₂ gas with an electrolyte from positive or negative electrode compartments of a redox flow battery, such as the redox flow battery cell 18 of FIG. 1, at catalytic surfaces of negative electrodes of the stack of internally shorted electrode assemblies. Accordingly, the rebalancing cell 202 may be one or both of the rebalancing reactors 80 and 82 of FIG. 1. A set of reference axes 201 is provided for describing relative positioning of the components shown and for comparison between the views of FIGS. 2A-4B, 6A, 6B, 9A, and 9B, the axes 201 indicating an x-axis, a y-axis, and a z-axis. As further shown in dashing in FIGS. 2A, 2B, and 6A, an additional axis g may be parallel with a direction of gravity (e.g., in a positive direction along the axis g) and a vertical direction (e.g., in a negative direction along the axis g and opposite to the direction of gravity).

A number of rebalancing cells 202 included in the redox flow battery system and a number of electrode assemblies included in the stack of internally shorted electrode assemblies are not particularly limited and may increase to accommodate correspondingly higher performance applications. For example, a 75 kW redox flow battery system may include two rebalancing cells 202 including a stack of 20 electrode assemblies (e.g., a stack of 19 bipolar assemblies with 2 end plates positioned at opposite ends of the stack).

As shown, the stack of internally shorted electrode assemblies may be removably enclosed within an external cell enclosure or housing 204. Accordingly, in some examples, the cell enclosure 204 may include a top cover removably affixed to an enclosure base, such that the top cover may be temporarily removed to replace or diagnose one or more electrode assemblies of the stack of internally shorted electrode assemblies. In additional or alternative examples, the cell enclosure 204, depicted in FIGS. 2A and 2B as a rectangular prism, may be molded to be clearance fit against other components of the redox flow battery system such that the rebalancing cell 202 may be in face-sharing contact with such components. In some examples, the cell enclosure 204 may be composed of a material having a low electrical conductivity, such as a plastic or other polymer, so as to reduce undesirable shorting events.

The cell enclosure 204 may further be configured to include openings or cavities for interfacial components of the rebalancing cell 202. For example, the cell enclosure 204 may include a plurality of inlet and outlet ports configured to fluidically couple to other components of the redox flow battery system. In one example, and as shown, the plurality of inlet and outlet ports may include polypropylene (PP) flange fittings fusion welded to PP plumbing.

In an exemplary embodiment, the plurality of inlet and outlet ports may include an electrolyte inlet port 206 for flowing the electrolyte into the cell enclosure 204 and an electrolyte outlet port 208 for expelling the electrolyte from the cell enclosure 204. In one example, the electrolyte inlet port 206 may be positioned on an upper half of the cell enclosure 204 and the electrolyte outlet port 208 may be positioned on a lower half of the cell enclosure 204 (where the upper half and the lower half of the cell enclosure 204 are separated along the z-axis by a plane parallel with each of the x- and y-axes). Accordingly, the electrolyte outlet port 208 may be positioned lower than the electrolyte inlet port 206 with respect to the direction of gravity (e.g., along the axis g).

Specifically, upon the electrolyte entering the cell enclosure 204 via the electrolyte inlet port 206, the electrolyte may be distributed across the stack of internally shorted electrode assemblies, gravity fed through the stack of electrode assemblies, wicked up (e.g., against the direction of gravity) through positive electrodes of the stack of internally shorted electrode assemblies to react at the catalytic surfaces of the negative electrodes in a cathodic half reaction, and expelled out of the cell enclosure 204 via the electrolyte outlet port 208. To assist in the gravity feeding of the electrolyte and decrease a pressure drop thereof, the rebalancing cell 202 may further be tilted or inclined with respect to the direction of gravity via a sloped support 220 coupled to the cell enclosure 204. In some examples, tilting of the cell enclosure 204 in this way may further assist in electrolyte draining of the rebalancing cell 202 (e.g., during an idle mode of the redox flow battery system) and keep the catalytic surfaces relatively dry (as the catalytic surfaces may corrode after being soaked in the electrolyte for a sufficient duration, in some examples).

As shown, the sloped support 220 may tilt the cell enclosure 204 at an angle 222 such that planes of electrode sheets of the stack of internally shorted electrode assemblies are inclined with respect to a lower surface (not shown) on which the sloped support 220 rests at the angle 222. In some examples, the angle 222 (e.g., of the cell enclosure 204 with respect to the lower surface) may be between 0° and 30° (in embodiments wherein the angle 222 is substantially 0°, the rebalancing cell 202 may still function, though the pressure drop may be greater and electrolyte crossover to the negative electrodes may be reduced when the cell enclosure 204 is tilted). In some examples, the angle 222 may be between 2° and 30°. In some examples, the angle 222 may be between 2° and 20°. In one example, the angle 222 may be about 8°. Accordingly, the pressure drop of the electrolyte may be increased by increasing the angle 222 and decreased by decreasing the angle 222. Further aspects of the sloped support 220 are described in greater detail below with reference to FIGS. 9A and 9B. Additionally or alternatively, one or more support rails 224 may be coupled to the upper half of the cell enclosure 204 (e.g., opposite from the sloped support 220). In some examples, and as shown in the perspective view 200 of FIG. 2A, the one or more support rails 224 may be tilted with respect to the cell enclosure 204 at the angle 222 such that the one or more support rails 224 may removably fasten the rebalancing cell 202 to an upper surface above and parallel with the lower surface. In this way, and based on geometric considerations, the z-axis may likewise be offset from the axis g at the angle 222 (e.g., the cell enclosure 204 may be tilted with respect to a vertical direction opposite the direction of gravity by the angle 222, as shown in FIGS. 2A and 2B). In some examples, gravity feeding of the electrolyte through the rebalancing cell 202 may further be assisted by positioning the rebalancing cell 202 above an electrolyte storage tank (e.g., the multi-chambered electrolyte storage tank 110 of FIG. 1) of the redox flow battery system with respect to the vertical direction opposite to the direction of gravity. Further aspects of the electrolyte flow will be discussed in greater detail below with reference to FIGS. 6A-7B.

As further shown, the electrolyte outlet port 208 may include a plurality of openings in the cell enclosure 204 configured to expel at least a portion of the electrolyte (each of the plurality of openings including the PP flange fitting fusion welded to PP plumbing). For instance, in FIGS. 2A and 2B, the electrolyte outlet port 208 is shown including five openings. In this way, the electrolyte may be evenly distributed across the stack of internally shorted electrode assemblies and may be expelled from the cell enclosure 204 with substantially unimpeded flow. In other examples, the electrolyte outlet port 208 may include more than five openings or less than five openings. In one example, the electrolyte outlet port 208 may include only one opening. In additional or alternative examples, the electrolyte outlet port 208 may be positioned beneath the cell enclosure 204 with respect to the z-axis (e.g., on a face of the cell enclosure 204 facing a negative direction of the z-axis).

The electrolyte inlet port 206 and the electrolyte outlet port 208 may be positioned on the cell enclosure 204 based on a flow path of the electrolyte through the stack of internally shorted electrode assemblies (e.g., from the electrolyte inlet port 206 to the electrolyte outlet port 208 and inclusive of channels, passages, plenums, wells, etc. within the cell enclosure 204 fluidically coupled to the electrolyte inlet port 206 and the electrolyte outlet port 208). In some examples, and as shown, the electrolyte inlet port 206 and the electrolyte outlet port 208 may be positioned on adjacent sides of the cell enclosure 204 (e.g., faces of the cell enclosure 204 sharing a common edge). In other examples, the electrolyte inlet port 206 and the electrolyte outlet port 208 may be positioned on opposite sides of the cell enclosure 204. In other examples, the electrolyte inlet port 206 and the electrolyte outlet port 208 may be positioned on the same side of the cell enclosure 204.

In some examples, the electrolyte inlet port 206 may be positioned on a face of the cell enclosure 204 facing a negative direction of the x-axis. In additional or alternative examples, the electrolyte inlet port 206 may be positioned on a face of the cell enclosure 204 facing a positive direction of the x-axis. In one example, and as shown, one opening of the electrolyte inlet port 206 may be positioned on the face of the cell enclosure 204 facing the negative direction of the x-axis and another opening of the electrolyte inlet port 206 may be positioned on the face of the cell enclosure 204 facing the positive direction of the x-axis.

In some examples, the plurality of inlet and outlet ports may further include a hydrogen gas inlet port 210 for flowing the H₂ gas into the cell enclosure 204 and a hydrogen gas outlet port 212 for expelling the H₂ gas from the cell enclosure 204. In one example, and as shown, each of the hydrogen gas inlet port 210 and the hydrogen gas outlet port 212 may be positioned on the lower half of the cell enclosure 204 (e.g., at a lowermost electrode assembly of the stack of internally shorted electrode assemblies along the z-axis). In another example, each of the hydrogen gas inlet port 210 and the hydrogen gas outlet port 212 may be positioned on the upper half of the cell enclosure 204 (e.g., at an uppermost electrode assembly of the stack of internally shorted electrode assemblies along the z-axis). In yet another example, the hydrogen gas inlet port 210 may be positioned on the lower half of the cell enclosure 204 and the hydrogen gas outlet port 212 may be positioned on the upper half of the cell enclosure 204. In such an example, the hydrogen gas inlet port 210 may be positioned lower than the hydrogen gas outlet port 212 with respect to the direction of gravity (e.g., along the axis g).

Specifically, upon the H₂ gas entering the cell enclosure 204 via the hydrogen gas inlet port 210, the H₂ gas may be distributed across and through the stack of internally shorted electrode assemblies via forced convection (e.g., induced by flow field configurations of respective flow field plates, as discussed in greater detail below with reference to FIGS. 5A-5D and 8A-8D) and decomposed at the catalytic surfaces of the negative electrodes in an anodic half reaction. However, in some examples, excess, unreacted H₂ gas may remain in the rebalancing cell 202 following contact with the catalytic surfaces. In some examples, at least a portion of the H₂ gas which has not reacted at the catalytic surfaces may pass into the electrolyte. To avoid undesirable pressure buildup and thereby prevent electrolyte pooling on the positive electrodes and concomitant electrolyte flooding of the negative electrodes in such examples, the plurality of inlet and outlet ports may further include a pressure release outlet port 214 to expel unreacted H₂ gas from the electrolyte. Further, in some examples, the hydrogen gas outlet port 212 may be configured to expel at least a portion of the H₂ gas which has not reacted at the catalytic surfaces and that has not flowed through the negative electrodes into the electrolyte. Further aspects of the H₂ gas flow will be discussed in greater detail below with reference to FIGS. 4A-5D.

The hydrogen gas inlet port 210 and the hydrogen gas outlet port 212 may be positioned on the cell enclosure 204 based on a flow path of the H₂ gas through the stack of internally shorted electrode assemblies [e.g., from the hydrogen gas inlet port 210 to the hydrogen gas outlet port 212 (when included) and inclusive of channels, passages, plenums, etc. within the cell enclosure 204 fluidically coupled to the hydrogen gas inlet port 210 and the hydrogen gas outlet port 212 (when included)]. In some examples, and as shown, the hydrogen gas inlet port 210 and the hydrogen gas outlet port 212 may be positioned on opposite sides of the cell enclosure 204. In other examples, the hydrogen gas inlet port 210 and the hydrogen gas outlet port 212 may be positioned on adjacent sides of the cell enclosure 204. In other examples, the hydrogen gas inlet port 210 and the hydrogen gas outlet port 212 may be positioned on the same side of the cell enclosure 204. Further, though the hydrogen gas inlet port 210 is shown in FIGS. 2A and 2B as being positioned on the face of the cell enclosure 204 facing the negative direction of the x-axis and the hydrogen gas outlet port 212 is shown in FIGS. 2A and 2B as being positioned on the face of the cell enclosure 204 facing the positive direction of the x-axis, in other examples, the hydrogen gas inlet port 210 may be positioned on the face of the cell enclosure 204 facing the positive direction of the x-axis and the hydrogen gas outlet port 212 may be positioned on the face of the cell enclosure 204 facing the negative direction of the x-axis.

In one example, the hydrogen gas inlet port 210, the hydrogen gas outlet port 212, the electrolyte inlet port 206, and the electrolyte outlet port 208 may be positioned on the cell enclosure 204 in a crosswise configuration. Specifically, the crosswise configuration may include the hydrogen gas outlet port 212 and the electrolyte inlet port 206 being positioned on different sides (e.g., faces) of the upper half of the cell enclosure 204 and the hydrogen gas inlet port 210 and the electrolyte outlet port 208 being positioned on different sides of the lower half of the cell enclosure 204.

In other examples, no hydrogen gas outlet port 212 may be present for expelling H₂ gas which has not reacted at the catalytic surfaces of the negative electrodes and which has not flowed through the negative electrodes into the electrolyte. In such examples, however, the pressure release outlet port 214 for expelling unreacted H₂ gas from the electrolyte may still be present, and the unreacted H₂ gas may only be expelled from the cell enclosure 204 after flowing through the negative electrodes into the electrolyte and through the pressure release outlet port 214. Exemplary rebalancing cell configurations lacking the hydrogen gas outlet port 212, whether or not including the pressure release outlet port 214, may be referred to as “dead ended configurations.” In dead ended configurations, substantially all of the H₂ gas may be forced into contact with the catalytic surfaces of the negative electrodes, whereat the H₂ gas may either decompose via the anodic half reaction and/or the H₂ gas may enter the electrolyte after passing through the negative electrodes (e.g., without reacting at catalytic surfaces thereof).

Referring now to FIG. 3, an exploded view 300 depicting an electrode assembly 302 for a rebalancing cell, such as the rebalancing cell 202 of FIGS. 2A and 2B, is shown. Accordingly, the electrode assembly 302 may be internally shorted (e.g., electric current flowing through the electrode assembly 302 is not channeled through an external load). In an exemplary embodiment, the electrode assembly 302 may be included in a stack of electrode assemblies of like configuration in a cell enclosure so as to form the rebalancing cell. The electrode assembly 302 may include a plate 304 with an activated carbon foam 306, a positive electrode 308 (also referred to herein as a “cathode” in certain examples), and a negative electrode 310 (also referred to herein as an “anode” in certain examples) sequentially stacked thereon. The electrode assembly 302 may be positioned within the rebalancing cell so as to receive an electrolyte through the carbon foam 306, wherefrom the electrolyte may enter pores of the positive electrode 308 via capillary action and come into contact with the negative electrode 310. The electrode assembly 302 may further be positioned within the rebalancing cell so as to receive H₂ gas across a catalytic surface of the negative electrode 310 opposite to the positive electrode 308 via convection. The convection of the H₂ gas across the catalytic surface may be assisted by a flow field plate (not shown at FIG. 3) interfacing with the catalytic surface. Upon decomposition of the H₂ gas at the catalytic surface via an anodic half reaction, protons and electrons may flow to an interface of the negative electrode 310 and the positive electrode 308, whereat ions in the electrolyte may be reduced via a cathodic half reaction (e.g., Fe³⁺ may be reduced to Fe²⁺). In this way, the electrode assembly 302 may be configured for electrolyte rebalancing for a redox flow battery, such as the redox flow battery cell 18 of FIG. 1, fluidically coupled to the rebalancing cell including the electrode assembly 302.

In some examples, the plate 304 may be composed of a material having a low electrical conductivity, such as a plastic or other polymer, so as to reduce undesirable shorting events. Accordingly, in one example, the plate 304 may be formed from the same material as the cell enclosure 204 of FIGS. 2A and 2B.

As shown, the plate 304 may include a plurality of inlets and outlets therethrough. For example, the plurality of inlets and outlets may include an electrolyte outlet channel section 316, a hydrogen gas inlet channel section 318a, and a hydrogen gas outlet channel section 318b. Specifically, the plate 304 may include the electrolyte outlet channel section 316 for directing the electrolyte out of the rebalancing cell, the hydrogen gas inlet channel section 318a for directing the H₂ gas into the rebalancing cell and across the negative electrode 310, and the hydrogen gas outlet channel section 318b for directing the H₂ gas out of the rebalancing cell. The plate 304 may further include an electrolyte inlet well 312 for receiving the electrolyte at the electrode assembly 302, the electrolyte inlet well 312 fluidically coupled to a plurality of electrolyte inlet passages 314a set into a berm 314b positioned adjacent to the carbon foam 306 for distributing the received electrolyte across the carbon foam 306. In some examples, the electrolyte inlet well 312 may receive the electrolyte from an electrolyte inlet port (e.g., the electrolyte inlet port 206 of FIGS. 2A and 2B) fluidically coupled thereto (e.g., via an electrolyte inlet channel; not shown at FIG. 3), the electrolyte outlet channel section 316 may expel the electrolyte through an electrolyte outlet port (e.g., the electrolyte outlet port 208 of FIGS. 2A and 2B) fluidically coupled thereto, the hydrogen gas inlet channel section 318a may receive the H₂ gas from a hydrogen gas inlet port (e.g., the hydrogen gas inlet port 210 of FIGS. 2A and 2B) fluidically coupled thereto, and the hydrogen gas outlet channel section 318b may expel the H₂ gas through a hydrogen gas outlet port (e.g., the hydrogen gas outlet port 212 of FIGS. 2A and 2B) fluidically coupled thereto.

It will be appreciated that, though the hydrogen gas inlet channel section 318a is described herein as a section of a hydrogen gas inlet channel and the hydrogen gas outlet channel section 318b is described herein as a section of a hydrogen gas outlet channel, in other examples, the channel section 318b may be a section of a hydrogen gas inlet channel (e.g., for directing the H₂ gas into the rebalancing cell and across the negative electrode 310 after receiving the H₂ gas from the hydrogen gas inlet port) and the channel section 318a may be a section of a hydrogen gas outlet channel (e.g., for directing the H₂ gas out of the rebalancing cell by expelling the H₂ gas through the hydrogen gas outlet port). In other examples, the rebalancing cell may have a dead ended configuration and no hydrogen gas outlet port may be fluidically coupled to the hydrogen gas outlet channel section 318b. In such examples, the hydrogen gas outlet channel section 318b may direct the H₂ gas back across the negative electrode 310 or the hydrogen gas outlet channel section 318b may instead be configured as another hydrogen gas inlet channel section (e.g., for directing a portion of the H₂ gas into the rebalancing cell and across the negative electrode 310 after receiving the portion of the H₂ gas from the hydrogen gas inlet port).

The plurality of inlets and outlets may be configured to improve electrolyte and H₂ gas flow throughout the rebalancing cell. As an example, a size of each of the hydrogen gas inlet channel section 318a and the hydrogen gas outlet channel section 318b may be selected to minimize a pressure drop therethrough, thereby aiding in flow distribution into each electrode assembly 302 of the stack of internally shorted electrode assemblies. As another example, a size of each electrolyte inlet passage 314a and a total number of the plurality of electrolyte inlet passages 314a relative to the berm 314b may be selected to induce a relatively small pressure drop to substantially evenly distribute electrolyte flow. In such an example, the selection of the size of each electrolyte passage 314a and the total number of the plurality of electrolyte inlet passages 314a may be dependent on a number of factors specific to a given configuration of the rebalancing cell, such as a size of an electrolyte flow field and a desired electrolyte flow rate.

In additional or alternative examples, the electrolyte outlet channel section 316 may further be configured for distributing the electrolyte through multiple openings included in the electrolyte outlet port. For instance, in the exploded view 300 of FIG. 3, the electrolyte outlet channel section 316 is shown including two openings. In some examples, a number of openings included in the electrolyte outlet channel section 316 may be equal to a number of openings included in the electrolyte outlet port, such that the openings of the electrolyte outlet channel section 316 may respectively correspond to the openings of the electrolyte outlet port. In this way, the electrolyte may be evenly distributed across the electrode assembly 302 and may be expelled from the rebalancing cell with substantially unimpeded flow. In other examples, the electrolyte outlet channel section 316 may include more than two openings or less than two openings (e.g., only one opening).

Further, when the electrode assembly 302 is included in a stack of electrode assemblies, electrolyte outlet channel sections 316, hydrogen gas inlet channel sections 318a, and hydrogen gas outlet channel sections 318b may align to form a continuous electrolyte outlet channel, a continuous hydrogen gas inlet channel, and a continuous hydrogen gas outlet channel, respectively (as variously shown in FIGS. 4A, 4B, 6A, and 6B, described below). In this way, the stack of electrode assemblies may be formed in a modular fashion, whereby any practical number of electrode assemblies 302 may be stacked and included in a rebalancing cell.

As further shown, a plurality of sealing inserts may be affixed (as used herein, “affix,” “affixed,” or “affixing” includes, but is not limited to, gluing, attaching, connecting, fastening, joining, linking, or securing one component to another component through a direct or indirect relationship) or otherwise coupled to the plate 304. As an example, the plurality of sealing inserts may include a hydrogen gas inlet channel seal insert 320a and a hydrogen gas outlet channel seal insert 320b for inducing flow of the H₂ gas across the negative electrode 310 by mitigating H₂ gas bypass. Specifically, the hydrogen gas inlet channel seal insert 320a and the hydrogen gas outlet channel seal insert 320b may be affixed or otherwise coupled adjacent to the hydrogen gas inlet channel section 318a and the hydrogen gas outlet channel section 318b, respectively, on a side of the plate 304 including the carbon foam 306, the positive electrode 308, and the negative electrode 310. In some examples, and as discussed in greater detail with reference to FIGS. 4A and 4B, the hydrogen gas inlet channel seal insert 320a and the hydrogen gas outlet channel seal insert 320b may be coincident with an x-y plane of the negative electrode 310 such that the hydrogen gas inlet channel seal insert 320a and the hydrogen gas outlet channel seal insert 320b may extend from a locus of affixation or coupling with the plate 304 and partially overlap the positive electrode 308.

As another example, the plurality of sealing inserts may further include each of a hydrogen gas inlet channel O-ring 322a and a hydrogen gas outlet channel O-ring 322b for respectively sealing an interface of the hydrogen gas inlet channel section 318a with a hydrogen gas inlet channel section of another electrode assembly and an interface of the hydrogen gas outlet channel section 318b with a hydrogen gas outlet channel section of another electrode assembly. Specifically, the hydrogen gas inlet channel O-ring 322a and the hydrogen gas outlet channel O-ring 322b may be affixed or otherwise coupled to the plate 304 so as to respectively circumscribe the hydrogen gas inlet channel section 318a and the hydrogen gas outlet channel section 318b.

As another example, the plurality of sealing inserts may further include an overboard O-ring 324 for sealing an interface of the electrode assembly 302 with another electrode assembly at outer edges thereof. Specifically, the overboard O-ring 324 may be affixed or otherwise coupled to the plate 304 so as to circumscribe each of the electrolyte inlet well 312, the plurality of electrolyte inlet passages 314a, the berm 314b, the electrolyte outlet channel section 316, the hydrogen gas inlet channel section 318a, and the hydrogen gas outlet channel section 318b.

The carbon foam 306 may be positioned in a cavity 326 of the plate 304 between the berm 314b and the electrolyte outlet channel section 316 along the y-axis and between the hydrogen gas inlet channel section 318a and the hydrogen gas outlet channel section 318b along the x-axis. Specifically, the carbon foam 306 may be positioned in face-sharing contact with a side of the plate 304 forming a base of the cavity 326. In some examples, the carbon foam 306 may be formed as a continuous monolithic piece, while in other examples, the carbon foam 306 may be formed as two or more carbon foam sections. In an exemplary embodiment, the carbon foam 306 may be conductive, permeable, and porous, providing a distribution field for the electrolyte being gravity fed therethrough from the plurality of electrolyte inlet passages 314a. In some examples, a pore distribution of the carbon foam 306 may be between 10 and 100 PPI. In one example, the pore distribution may be 30 PPI. In additional or alternative examples, a permeability of the carbon foam 306 may be between 0.02 and 0.5 mm². As such, each of the pore distribution and the permeability, in addition to an overall size, of the carbon foam 306 may be selected to target a relatively small pressure drop and thereby induce convection of the electrolyte from the carbon foam 306 into the positive electrode 308. For example, the pressure drop may be targeted to between 2 to 3 mm of electrolyte head rise.

In some examples, the carbon foam 306 may be replaced with a flow field plate configured to transport the electrolyte into the positive electrode 308 via convection induced by a flow field configuration of the flow field plate. Specifically, the flow field plate may be fluidically coupled to each of the plurality of electrolyte inlet passages 314a and the electrolyte outlet channel section 316. In one example, the flow field plate may be integrally formed in the plate 304 of the electrode assembly 302, positioned beneath the positive electrode 308 with respect to the z-axis. In other examples, the flow field plate may be a separate, removable component.

In some examples, and as described in detail below with reference to FIGS. 5A-5D, the flow field configuration may be an interdigitated flow field configuration, a partially interdigitated flow field configuration, or a serpentine flow field configuration. In some examples, each electrode assembly 302 may interface with a flow field configuration of like configuration (e.g., interdigitated, partially interdigitated, serpentine, etc.) as each other electrode assembly 302. In other examples, a number of different flow field configurations may be provided among the electrode assemblies 302 in the stack of electrode assemblies (e.g., dependent upon a location of a given electrode assembly 302 in the rebalancing cell 202 of FIGS. 2A and 2B). In this way, the electrolyte may be directed from the electrolyte inlet port (e.g., the electrolyte inlet port 206 of FIGS. 2A and 2B) to the flow field plates respectively interfacing with the positive electrodes 308 in the stack of electrode assemblies, the flow field plates being configured in interdigitated flow field configurations, partially interdigitated flow field configurations, serpentine flow field configurations, or a combination thereof.

In certain examples, and as discussed in greater detail below with reference to FIGS. 4A and 4B (see also FIGS. 8A-8D), in addition to the carbon foam 306 being replaced with the flow field plate (also referred to herein as an “electrolyte flow field plate”), another flow field plate (also referred to herein as a “hydrogen gas flow field plate”) may interface with the negative electrode 310 opposite from the positive electrode 308 with respect to the z-axis. However, in other examples, only the electrolyte flow field plate may be included (e.g., replacing the carbon foam 306) and no hydrogen gas flow field plate may be present. In still other examples, only the hydrogen gas flow field plate may be included (e.g., interfacing with the negative electrode 310) and no electrolyte flow field plate may be present.

The positive electrode 308 may be positioned in the cavity 326 in face-sharing contact with a side of the carbon foam 306 opposite from the plate 304 along the z-axis. In an exemplary embodiment, the positive electrode 308 may be a wicking conductive carbon felt, sponge, or mesh which may bring the electrolyte flowing through the carbon foam 306 into contact with the negative electrode 310 via capillary action. Accordingly, in some examples, the positive electrode 308 may be conductive and porous (though less porous than the carbon foam 306 in such examples). In one example, the electrolyte may be wicked into the positive electrode 308 when the porosity of the carbon foam 306 is within a predefined range (e.g., below an upper threshold porosity so as to retain enough solid material to promote wicking up and into the positive electrode 308 and above a lower threshold porosity so as to not impede electrolyte flow through the carbon foam 306). In an additional or alternative example, each of a sorptivity of the positive electrode 308 may decrease and a permeability of the positive electrode 308 may increase with an increasing porosity of the positive electrode 308 (e.g., at least until too little solid material of the positive electrode 308 remains to promote wicking of the electrolyte, such as when a critical porosity of the positive electrode 308 is reached). In some examples, surfaces of the positive electrode 308 may be sufficiently hydrophilic for desirable rebalancing cell operation (e.g., by facilitating thorough electrolyte wetting and thereby forming an ionically conductive medium). In such examples, an overall hydrophilicity of the positive electrode 308 may be increased by coating or treating the surfaces thereof. Further, though at least some of the H₂ gas may pass into the positive electrode 308 in addition to a portion of the electrolyte wicked into the positive electrode 308, the positive electrode 308 may be considered a separator between a bulk of the H₂ gas thereabove and a bulk of the electrolyte therebelow.

In some examples, each of the positive electrode 308 and the negative electrode 310 may be formed as a continuous monolithic piece (e.g., as opposed to discrete particles or a plurality of pieces), such that interphase mass-transport losses across boundary layer films may be reduced when bringing the electrolyte into contact with the H₂ gas at the catalytic surfaces of the negative electrode 310, thereby promoting ionic and proton movement. In contrast, a packed bed configuration including discretely packed catalyst particles may include mass-transport limiting boundary layer films surrounding each individual particle, thereby reducing a rate of mass-transport of the electrolyte from a bulk thereof to surfaces of the particles.

The negative electrode 310 may be positioned in the cavity 326 in face-sharing contact with a side of the positive electrode 308 opposite from the carbon foam 306 along the z-axis, such that a three-phase contact interface between the (wicked) electrolyte, the catalytic surfaces of the negative electrode 310, and the H₂ gas may be formed for proton (e.g., H⁺) and ionic movement (H₃O⁺) therethrough. In tandem, the positive electrode 308 may reduce an overall electronic resistance by providing a conductive path for electrons to move into the electrolyte front and reduce Fe³⁺ ions thereat.

In an exemplary embodiment, the negative electrode 310 may be a porous non-conductive material or a conductive carbon substrate with a metal catalyst coated thereon. In some examples, the porous non-conductive material may include polytetrafluoroethylene (PTFE), polypropylene, or the like. In some examples, the conductive carbon substrate may include carbon cloth or carbon paper. In some examples, the metal catalyst may include a precious metal catalyst. In some examples, the precious metal catalyst may include Pt. In additional or alternative examples, the precious metal catalyst may include Pd, Rh, Ru, Ir, Ta, or alloys thereof. In some examples, a relatively small amount (e.g., 0.2 to 0.5 wt %) of the precious metal catalyst supported on the conductive carbon substrate may be employed for cost considerations. In practice, however, the amount of the precious metal catalyst is not particularly limited and may be selected based on one or more of a desired rate of reaction for the rebalancing cell and an expected lifetime of the rebalancing cell. Furthermore, alloys included in the precious metal catalyst may be utilized to reduce cost and increase a corrosion stability of the precious metal catalyst. For example, 10% addition of Rh to Pt may reduce corrosion of Pt by Fe³⁺ by over 98%. In other examples, the metal catalyst may include a non-precious metal catalyst selected for stability in ferric solution and other such acidic environments (e.g., molybdenum sulfide). In one example, the negative electrode 310 may include carbon cloth coated with 1.0 mg/cm² Pt and may include a microporous layer bound with a polytetrafluoroethylene (PTFE) binder (e.g., for hydrophobicity). Indeed, inclusion of the PTFE binder may increase a durability of rebalancing cell performance over extended durations relative to electrode assemblies formed using other binders.

In some examples, such as when the precious metal catalyst includes Pt, soaking of the negative electrode 310 may eventually result in corrosion of the precious metal catalyst. In other examples, and as discussed in greater detail above with reference to FIGS. 2A and 2B, the electrode assembly 302 (along with the stack of electrode assemblies and the entire rebalancing cell) may be tilted or inclined with respect to a surface on which the rebalancing cell rests (e.g., the z-axis may be non-parallel with a direction of gravity) such that the precious metal catalyst may remain relatively dry as flow of the electrolyte is drawn through the carbon foam 306 toward the electrolyte outlet channel section 316 via gravity feeding. Thus, in some examples, the electrode assembly 302 may either be horizontal or inclined with respect to the surface on which the rebalancing cell rests at an angle of between 0° and 30°.

In an exemplary embodiment, the electrode assembly 304, including each of the carbon foam 306, the positive electrode 308, and the negative electrode 310, may be under compression along the z-axis, with the positive electrode 308 having a greater deflection than the carbon foam 306 and the negative electrode 310 under a given compressive pressure. Accordingly, a depth of the cavity 326 may be selected based on a thickness of the carbon foam 306, a thickness of the positive electrode 308, a desired compression of the positive electrode 308, and a thickness of the negative electrode 310. Specifically, the depth of the cavity 326 may be selected to be greater than a lower threshold depth of a sum of the thickness of the carbon foam 306 after substantially complete compression thereof and the thickness of the positive electrode 308 after substantially complete compression thereof (to avoid overstressing and crushing of the carbon foam 306, which may impede electrolyte flow) and less than an upper threshold depth of a sum of the thickness of the carbon foam 306 and the thickness of the positive electrode 308 (to avoid zero compression of the positive electrode 308 and possibly a gap, which may result in insufficient contact of the H₂ gas and the electrolyte). For instance, in an example wherein the thickness of the carbon foam 306 is 6 mm, the thickness of the positive electrode 308 is 3.4 mm, the desired compression of the positive electrode 308 is 0.4 mm (so as to achieve a desired compressive pressure of 0.01 MPa), and the thickness of the negative electrode 310 is 0.2 mm, the depth of the cavity 326 may be 9.2 mm (=3.4 mm+6 mm+0.2 mm−0.4 mm). As another example, the thickness of the carbon foam 306 may be between 2 and 10 mm, the thickness of the positive electrode 308 may be between 1 and 10 mm, the desired compression of the positive electrode 308 may be between 0 and 2.34 mm (so as to achieve the desired compressive pressure of 0 to 0.09 MPa), and the thickness of the negative electrode 310 may be between 0.2 and 1 mm, such that the depth of the cavity 326 may be between 0.86 and 21 mm. In additional or alternative examples, the thickness of the positive electrode 308 may be 20% to 120% of the thickness of the carbon foam 306. In one example, the thickness of the positive electrode 308 may be 100% to 110% of the thickness of the carbon foam 306. In one example, the depth of the cavity 326 may further depend upon a crush strength of the carbon foam 306 (e.g., the depth of the cavity 326 may be increased with decreasing crush strength). For instance, a foam crush factor of safety (FOS) may be 5.78 when the depth of the cavity 326 is 9.2 mm (e.g., when the desired compression of the positive electrode is 0.4 mm). The foam crush FOS may have a minimum value of 0.34 in some examples, where foam crush FOS values less than 1 may indicate that at least some crushing is expected. In some examples, the crush strength of the carbon foam 306 may be reduced by heat treatment of the carbon foam 306 during manufacturing thereof (from 0.08 MPa to 0.03 MPa, in one example). It will be appreciated that the electrode assembly 302 may be configured such that the depth of the cavity 326 is as low as possible (e.g., within the above constraints), as generally thinner electrode assemblies 302 may result in a reduced overall size of the rebalancing cell and a reduced electrical resistance across the electrode assembly 302 (e.g., as the electrolyte flow may be closer to the negative electrode 310).

In this way, the electrode assembly 302 may include a sequential stacking of the carbon foam 306 and an interfacing pair of the positive electrode 308 and the negative electrode 310 being in face-sharing contact with one another and being continuously electrically conductive. Specifically, a first interface may be formed between the positive electrode 308 and the carbon foam 306 and a second interface may be formed between the positive electrode 308 and the negative electrode 310, the second interface being opposite to the first interface across the positive electrode 308, and each of the carbon foam 306, the positive electrode 308, and the negative electrode 310 may be electrically conductive. Accordingly, the electrode assembly 302 may be internally shorted, such that electric current flowing through the electrode assembly 302 may not be channeled through an external load.

In an exemplary embodiment, and as discussed above, forced convection may induce flow of the H₂ gas into the electrode assembly 302 and across the negative electrode 310 (e.g., via a flow field plate interfacing with the negative electrode 310; not shown at FIG. 3). Thereat, the H₂ gas may react with the catalytic surface of the negative electrode 310 via equation (4a) (e.g., the reverse reaction of equation (1)):

½H₂→H⁺+e⁻ (anodic half reaction) (4a)

The proton (H⁺) and the electron (e⁻) may be conducted across the negative electrode 310 and into the positive electrode 308. The electrolyte, directed through the electrode assembly 302 via the carbon foam 306, may be wicked into the positive electrode 308. At and near the second interface between the positive electrode 308 and the negative electrode 310, Fe³⁺ in the electrolyte may be reduced via equation (4b):

Fe³⁺+e⁻→Fe²⁺ (cathodic half reaction) (4b)

Summing equations (4a) and (4b), the electrolyte rebalancing reaction may be obtained as equation (4):

Fe³⁺+½H₂→Fe²⁺+H⁺ (electrolyte rebalancing) (4)

Since the electrode assembly 302 is internally shorted, a cell potential of the electrode assembly 302 may be driven to zero as:

0=(Eₚₒₛ−E_{neg})−(η_{act}+ηₘₜ+ηₒₕₘ) (7)

where Eₚₒₛ is a potential of the positive electrode 308, E_{neg} is a potential of the negative electrode 310, η_{act} is an activation overpotential, ηₘₜ is a mass transport overpotential, and ηₒₕₘ is an ohmic overpotential. For the electrode assembly 302 as configured in FIG. 3, ηₘₜ and η_{act} may be assumed to be negligible. Further, ηₒₕₘ may depend on an overpotential η_{electrolyte} of the electrolyte and an overpotential η_{felt} of the carbon felt forming the positive electrode 308 as:

ηₒₕₘ=η_{electrolyte}+η_{felt} (8)

Accordingly, performance of the electrode assembly 302 may be limited at least by an electrical resistivity σ_{electrolyte} of a the electrolyte and an electrical resistivity σ_{felt} of the carbon felt. The electrical conductivity of the electrolyte and the electrical conductivity of the carbon felt may further depend on a resistance R_{electrolyte} of the electrolyte and a resistance R_{felt} of the carbon felt, respectively, which may be given as:

R_{electrolyte}=σ_{electrolyte}×t_{electrolyte}/A_{electrolyte} (9)

R_{felt}=σ_{felt}×t_{felt}/A_{felt} (10)

where t_{electrolyte} is a thickness of the electrolyte (e.g., a height of the electrolyte front), t_{felt} is a thickness of the carbon felt (e.g., the thickness of the positive electrode 308), A_{electrolyte} is an active area of the electrolyte (front), and A_{felt} is an active area of the carbon felt. Accordingly, the performance of the electrode assembly 302 may further be limited based on a front location of the electrolyte within the carbon felt and therefore the distribution of the electrolyte across the carbon foam 306 and an amount of the electrolyte wicked into the carbon felt forming the positive electrode 308.

After determining R_{electrolyte} and R_{felt}, an electric current I_{assembly} of the electrode assembly 302 may be determined as:

I_{assembly}=(Eₚₒₛ−E_{neg})/(R_{electrolyte}+R_{felt}) (11)

and a rate v_{rebalancing} of the electrolyte rebalancing reaction (e.g., the rate of reduction of Fe³⁺) may further be determined as:

v_{rebalancing}=I_{assembly}/(nFA_{rebalancing}) (12)

where n is a number of electrons flowing through the negative electrode 310, F is Faraday's constant, and A_{rebalancing} is an active area of the electrolyte rebalancing reaction (e.g., an area of an interface between the electrolyte front and the negative electrode 310). As an example, for an uncompressed carbon felt having t_{felt}=3 mm, v_{rebalancing} may have a maximum value of 113 mol/m² hr.

Referring now to FIGS. 4A and 4B, a cross-sectional view 400 and a magnified inset view 450 are respectively shown, each of the cross-sectional view 400 and the magnified inset view 450 depicting exemplary aspects of H₂ gas flow within the rebalancing cell 202. Specifically, the magnified inset view 450 magnifies a portion of the cross-sectional view 400 delimited by a dashed ellipse 410. As shown in FIGS. 4A and 4B, the rebalancing cell 202 may include an electrode assembly stack 402 formed as a stack of individual electrode assemblies 302 aligned such that the hydrogen gas inlet channel section 318a of each electrode assembly 302 forms a continuous hydrogen gas inlet channel 404 with the hydrogen gas inlet channel section 318a of each other electrode assembly 302. A hydrogen gas inlet plenum 406 may further be included in the hydrogen gas inlet channel 404, the hydrogen gas inlet plenum 406 fluidically coupling the hydrogen gas inlet channel 404 to the hydrogen gas inlet port 210. Respective hydrogen gas inlet channel O-rings 322a and overboard O-rings 324 may seal the hydrogen gas inlet channel 404 at interfaces between pairs of the electrode assemblies 302. It will be appreciated that cut portions of the rebalancing cell 202 are depicted in the cross-sectional view 400 and the magnified inset view 450 for detail, and that additional features of the rebalancing cell 202 (e.g., shown in FIGS. 2A and 2B) may not be depicted. Further, it will be appreciated that greater or fewer electrode assemblies 302 may be included in the electrode assembly stack 402 than shown in the cross-sectional view 400 for a given application (however, in some examples, scale-up performance may be substantially insensitive to H₂ gas flow at or below 50% H₂ gas utilization). Further, though structural features of the hydrogen gas inlet channel 404 and adjacent components are described in detail with reference to FIGS. 4A and 4B, it will be appreciated that structural features of a corresponding hydrogen gas outlet channel [e.g., formed by aligning a hydrogen gas outlet channel section 318b (see FIG. 3) of each electrode assembly 302] and adjacent components may be similarly configured (excepting that the hydrogen gas outlet channel may be dead ended or that a hydrogen gas outlet plenum included in the hydrogen gas outlet channel may be positioned opposite to the hydrogen gas inlet plenum 406 along the x- and z-axes).

As shown, and as indicated by arrows 408a, the H₂ gas may enter the hydrogen gas inlet channel 404 via the hydrogen gas inlet port 210, flowing first into the hydrogen gas inlet plenum 406 and then sequentially through the hydrogen gas channel inlet sections 318a in a positive direction along the z-axis. A size and a shape of the hydrogen gas inlet plenum 406 is not particularly limited, though a minimum size (e.g., a minimum volume, a minimum flow path width) of the hydrogen gas inlet plenum 406 may be selected to avoid relatively high flow velocity and pressure drop resulting in poor H₂ gas distribution. Further, the sloped support 220 may tilt the rebalancing cell 202 such that the hydrogen gas inlet channel 404 extends along the positive direction of the z-axis away from a direction of gravity (though not directly opposite to the direction of gravity, as discussed in detail above with reference to FIGS. 2A and 2B), and the H₂ gas may convect along the hydrogen gas inlet channel 404 along the positive direction of the t-axis.

As further shown, and as indicated by arrows 408b, at least some of the H₂ gas may flow from the hydrogen gas inlet channel 404 across the hydrogen gas inlet channel seal insert 320a of each respective electrode assembly 302 and into one or more hydrogen gas inlet passages 452 fluidically coupled to the hydrogen gas inlet channel 404 and interfacing with each respective electrode assembly 302. In this way, each electrode assembly 302 included in the electrode assembly stack 402 may be fluidically coupled to each other electrode assembly stack 302 included in the electrode assembly stack 402 via the hydrogen gas inlet channel 404. In one example, a surface of the hydrogen gas inlet channel seal insert 320a of a given electrode assembly 302 opposite to the one or more hydrogen gas inlet passages 452 of the given electrode assembly 302 may be coincident with the same x-y plane as a surface of the negative electrode 310 of the given electrode assembly 302 opposite to the one or more hydrogen gas inlet passages 452 of the given electrode assembly. Further, in some examples, the hydrogen gas inlet channel seal insert 320a of the given electrode assembly 302 may extend from a locus of affixation or coupling with the plate 304 of the given electrode assembly 302 and partially overlap the positive electrode 308 of the given electrode assembly 302 along the z-axis, thereby assisting in sealing the positive electrode 308 at an edge thereof.

In an exemplary embodiment, the one or more hydrogen gas inlet passages 452 may not be wholly included in any given electrode assembly 302 and instead may be formed as one or more gaps between adjacent pairs of electrode assemblies 302 in the electrode assembly stack 402. In some examples, the one or more hydrogen gas inlet passages 452 interfacing with a given electrode assembly 302 may be configured in a flow field configuration, such that the H₂ gas may be forcibly convected into the one or more hydrogen gas inlet passages 452 interfacing with the given electrode assembly 302. Specifically, and as described in detail below with reference to FIGS. 8A-8D, the one or more hydrogen gas inlet passages 452 as configured in the flow field configuration may be formed from a flow field plate interfacing with the negative electrode 310 of the given electrode assembly 302. In one example, the flow field plate interfacing with the negative electrode 310 of the given electrode assembly 302 may be integrally formed in the plate 304 of an adjacent electrode assembly 302, positioned beneath the carbon foam 306 of the adjacent electrode assembly 302 with respect to the z-axis. In other examples, the flow field plate interfacing with the negative electrode 310 of the given electrode assembly 302 may be a separate, removable component. Additionally, a topmost flow field plate with respect to the z-axis may not be integrally formed with any electrode assembly 302 and may instead be included in the rebalancing cell 202 as either a separate, removable component or an integral feature of another component (e.g., the cell enclosure 204 of FIGS. 2A and 2B).

In some examples, and as described in detail below with reference to FIGS. 5A-5D, the flow field configuration may be an interdigitated flow field configuration, a partially interdigitated flow field configuration, or a serpentine flow field configuration. In some examples, each electrode assembly 302 may interface with a flow field configuration of like configuration (e.g., interdigitated, partially interdigitated, serpentine, etc.) as each other electrode assembly 302. In other examples, a number of different flow field configurations may be provided among the electrode assemblies 302 of the electrode assembly stack 402 (e.g., dependent upon a location of a given electrode assembly 302 in the rebalancing cell 202). In this way, the H₂ gas may be directed from the hydrogen gas inlet port 210 to the flow field plates respectively interfacing with the negative electrodes 310 of the electrode assembly stack 402, the flow field plates being configured in interdigitated flow field configurations, partially interdigitated flow field configurations, serpentine flow field configurations, or a combination thereof.

As further shown, and as indicated by arrows 408c, the H₂ gas may be convected across the negative electrodes 310 of the electrode assembly stack 402 (e.g., at a flow rate of 10 to 50 l/min per m² of the catalytic surfaces of the negative electrode 310). In some examples, the flow field plates interfacing with the respective electrode assemblies 302 may assist in the convection and distribute the H₂ gas across the respective negative electrodes 310. The H₂ gas may react with the catalytic surfaces of the negative electrodes 310 of the electrode assembly stack 402 in an anodic half reaction (see equation (4a)) to generate protons and electrons, which may then flow towards respective positive electrodes 308 and carbon foams 306. In some examples, at least some of the H₂ gas may remain unreacted and may flow across the negative electrodes 310 of the electrode assembly stack 402 along the arrows 408c as well.

Referring now to FIGS. 5A-5D, schematic views 500, 520, 540, and 560 are respectively shown, the schematic views 500, 520, 540, and 560 respectively depicting an exemplary interdigitated flow field configuration, an exemplary partially interdigitated flow field configuration, a first exemplary serpentine flow field configuration, and a second exemplary serpentine flow field configuration. In an exemplary embodiment, the one or more hydrogen gas inlet passages 452 of FIGS. 4A and 4B may be formed from a flow field plate configured as any of the exemplary flow field configurations of FIGS. 5A-5D for a given electrode assembly. In an additional or alternative embodiment, the carbon foam 306 of FIGS. 3-4B, 6A, and 6B may be replaced with a flow field plate configured as any of the exemplary flow field configurations of FIGS. 5A-5D for a given electrode assembly. A set of reference axes 501 is provided for describing relative positioning of the components shown and for comparison between the views of FIGS. 5A-5D, the axes 501 indicating an x-axis, a y-axis, and a z-axis. It will be appreciated that the relative dimensions shown in FIGS. 5A-5D are exemplary and that other flow field configurations are considered within the scope of the present disclosure (e.g., having wider passages, a greater number of passages or bends therein, etc.). For example, passages forming the flow field configurations may include a series of steps therein (e.g., eight steps, though a total number of the steps may be increased or decreased to alter fluid diffusion and thereby improve performance for a given application) incrementally extending in height from an inlet of the passage to an outlet or end of the passage (e.g., from substantially zero height to at or near a total depth of the passage).

As shown in the schematic view 500 of FIG. 5A, the exemplary interdigitated flow field configuration may include a first inlet channel 506a and a second inlet channel 506b. A fluid (e.g., H₂ gas, electrolyte) may flow through each of the first and second inlet channels 506a and 506b parallel to the z-axis, wherefrom the fluid may be forcibly convected over end walls 508 and into passages 502 of the interdigitated flow field configuration parallel to the x-axis (as indicated by arrows 504). In some examples, when the exemplary interdigitated flow field configuration interfaces with a porous medium (such as the positive electrode 308 or the negative electrode 310 of FIGS. 3-4B), substantially all of the fluid may pass into the porous medium after being forcibly convected into the passages 502 (e.g., rather than passing from one of the inlet channels 506a, 506b to the other). As shown, each of the passages 502 may be open to only one of the first and second inlet channels 506a and 506b. However, in some examples, the second inlet channel 506b may be fluidically coupled to the first inlet channel 506a elsewhere. Accordingly, in one example, the second inlet channel 506b may serve as an outlet channel for the fluid (e.g., the fluid may flow first through the first inlet channel 506a and then through the second inlet channel 506b following passage of the fluid through the porous medium). In an additional or alternative example, the outlet channel for the fluid may not be either of the inlet channels 506a, 506b. For instance, the outlet channel may be a pressure release outlet port, such as the pressure release outlet port 214 of FIG. 2A, through which the fluid may flow following passage of the fluid through the porous medium. In certain examples wherein the fluid is H₂ gas and the porous medium is the negative electrode 310 of FIGS. 3-4B, the fluid may sequentially pass through the negative electrode 310, enter flowing electrolyte on the other side of the negative electrode 310, and be expelled via the pressure release outlet port 214 (fluidically coupled to the flowing electrolyte).

As shown in the schematic view 520 of FIG. 5B, the exemplary partially interdigitated flow field configuration may include a first inlet channel 526a and a second inlet channel 526b. A fluid (e.g., H₂ gas, electrolyte) may flow through each of the first and second inlet channels 526a and 526b parallel to the z-axis, wherefrom the fluid may be forcibly convected into constricted inlets 522a bisecting end walls 528 of passages 522 of the partially interdigitated flow field configuration parallel to the x-axis (as indicated by arrows 524). In some examples, when the exemplary partially interdigitated flow field configuration interfaces with a porous medium (such as the positive electrode 308 or the negative electrode 310 of FIGS. 3-4B), and though each of the passages 522 may be open to each of the first and second inlet channels 526a and 526b, substantially all of the fluid may pass into the porous medium after being forcibly convected into the passages 522 via the constricted inlets 522a (e.g., rather than passing from one of the inlet channels 526a, 526b to the other). A thickness of each of the constricted inlets 522a may be variable, ranging from a greatest thickness of a corresponding passage 522 (e.g., a straight-channel flow field configuration, wherein the inlets 522a are substantially unconstricted) to substantially zero thickness (e.g., a fully interdigitated flow field configuration, such as the exemplary interdigitated flow field configuration of FIG. 5A).

As shown in the schematic view 540 of FIG. 5C, the first exemplary serpentine flow field configuration may include an inlet channel 546a and an outlet channel 546b. A fluid (e.g., H₂ gas, electrolyte) may flow through the inlet channel 546a parallel to the z-axis, wherefrom the fluid may be forcibly convected into an inlet 542a of a serpentine passage 542 of the first exemplary flow field configuration parallel to the x-axis. As indicated by arrows 544, the fluid may flow along the serpentine passage 542 parallel to the x- and y-axes, altering direction at 90° bends therein until the fluid is expelled from the outlet 542b of the serpentine passage 542 into the outlet channel 546b. As further shown, the first exemplary serpentine flow field configuration may include longer straight sections of the serpentine pas sage 542 parallel to the y-axis and shorter straight sections (e.g., bases of U-bends) of the serpentine passage 542 parallel to the x-axis. In additional or alternative examples, multiple serpentine passages 542 of like or similar configuration may fluidically couple the inlet channel 546a to the outlet channel 546b. In some examples, when the first exemplary serpentine flow field configuration interfaces with a porous medium (such as the positive electrode 308 or the negative electrode 310 of FIGS. 3-4B), and though the serpentine passage 542 may be open to each of the inlet channel 546a and the outlet channel 546b, substantially all of the fluid may pass into the porous medium after being forcibly convected into the serpentine passage 542 via the inlet 542a (e.g., rather than passing from the inlet channel 546a to the outlet channel 546b). In one example, however, the serpentine passage 542 may not include the outlet 542b and thus may not fluidically couple to the outlet channel 546b (e.g., such as when the first exemplary serpentine flow field configuration is dead ended).

As shown in the schematic view 560 of FIG. 5D, the second exemplary serpentine flow field configuration may include an inlet channel 566a and an outlet channel 566b. A fluid (e.g., H₂ gas, electrolyte) may flow through the inlet channel 566a parallel to the z-axis, wherefrom the fluid may be forcibly convected into an inlet 562a of a serpentine passage 562 of the second exemplary flow field configuration parallel to the x-axis. As indicated by arrows 564, the fluid may flow along the serpentine passage 562 parallel to the x- and y-axes, altering direction at 90° bends therein until the fluid is expelled from the outlet 562b of the serpentine passage 562 into the outlet channel 566b. As further shown, the second exemplary serpentine flow field configuration may include longer straight sections of the serpentine passage 562 parallel to the x-axis and shorter straight sections (e.g., bases of U-bends) of the serpentine passage 562 parallel to the y-axis. In additional or alternative examples, multiple serpentine passages 562 of like or similar configuration may fluidically couple the inlet channel 566a to the outlet channel 566b. In some examples, when the second exemplary serpentine flow field configuration interfaces with a porous medium (such as the positive electrode 308 or the negative electrode 310 of FIGS. 3-4B), and though the serpentine passage 562 may be open to each of the inlet channel 566a and the outlet channel 566b, substantially all of the fluid may pass into the porous medium after being forcibly convected into the serpentine passage 562 via the inlet 562a (e.g., rather than passing from the inlet channel 566a to the outlet channel 566b). In one example, the serpentine passage 562 may not include the outlet 562b and thus may not fluidically couple to the outlet channel 566b (e.g., such as when the second exemplary serpentine flow field configuration is dead ended).

Referring now to FIGS. 6A and 6B, a cross-sectional view 600 and a magnified inset view 650 are respectively shown, each of the cross-sectional view 600 and the magnified inset view 650 depicting exemplary aspects of electrolyte flow within the rebalancing cell 202. Specifically, the magnified inset view 650 magnifies a portion of the cross-sectional view 600 delimited by a dashed ellipse 610. As shown in FIGS. 6A and 6B, the rebalancing cell 202 may include one or more electrolyte inlet channels 614 fluidically coupled to the electrolyte inlet wells 312 included in the individual electrode assemblies 302 of the electrode assembly stack 402. Each of the one or more electrolyte inlet channels 614 may be fluidically coupled to an electrolyte inlet plenum 606a located above the electrode assembly stack 402 with respect to the z-axis via a respective nozzle or orifice 612 modulating, restricting, or otherwise controlling flow of the electrolyte into the respective electrolyte inlet channel 614. In this way, each electrode assembly 302 included in the electrode assembly stack 402 may be fluidically coupled to each other electrode assembly stack 302 included in the electrode assembly stack 402 via the electrolyte inlet plenum 606a and the one or more electrolyte inlet channels 614. The electrolyte inlet plenum 606a may further be fluidically coupled to the electrolyte inlet port (e.g., the electrolyte inlet port 206 of FIGS. 2A and 2B; not shown at FIGS. 6A and 6B). The electrode assembly stack 402 may further be formed as a stack of the individual electrode assemblies 302 aligned such that the electrolyte outlet channel section 316 of each electrode assembly forms a continuous electrolyte outlet channel 604 with the electrolyte outlet channel section 316 of each other electrode assembly 302, the electrolyte outlet channel 604 being parallel to the one or more electrolyte inlet channels 614 and to the z-axis and on an opposite end of the rebalancing cell 202 from the one or more electrolyte inlet channels 614 with respect to the y-axis. An electrolyte outlet plenum 606b may further be included in the electrolyte outlet channel 604, the electrolyte outlet plenum 606b fluidically coupling the electrolyte outlet channel 604 to the electrolyte outlet port 208. Respective overboard O-rings 324 may seal the electrolyte outlet channel 604 at interfaces between pairs of electrode assemblies 302. It will be appreciated that cut portions of the rebalancing cell 202 are depicted in the cross-sectional view 600 and the magnified inset view 650 for detail, and that additional features of the rebalancing cell 202 (e.g., shown in FIGS. 2A and 2B) may not be depicted. Further, it will be appreciated that greater or fewer electrode assemblies 302 may be included in the electrode assembly stack 402 than shown in the cross-sectional view 600 for a given application.

The electrolyte may enter the electrolyte inlet plenum 606a via the electrolyte inlet port, wherefrom the electrolyte may be directed into the one or more electrolyte inlet channels 614 via the one or more orifices 612, respectively. In some examples, a cross-sectional shape of the electrolyte inlet plenum 606a may be selected for ease of machining. As an example, the cross-sectional shape of the electrolyte inlet plenum 606a may be rectangular. As another example, the cross-sectional shape of the electrolyte inlet plenum 606a may be circular. A size of the electrolyte inlet plenum 606a may be selected to realize a relatively low pressure drop upon entry of the electrolyte into the rebalancing cell 202.

In some examples, a size of each of the one or more orifices 612 may be between 3 and 10 mm, as dependent on a total number of electrode assemblies 302 in the electrode assembly stack 402, an overall size of the rebalancing cell 202, and an electrolyte flow path design. The size and overall configuration of each of the one or more orifices 612 may be selected to maintain substantially even electrolyte flow throughout each electrode assembly 302 of the electrode assembly stack 402.

In some examples, each of the one or more electrolyte inlet channels 614 may be a continuous and unbroken channel configured adjacent to the electrode assembly stack 402. In other examples, each electrode assembly 302 of the electrode assembly stack 402 may include one or more electrolyte inlet channel sections corresponding to the one or more electrolyte inlet channels 614, respectively. In such examples, the electrode assemblies 302 of the electrode assembly stack 402 may be aligned such that the one or more electrolyte inlet channel sections of each electrode assembly 302 respectively form the one or more electrolyte inlet channels 614 with the one or more electrolyte inlet channel sections of each other electrode assembly 302.

In some examples, the one or more electrolyte inlet channels 614 may include a plurality of electrolyte inlet channels 614 and the one or more orifices 612 may include a plurality of orifices 612 respectively fluidically coupled to the plurality of electrolyte inlet channels 614, such that an electrolyte inlet manifold may be formed. In the cross-sectional view 600 of FIG. 6A, only a nearest electrolyte inlet channel 614 of the plurality of electrolyte inlet channels 614 is visible, obscuring each other electrolyte inlet channel 614 of the plurality of electrolyte inlet channels 614 aligned therewith parallel to the x-axis. In some examples, each of the plurality of electrolyte inlet channels 614 forming the electrolyte inlet manifold may be respectively fluidically coupled to a single electrode assembly 302 of the electrode assembly stack 402 so as to evenly flow the electrolyte across the electrode assemblies 302 of the electrode assembly stack (e.g., at an electrolyte flow rate of ˜10-40 L/min per m² of the catalytic surfaces of the negative electrode 310).

In some examples, the electrolyte entering the electrolyte inlet plenum 606a may have an adjustable flow rate (e.g., by a controller of the redox flow battery system, such as the controller 88 of FIG. 1, executing instructions stored in non-transitory memory thereof) such that even distribution of the electrolyte into and within the rebalancing cell 202 may be controllably adjusted based on a given application. In certain examples, electrolyte flow distribution between individual electrode assemblies 302 of the electrode assembly stack 402 may be correspondingly adjusted based on adjustments to the electrolyte flow rate of the electrolyte entering the electrolyte inlet plenum 606a.

In other examples, each of the plurality of electrolyte inlet channels 614 may be fluidically coupled to each and every electrode assembly 302 of the electrode assembly stack 402 so as to evenly distribute the electrolyte across the electrode assembly stack 402 with respect to both the x- and y-axes. In alternative examples, the one or more electrolyte inlet channels 614 may include only one electrolyte inlet channel 614 which may be fluidically coupled to each and every electrode assembly 302 of the electrode assembly stack 402.

In some examples, a cross-sectional shape of each of the one or more electrolyte inlet channels 614 may be a circle. However, the cross-sectional shape of each of the one or more electrolyte inlet channels 614 is not particularly limited and other geometric shapes may be employed. A size of each of the one or more electrolyte inlet channels 614 may be selected to realize a relatively low pressure drop for the electrolyte flow rate of ˜10-40 L/min per m² of the catalytic surfaces of the negative electrode 310 (e.g., relatively small sizes may result in poor distribution of the electrolyte) while maintaining practical size considerations of the rebalancing cell 202 as a whole (e.g., relatively large sizes may result in an undesirably large rebalancing cell 202). In one example, the cross-sectional shape of each of the one or more electrolyte inlet channels 614 may be a circle having a diameter of between 10 and 30 mm.

Upon entering the one or more electrolyte inlet channels 614, a pressure therein may be substantially similar to a pressure of an electrolyte source (e.g., the negative and positive electrode compartments 22 and 20 and/or the integrated multi-chambered electrolyte storage tank 110 of FIG. 1), such that gravity may substantially exclusively drive electrolyte flow through the one or more electrolyte inlet channels 614. Specifically, and as indicated by arrows 608a, the electrolyte may flow through the one or more electrolyte inlet channels 614 in a negative direction along the z-axis and into the electrolyte inlet wells 312 of the electrode assembly stack 402. The sloped support 220 may tilt the rebalancing cell 202 such that the z-axis is offset from the axis g coincident with the direction of gravity, and the electrolyte may flow through the carbon foams 306 of the electrode assembly stack 402 via gravity feeding (as indicated by arrows 608b).

As further shown, and as indicated by arrows 608c, while flowing through the carbon foams 306 of the electrode assembly stack 402, at least some of the electrolyte may be induced into the positive electrodes 308 of the electrode assembly stack 402 towards the negative electrodes 310 of the electrode assembly stack 402 via capillary action. Fe³⁺ ions in the electrolyte may be reduced by electrons flowing through the negative electrodes 310 of the electrode assembly stack 402 in a cathodic half reaction (see equation (4b)) to generate Fe²⁺ ions. For each electrode assembly 302 of the electrode assembly stack 402, to ensure that no gap is present between the positive electrode 308 and the negative electrode 310 (which may result in a decreased Fe³⁺ reduction rate), a depth 652 of the cavity (e.g., the cavity 326 of FIG. 3) may be selected such that the positive electrode 308 is at least partially compressed without excessively compressing the carbon foam 306 (which may buckle and degrade a foam structure thereof). Accordingly, to minimize compression of the carbon foam 306 in each electrode assembly 302 of the electrode assembly stack 402, a thickness 654 of the adjacent positive electrode 308 may be decreased (e.g., by about 10%) relative to when the positive electrode 308 is fully uncompressed. In some examples, for each electrode assembly 302 of the electrode assembly stack 402, the thickness 654 of the positive electrode 308 may be 20% to 120% of the thickness 656 of the carbon foam 306, where each of the thickness 654 of the positive electrode 308 and the thickness 656 of the carbon foam 306 may be selected based on structural considerations such as the permeability of the carbon foam 306, an overall size of the positive electrode 308, etc. In one example, for each electrode assembly 302 of the electrode assembly stack 402, the thickness 654 of the positive electrode 308 may be 100% to 110% of the thickness 656 of the carbon foam 306.

As further shown, and as indicated by arrows 608d, after flowing through the carbon foams 306 of the electrode assembly stack 402, the electrolyte may be directed through electrolyte outlet passages 658 of the electrode assembly stack 402, into the electrolyte outlet channel 604, and out through the electrolyte outlet port 208 therefrom. Specifically, for each given electrode assembly 302 of the electrode assembly stack 402, the electrolyte may flow from the carbon foam 306 through the electrolyte outlet passage 658 and into the electrolyte outlet channel section 316, wherefrom the electrolyte may flow with the direction of gravity (e.g., along the positive direction of the axis g) into the electrolyte outlet plenum 606b (after passing through any further electrolyte outlet channel sections 316 interposed between the given electrode assembly 302 and the electrolyte outlet plenum 606b). The electrolyte may then pass through the electrolyte outlet plenum 606b and into the electrolyte outlet port 208, wherefrom the electrolyte may be expelled from the rebalancing cell 202. In this way, the electrolyte may be directed from the electrolyte inlet port (e.g., the electrolyte inlet port 206 of FIGS. 2A and 2B; not shown at FIGS. 6A and 6B) through the carbon foams 306 of the electrode assembly stack 402 to the electrolyte outlet port 208.

In some examples, an overall size of each of the electrolyte outlet passages 658 may be selected so as to be sufficiently large to generate a suitable pressure drop and to not overfill the electrolyte outlet plenum 606b (which may flood the electrode assemblies 302 at a bottom of the electrode assembly stack 402 with respect to the z-axis). Accordingly, in such examples, the overall size of each of the electrolyte outlet passages 658 may depend on an overall size of the electrolyte outlet plenum 606b and an overall number of openings corresponding to the electrolyte outlet port 208. In other examples, dimensions of the electrolyte outlet plenum 606b may be larger to accommodate an electrolyte outlet port 208 having fewer, larger openings. In examples wherein the electrolyte outlet port 208 is positioned on the face of the cell enclosure 204 facing the negative direction of the z-axis, larger openings may be accommodated while maintaining a thickness of a lowest electrode assembly 302 along the z-axis and the pressure drop may be further reduced (e.g., as the electrolyte would not flow at a ˜90° angle from the electrolyte outlet plenum 606b to the electrolyte outlet port 208).

As further shown, flow field plates 626 may respectively interface with the electrode assemblies 302 of the electrode assembly stack 402. In some examples, the flow field plate 626 may interface (e.g., be in face-sharing contact) with the negative electrode 310 of a given electrode assembly 302 and may be integrally formed in the plate 304 of an adjacent electrode assembly 302, positioned beneath the carbon foam 306 of the adjacent electrode assembly 302 with respect to the z-axis. In other examples, the flow field plate 626 interfacing with the negative electrode 310 of the given electrode assembly 302 may be a separate, removable component. Additionally, and as further shown, a topmost flow field plate 626 with respect to the z-axis may not be integrally formed with any electrode assembly 302 and may instead be included in the rebalancing cell 202 as either a separate, removable component or an integral feature of another component (e.g., the cell enclosure 204 of FIGS. 2A and 2B).

In an exemplary embodiment, the one or more hydrogen gas inlet passages 452, configured to flow the H₂ gas across a given electrode assembly 302, may be formed from the flow field plate 626 interfacing with the negative electrode 310 of the given electrode assembly 302. For instance, the one or more hydrogen gas inlet passages 452 may be configured as either a plurality of hydrogen gas inlet passages 452 parallel to one another and the x-axis (e.g., in the interdigitated flow field configuration or the partially interdigitated flow field configuration) or a single, coiled hydrogen gas inlet passage 452 into which the H₂ gas may enter parallel to the x-axis (e.g., in the serpentine flow field configuration). In some examples, the one or more hydrogen gas inlet passages 452 may extend parallel to the x-axis while the electrolyte may flow through the carbon foam 306 of the given electrode assembly 302 parallel to the y-axis (as indicated by the arrows 608b). Accordingly, in such examples, the H₂ gas may be directed into the electrode assembly stack 402 at a 90° angle from which the electrolyte may be directed into the electrode assembly stack 402.

In additional or alternative examples, the carbon foam 306 of a given electrode assembly 302 may be replaced with a flow field plate of substantially similar flow field configuration to the flow field plate 626. In one such example, the flow field configuration of the flow field plate replacing the carbon foam 306 of the given electrode assembly 302 may be oriented in the same direction as the flow field configuration of the flow field plate 626 with respect to the x- and y-axes. In another such example, the flow field configuration of the flow field plate replacing the carbon foam 306 of the given electrode assembly 302 may be oriented in a different direction as the flow field configuration of the flow field plate 626 (e.g., at a 90° angle, a 180° angle, or a 270° angle) with respect to the x- and y-axes.

Referring now to FIGS. 7A and 7B, perspective views 700 and 750 are respectively shown, each of the perspective views 700 and 750 depicting aspects of electrolyte flow through an exemplary electrode assembly 702 for a rebalancing cell of a redox flow battery system. As shown, the electrode assembly 702 may include a sequential stacking of a carbon foam 706, a positive electrode 708, and a negative electrode 710, where the carbon foam 706 and the positive electrode 708 may be in face-sharing contact with one another, the positive electrode 708 may be in face-sharing contact with the negative electrode 710, and the sequential stacking may be continuously electrically conductive. In some embodiments, a stack of the electrode assemblies 702 may be implemented in the rebalancing cell 202 in place of the electrode assemblies 302 of the electrode assembly stack 402 (see FIGS. 2A-4B, 6A, and 6B). Accordingly, the redox flow battery system may be the redox flow battery system 10 of FIG. 1. A set of reference axes 701 is provided for describing relative positioning of the components shown and for comparison between the views of FIGS. 7A and 7B, the axes 701 indicating an x-axis, a y-axis, and a z-axis. As further shown in dashing in FIG. 7B, an additional axis g may be parallel with a direction of gravity (e.g., in a positive direction along the axis g) and a vertical direction (e.g., in a negative direction along the axis g and opposite to the direction of gravity).

As shown, the electrode assembly 702 may include a sequential stacking of a carbon foam 706, a positive electrode 708, and a negative electrode 710 on a plate 704, where the plate 704 may be in face-sharing contact with the carbon foam 706, the carbon foam 706 may be in face-sharing contact with the positive electrode 708, and the positive electrode 708 may be in face-sharing contact with the negative electrode 710. As further shown in the perspective view 750 of FIG. 7B, the carbon foam 706 may be retained in place by a plurality of holders 766. Accordingly, an overall size of the carbon foam 706 may be selected to be clearance fit to the plurality of holders 766. Each of the carbon foam 706 and the positive electrode 708 may be porous and continuously electrically conductive with the negative electrode 710. Specifically, in an exemplary embodiment, the carbon foam 706 may be an activated conductive carbon foam, the positive electrode 708 may be a conductive carbon felt, and the negative electrode 710 may be a conductive carbon substrate with a Pt catalyst coated thereon. Accordingly, in some examples, the carbon foam 706, the positive electrode 708, and the negative electrode 710 may be the carbon foam 306, the positive electrode 308, and the negative electrode 310 of FIG. 3, respectively. Accordingly, in one example, the carbon foam 706 may be replaced with a flow field plate for convecting the electrolyte across the electrode assembly 702 and into contact with the positive electrode 708.

In addition to an electrolyte inlet well 712 for receiving the electrolyte (e.g., from an electrolyte inlet port of the rebalancing cell), the plate 704 may include a plurality of inlets and outlets therethrough for directing flows of the H₂ gas and the electrolyte. For example, the plurality of inlets and outlets may include a hydrogen gas inlet channel section 718a for receiving the H₂ gas (e.g., from a hydrogen gas inlet port of the rebalancing cell), a hydrogen gas outlet channel section 718b for expelling the H₂ gas (e.g., through a hydrogen gas outlet port of the rebalancing cell), and one or more electrolyte outlet passages 716 for expelling the electrolyte (e.g., through one or more electrolyte outlet ports of the rebalancing cell respectively accepted by and fitted to the one or more electrolyte outlet passages 716, the one or more electrolyte outlet ports configured as one or more fusion-welded plumbing flanges in an exemplary embodiment).

As further shown, the electrolyte inlet well 712 may be fluidically coupled to the sequential stacking of the carbon foam 706, the positive electrode 708, and the negative electrode 710 via a plurality of electrolyte inlet passages 714a set in a berm 714b extending parallel to the x-axis. Specifically, the plurality of electrolyte inlet passages 714a may be distributed across the berm 714b, a length of each of the plurality of electrolyte inlet passages 714a extending parallel to the y-axis. In some examples, and as shown in the perspective view 750 of FIG. 7B, an electrolyte trough 764 may further be interposed between the berm 714b and the sequential stacking of the carbon foam 706, the positive electrode 708, and the negative electrode 710. In this way, the electrolyte inlet well 712, the plurality of electrolyte inlet passages 714a, the berm 714b, and the electrolyte trough 764 may be configured for distributing the electrolyte across the sequential stacking of the carbon foam 706, the positive electrode 708, and the negative electrode 710.

In some examples, an overall number of the plurality of electrolyte inlet passages 714a may be selected based on a target pressure drop of between 0.5 to 3 mm of electrolyte head rise (which may in turn be a function of an electrolyte flow rate and an overall size of the electrode assembly 702). In some examples, a shape of each of the plurality of electrolyte inlet passages 714a may be rectangular (e.g., for ease of manufacturing). However, the shape of each of the plurality of electrolyte inlet passages 714a is not particularly limited and other geometries may be employed.

In an exemplary embodiment, and as indicated by arrows 708a, the electrolyte inlet well 712 may receive the electrolyte from the electrolyte inlet port (e.g., the electrolyte inlet port 206 of FIGS. 2A and 2B). As the electrolyte distributes throughout the electrolyte inlet well 712, the electrolyte may collect against the berm 714b and flow thereacross via the plurality of electrolyte inlet passages 714a and into the electrolyte trough 764. As the electrolyte further distributes throughout the electrolyte trough 764, the electrolyte may flow therefrom through the carbon foam 706 (as indicated by arrows 708b). While flowing through the carbon foam 706, and as indicated by arrows 708c, the positive electrode 708 may wick up (e.g., against the direction of gravity) at least some of the electrolyte towards the negative electrode 710, whereat ions in the electrolyte may be reduced by electrons flowing through the negative electrode 710 (e.g., from decomposition of the H₂ gas at the negative electrode 710). After flowing through the carbon foam 706, and as indicated by arrows 708d, the electrolyte may flow through the one or more electrolyte outlet passages 716, wherefrom the electrolyte may be expelled from the rebalancing cell via the electrolyte outlet port (e.g., the electrolyte outlet port 208 of FIGS. 2A and 2B).

As further shown in FIG. 7B, the electrode assembly 702 may be tilted relative to the direction of gravity so as to induce electrolyte flow therethrough along the y-axis via gravity feeding. Thus, in some examples, the z-axis may either be aligned with or offset from the vertical direction opposite to the direction of gravity at an angle of 0° to 30° such that the y-axis may not be orthogonal to the axis g.

Referring now to FIGS. 8A-8D, perspective views 800, 825, and 850 and a cross-sectional view 875 are respective shown, each of the perspective views 800, 825, and 850 and the cross-sectional view 875 depicting a flow field plate 826 of an exemplary electrode assembly 802 for a rebalancing cell of a redox flow battery system are respectively shown. As shown, the flow field plate 826 may be integrally formed in a plate 804 of the electrode assembly 802, the flow field plate 826 being configured to convect H₂ gas through passages thereof. In some embodiments, a stack of the electrode assemblies 802 may be implemented in a rebalancing cell 202 in place of the electrode assemblies 302 of the electrode assembly stack 402 (see FIGS. 2A-4B, 6A, and 6B). Accordingly, the redox flow battery system may be the redox flow battery system 10 of FIG. 1. A set of reference axes 801 is provided for describing relative positioning of the components shown and for comparison between the views of FIGS. 8A-8D, the axes 801 indicating an x-axis, a y-axis, and a z-axis.

As shown, the flow field plate 826 may be formed in the plate 804 adjacent to an electrolyte outlet channel section 816 of the plate 804 and in fluidic communication with each of a hydrogen gas inlet channel section 818a and a hydrogen gas outlet channel section 818b of the plate 804. Specifically, the flow field plate 826 may include a plurality of inlet passages 852a, each of the plurality of inlet passages 852a being fluidically coupled to the hydrogen gas inlet channel section 818a. The flow field plate 826 may further include a plurality of outlet passages 852b, each of the plurality of outlet passages 852b being fluidically coupled to a hydrogen gas outlet channel section 818b of the plate 804. As further shown, the plurality of inlet passages 852a may be interdigitated with the plurality of outlet passages 852b, each passage of the plurality of inlet passages 852a and the plurality of outlet passages 852b being separated from each of at least one adjacent passage by a passage wall 856. In this way, the flow field plate 826 may be considered to be configured as an interdigitated flow field configuration (however, it will be appreciated that the flow field plate 826 may be configured as an alternative flow field configuration, such as a partially interdigitated flow field configuration or a serpentine flow field configuration). Specifically, the plurality of inlet passages 852a may extend along a positive direction of the x-axis, while the plurality of outlet passages 852b may extend along a negative direction of the x-axis, each passage of the plurality of inlet passages 852a and the plurality of outlet passages 852b terminating at an end wall 854.

As shown in the cross-sectional view 875 of FIG. 8D, each passage of the plurality of inlet passages 852a and the plurality of outlet passages 852b may have a uniform height 858 and a uniform thickness 860. Additionally or alternatively, each passage wall 856 may have the height 858 and a uniform thickness 862. In some examples, the height 858 may be between 1 mm and 5 mm, the thickness 860 may be between 1 mm and 5 mm, and the thickness 862 may be between 1 mm and 4 mm. However, it will be appreciated that non-uniform dimensions may be employed for the passages and passage walls, such that individual passages may have differing heights and/or thicknesses, individual passage walls may have differing heights and/or thicknesses, etc.

In an exemplary embodiment, the flow field plate 826 may be integrally formed in the electrode assembly 802 opposite to a surface 868 of the plate 804 with respect to the z-axis, the surface 868 including a sequential stacking of a carbon foam, a positive electrode, and a negative electrode (not shown at FIGS. 8A-8D) thereon. The electrode assembly 802 may further be included in a stack of electrode assemblies 802 of like configuration. Specifically, a given electrode assembly 802 may be aligned with other electrode assemblies 802 such that the flow field plate 826 of the given electrode assembly 802 may be in face-sharing contact with a negative electrode of an adjacent electrode assembly 802 and such that the hydrogen gas inlet channel sections 818a of the stack of electrode assemblies 802 may form a continuous hydrogen inlet channel (not shown at FIGS. 8A-8D) fluidically coupled to the plurality of inlet passages 852a of each flow field plate 826 of the stack of electrode assemblies 802. Accordingly, when the H₂ gas flows through the hydrogen gas inlet channel, the plurality of inlet passages 852a of the flow field plate 826 of the given electrode assembly 802 may forcibly convect the H₂ gas therethrough and across the negative electrode of the adjacent electrode assembly 802. Further, the hydrogen gas outlet channel sections 818b of the stack of electrode assemblies 802 may form a continuous hydrogen outlet channel (not shown at FIGS. 8A-8D) fluidically coupled to the plurality of outlet passages 852b of each flow field plate 826 of the stack of electrode assemblies 802.

As further shown in the cross-sectional view 875 of FIG. 8D, the plate 804 may further include one or more features to assist in distributing an electrolyte across the surface 868 and through the carbon foam (not shown at FIG. 8D) positioned on the surface 868. As an example, the plate 804 may include an electrolyte inlet well 812 in which the electrolyte may collect upon flowing to the electrode assembly 802 [e.g., via an electrolyte inlet channel (not shown at FIG. 8D)]. As another example, the plate 804 may include a berm 814b against which the electrolyte may collect, the berm 814b extending parallel to the x-axis. The berm 814b may include a plurality of electrolyte inlet passages (not shown) set therein and distributed thereacross for allowing the electrolyte to flow through the berm 814b in a positive direction of the y-axis. As another example, the plate 804 may include an electrolyte trough 864, which may collect and distribute the electrolyte flowing from the electrolyte inlet well 812 and through the berm 814b via the plurality of electrolyte inlet passages. To further assist electrolyte flow, the plate 804 may be tilted with respect to a direction of gravity, such that the electrolyte may be gravity fed along the positive direction of the y-axis and through the plurality of electrolyte inlet passages. Thus, in some examples, the z-axis may either be aligned with or offset from a vertical direction opposite to the direction of gravity at an angle of 0° to 30°. In this way, the electrolyte from the electrolyte inlet well 812 may be substantially evenly distributed across the surface 868 (e.g., through the carbon foam of the electrode assembly 802).

In additional or alternative examples, the carbon foam 306 of FIGS. 3-4B, 6A, and 6B or the carbon foam 706 of FIGS. 7A and 7B may be replaced with a flow field plate of substantially similar flow field configuration to the flow field plate 826. In one such example, the flow field configuration of the flow field plate replacing the carbon foam 306 or the carbon foam 706 may be oriented in the same direction as the flow field configuration of the flow field plate 826 with respect to the x- and y-axes. In another such example, the flow field configuration of the flow field plate replacing the carbon foam 306 or the carbon foam 706 may be oriented in a different direction as the flow field configuration of the flow field plate 826 (e.g., at a 90° angle, a 180° angle, or a 270° angle) with respect to the x- and y-axes.

Referring now to FIGS. 9A and 9B, perspective views 900 and 950 are respectively shown, each of perspective views 900 and 950 depicting the sloped support 220 of the rebalancing cell 202. As shown, an upper surface 902 of the sloped support 220 may be parallel to, or offset from, each of a lower surface 904, a back foot 906, and a front foot 908 of the sloped support 220 at the angle 222. In one example, the angle 222 may range from 0° to 30°. Accordingly, a height 910 between the back foot 906 and the upper surface 902 and a height 912 between the front foot 908 and the upper surface 902 may be the same, or may differ, depending on the angle 222. As an example, when the angle 222 is 0°, the height 910 may be equal to the height 912. As another example, and as shown, when the angle 222 is greater than 0°, the height 910 may be greater than the height 912.

In some examples, the sloped support 220 may be formed from a relatively lightweight material. For instance, the sloped support 220 may be formed from a non-corrosive material with relatively high strength-to-weight ratio and impact strength and relatively low friction. In one example, the sloped support 220 may be formed from high-density polyethylene (HDPE).

In some examples, the sloped support 220 may be adjustable in that the angle 222 may be adjusted to level the cell enclosure of the rebalancing cell (not shown at FIGS. 9A and 9B) with respect to a direction of gravity. In one example, the sloped support 220 may be removably coupled (e.g., removably fastened) to the cell enclosure such that other supports may be substituted to raise or lower than angle 222. In an additional or alternative example, an adjusting mechanism (e.g., a hinge, reversible locking elements, etc.; not shown at FIGS. 9A and 9B) may be included in the sloped support 220 to adjust the angle 222 as desired for a given application.

Referring now to FIG. 10, an example plot 1000 depicting an Fe³⁺ reduction rate as a function of a total amount of Fe³⁺ reduced in exemplary rebalancing cells is shown. Each of the rebalancing cells are independently included in all-iron hybrid redox flow battery systems of like configuration. As shown in plot 1000, an abscissa represents the total amount of Fe³⁺ reduced (in mol/m²) and an ordinate represents the Fe³⁺ reduction rate (in mol/m² hr).

As further shown in plot 1000, curves 1002, 1004, and 1006 represent the Fe³⁺ reduction rates for the various rebalancing cells. Specifically, curve 1002 represents an average Fe³⁺ reduction rate for a typical jelly roll rebalancing reactor, curve 1004 represents an average Fe³⁺ reduction rate for a first exemplary rebalancing cell, and curve 1006 represents an average Fe³⁺ reduction rate for a second exemplary rebalancing cell. Each of the first and second exemplary rebalancing cells include a stack of internally shorted electrode assemblies through which H₂ gas flows via convection and electrolyte flows via gravity feeding and capillary action. Each of the internally shorted electrode assemblies of the first and second exemplary rebalancing cells may include a sequential stacking of a carbon foam, a positive electrode, and a negative electrode. However, the negative electrodes of the first exemplary rebalancing cell include a Nafion™ binder, whereas the negative electrodes of the second exemplary rebalancing cell include a PTFE binder.

Regardless of which binder is included in the negative electrodes of the first and second exemplary rebalancing cells, both exhibit significantly improved Fe³⁺ reduction rates as compared to the typical jelly roll rebalancing reactor [which exhibits the average Fe³⁺ reduction rate of less than 5 mol/m² hr (as indicated by curve 1002)]. For the first exemplary rebalancing cell, the average Fe³⁺ reduction rate may initially be ˜60 mol/m² hr (as indicated by curve 1004) and for the second exemplary rebalancing cell, the Fe³⁺ reduction rate may be consistently at or above 50 mol/m² hr (as indicated by curve 1006). However, the average Fe³ reduction rate for the first exemplary rebalancing cell may deteriorate during extended use (as measured by the total amount of Fe³⁺ reduced). For example, the average Fe³⁺ reduction rate of the first exemplary rebalancing cell may deteriorate to less than 20 mol/m² hr after about 3000 mol/m² total Fe³⁺ is reduced (as indicated by curve 1004). However, the second exemplary rebalancing cell is shown to maintain Fe³⁺ reduction performance beyond 16000 mol/m² total Fe³⁺ reduced. In this way, when the PTFE binder is employed in manufacturing the negative electrodes for rebalancing cells instead of the Nafion™ binder, a higher cell durability may be achieved, such that higher Fe′ reduction rates may be consistently realized over extended operation of the rebalancing cells. Without wishing to be bound by theory, such differences in durability may be ascribed to lower salt buildup (which may prevent H₂ gas from reaching catalytic surfaces of negative electrodes in the exemplary rebalancing cells), chloride poisoning of the catalytic surfaces of the negative electrodes, and/or water buildup in pores of the negative electrodes.

Referring now to FIG. 11A, a flow chart of a method 1100 for operating a redox flow battery system electrically coupled to an electrical grid via a power inverter is shown. In some examples, the redox flow battery system may be configured as a redox flow battery pack including a plurality of redox flow batteries, where each of the plurality of redox flow batteries may include a separate electrolyte storage tank. As such, in some examples, the plurality of redox flow batteries may be fluidically isolated from one another, where an electrolyte and H₂ gas may be circulated through each of the plurality of redox flow batteries at a low internal pressure (e.g., a maximum pressure of the electrolyte and H₂ gas within each of the plurality of redox flow batteries may be maintained low, such as below a relatively low threshold pressure), and each of the plurality of redox flow batteries may generate power during discharge substantially independently from one another. In such examples, the plurality of redox flow batteries may be electrically coupled in series, such that an electric current may be circulated across each of the plurality of redox flow batteries and the power inverter electrically coupled thereto. In this way, the redox flow battery pack may be considered modular, in that individual redox flow batteries may be added or removed with relative ease (e.g., via electrical coupling to two adjacent redox flow batteries or to one adjacent redox flow battery and the electrical grid via the power inverter).

In an exemplary embodiment, the redox flow battery system may be the redox flow battery system of any of FIGS. 1 and 15. Accordingly, method 1100 may be considered with reference to the embodiments of FIGS. 1 and 15, alone or in combination, features or more specific embodiments of which may be described in detail with reference to FIGS. 2A-9B and 13A-13D (though it may be understood that similar methods may be applied to other systems without departing from the scope of the present disclosure). For example, method 1100 may be carried out via the controller 88 of FIG. 1, and may be stored as executable instructions at a non-transitory storage medium (e.g., memory) communicably coupled to the controller 88. Further components described with reference to FIG. 11A may be examples of corresponding components of FIGS. 1-9B, 13A-13D, and 15.

At 1102, method 1100 may include receiving a power ON request. In one example, an operator of the redox flow battery pack may manually request active operation (e.g., initiation of electrolyte flow, initiation of H₂ gas flow, and/or activation of auxiliary systems, such as heaters, pumps, etc., may be requested) of the redox flow battery pack. In another example, an external controller (e.g., associated with an external electrical system or load, such as the electrical grid) may request active operation of the redox flow battery pack. In some examples, active operation of the redox flow battery pack may include operating the redox flow battery pack in a charge mode, a discharge mode, or an idle mode. For example, when a desired power output is requested for the electrical grid (e.g., by the external controller), the redox flow battery pack may be operated in the discharge mode. Accordingly, in additional or alternative examples, at 1102, method 1100 may at least include receiving a request to switch to the discharge mode (e.g., from an inactive state or from the charge or idle modes).

At 1104, method 1100 may include circulating or cycling the electrolyte and the H₂ gas through each of the plurality of redox flow batteries of the redox flow battery pack at the low internal pressure. Specifically, the low internal pressure may include the maximum pressure of the electrolyte and H₂ gas within each of the plurality of redox flow batteries being maintained less than the threshold pressure (accordingly, the threshold pressure may correspond to a similarly low pressure). In one example, the threshold pressure may be 5 psi. In another example, the threshold pressure may be 2 psi. In another example, the threshold pressure may be 1 psi. Such low pressures may be achieved by fluidically coupling, within each of the plurality of redox flow batteries, a redox flow battery cell to a rebalancing cell configured to rebalance the electrolyte at a correspondingly low H₂ gas partial pressure. As discussed above, in some examples, each of the plurality of redox flow batteries may be fluidically isolated from each other of the plurality of redox flow battery batteries. Accordingly, components within a given redox flow battery of the plurality of redox flow batteries (e.g., an electrolyte storage tank, a redox flow battery cell, a rebalancing cell, etc.) may be fluidically coupled to one another, but may be fluidically isolated from analogous components in each other of the plurality of redox flow batteries. For example, and as discussed in detail below with reference to FIG. 11B, circulating the electrolyte and the H₂ gas through the given redox flow battery of the plurality of redox flow batteries at the low internal pressure may include sequentially cycling the electrolyte from an electrolyte storage tank of the given redox flow battery through each of a redox flow battery cell of the given redox flow battery and the rebalancing cell of the given redox flow battery, and flowing the H₂ gas (e.g., simultaneously) from the electrolyte storage tank to the rebalancing cell.

In an exemplary embodiment, each of the rebalancing cells respectively included in the plurality of redox flow batteries may be the rebalancing cell of FIGS. 2A and 2B. Accordingly, each of the rebalancing cells may include a stack of internally shorted electrode assemblies (e.g., each electrode assembly including positive and negative electrodes in face-sharing contact with one another such that the positive and negative electrodes are continuously electrically conductive), such that an electric current flowing through each electrode assembly of the stack of internally shorted electrode assemblies may not be channeled through an external load, and an Fe³⁺ reduction rate may be increased and the H₂ gas partial pressure may be decreased relative to rebalancing cell setups which do not include internally shorted electrode pairs. For example, the H₂ gas partial pressure at which the rebalancing cells may be operated may be as low as 25% (e.g., corresponding to ˜7 kPa when the redox flow battery pack is operated up at 50° C.) with minimal impact on electrochemical performance. Accordingly, in some examples, the H₂ gas may be flowed from the electrolyte storage tanks respectively included in the plurality of redox flow batteries to the rebalancing cells respectively included in the plurality of redox flow batteries at a partial pressure of less than a threshold partial pressure of 25% (where the redox flow battery pack may be operated, for example, within a temperature range of room temperature (e.g., 20° C.) to 60° C.

By fluidically isolating the plurality of redox flow batteries from one another and by internally electrically shorting the electrode assemblies of the rebalancing cells respectively included in the plurality of redox flow batteries in this way, excess coupling elements (e.g., piping flange fittings, electrical couplings, etc.) between the plurality of redox flow batteries may be minimized and series electrically coupling of the redox flow battery cells respectively included in the plurality of redox flow batteries may be facilitated. In an exemplary embodiment, the redox flow battery cells may be electrically coupled in series to one another and to the power inverter.

Accordingly, at 1106, method 1100 may include circulating or cycling an electric current across the redox flow battery cells respectively included in the plurality of redox flow batteries and the power inverter. Specifically, as each of the redox flow battery cells may be operated at a potential difference of 40 to 75 V and the power inverter may be operated at a potential difference of 600 to 1000 V. Accordingly, by electrically coupling the redox flow battery cells in series, the potential difference thereacross may be ramped up such that first and last redox flow battery cells of the series electrical coupling may be directly electrically coupled to the power inverter without any intervening voltage boosting components (e.g., without any DC-to-DC boost converter). In this way, the redox flow battery pack may be configured with less components, lower cost, and less complexity as compared to a redox flow battery pack including redox flow battery cells fluidically and electrically coupled in parallel.

At 1108, method 1100 may include reversible flowing the electric current between the power inverter and the electrical grid. As such, the (series coupled) redox flow battery cells respectively included in the plurality of redox flow batteries may be configured to provide power to a high-voltage system, such as the electrical grid, via the power inverter.

At 1110, method 1100 may include determining whether a power OFF request has been received. In one example, the operator of the redox flow battery pack may manually request inactive operation (e.g., ceasing of electrolyte flow, ceasing of H₂ gas flow, and/or deactivation of auxiliary systems, such as heaters, pumps, etc., may be requested) of the redox flow battery pack. In another example, the external controller (e.g., associated with the external electrical system or load, such as the electrical grid) may request inactive operation of the redox flow battery pack. In some examples, inactive operation of the redox flow battery pack may include not operating the redox flow battery pack or operating the redox flow battery pack outside of the charge mode, the discharge mode, and the idle mode. For example, when the desired power output has been received by the electrical grid, the redox flow battery pack may be requested (e.g., by the external controller) to cease operating in the discharge mode. Accordingly, in additional or alternative examples, at 1110, method 1100 may at least include determining whether a request to switch from the discharge mode (e.g., to the inactive state or to the charge or idle modes) has been received. If the power OFF request is not received, method 1100 may return to 1104, where the electrolyte and the H₂ gas may continue to be circulated across each of the plurality of redox flow batteries (e.g., such that the electric current may continue to circulate across the redox flow battery cells respectively included in the plurality of redox flow batteries and the power inverter and thereby provide power to the electrical grid). If the power OFF request is received, method 1100 may proceed to 1112, where method 1100 may include ceasing circulating the electrolyte and the H₂ gas, and thereby the electric current (e.g., responsive to the power OFF request being received).

Referring now to FIG. 11B, a flow chart of a method 1130 for circulating an electrolyte and H₂ gas through a redox flow battery of a redox flow battery pack at a low internal pressure (e.g., a maximum pressure of the electrolyte and H₂ gas within the redox flow battery may be maintained low, such as below a relatively low threshold pressure) is shown. Specifically, the redox flow battery may be one of a plurality of redox flow batteries in the redox flow battery pack, each of the plurality of redox flow batteries having a substantially similar or equivalent configuration to one another. For example, the redox flow battery (and each of the plurality of redox flow batteries in the redox flow battery pack) may include an electrolyte storage tank (e.g., storing positive and negative electrolytes), at least one electrolyte pump (e.g., positive and negative electrolyte pumps for pumping the positive and negative electrolytes, respectively) directly fluidically coupled to the electrolyte storage tank, a redox flow battery cell directly fluidically coupled to the positive and negative electrolyte pumps, and at least one rebalancing cell (e.g., positive and negative rebalancing cells for rebalancing the positive and negative electrolytes, respectively) directly fluidically coupled to each of the redox flow battery cell and the electrolyte storage tank. As such, in some examples, in the redox flow battery, the electrolyte (e.g., inclusive of the positive and negative electrolytes) may be sequentially cycled through the electrolyte storage tank, the redox flow battery cell (e.g., pumped thereto from the electrolyte storage tank by the at least one electrolyte pump), and the at least one rebalancing cell, returning therefrom to the electrolyte storage tank. Further, in such examples, the H₂ gas may be flowed (e.g., simultaneously) from the electrolyte storage tank (e.g., from a gas head space thereof) to the at least one rebalancing cell to supply protons for rebalancing the electrolyte. As such, in one example, the redox flow battery may be fluidically isolated from each other redox flow battery of the redox flow battery pack, while each other redox flow battery of the redox flow battery pack may be similarly configured (e.g., with separate electrolyte storage tanks, electrolyte pumps, redox flow battery cells, and rebalancing cells) and fluidically isolated from one another. In this way, the redox flow battery (and each of the plurality of redox flow batteries of the redox flow battery pack) may be configured to independently circulate the electrolyte and the H₂ gas therethrough.

In an exemplary embodiment, the redox flow battery pack may be the redox flow battery system of any of FIGS. 1 and 15. Accordingly, method 1130 may be considered with reference to the embodiments of FIGS. 1 and 15, alone or in combination, features or more specific embodiments of which may be described in detail with reference to FIGS. 2A-9B and 13A-13D (though it may be understood that similar methods may be applied to other systems without departing from the scope of the present disclosure). For example, method 1130 may be carried out via the controller 88 of FIG. 1, and may be stored as executable instructions at a non-transitory storage medium (e.g., memory) communicably coupled to the controller 88. Further components described with reference to FIG. 11B may be examples of corresponding components of FIGS. 1-9B, 13A-13D, and 15.

At 1132, method 1130 may include initiating pumping of the electrolyte from the electrolyte storage tank via the at least one electrolyte pump (e.g., the positive and negative electrolyte pumps). In one example, initiating pumping of the electrolyte may be responsive to receipt of a power ON request and/or a request to switch to a discharge mode (e.g., at 1102 of method 1100, as described in detail above with reference to FIG. 11A).

At 1134, method 1130 may include circulating the electrolyte and the H₂ gas through the redox flow battery at the low internal pressure. Specifically, at 1136, method 1130 may include flowing the electrolyte through the electrolyte storage tank (e.g., from the at least one rebalancing cell and to the at least one electrolyte pump). For example, the positive electrolyte may be flowed through a positive electrolyte chamber of the electrolyte storage tank and the negative electrolyte may be flowed through a negative electrolyte chamber of the electrolyte storage tank. In some examples, the electrolyte storage tank may be rated up to an upper threshold gauge pressure of, for example, approximately 2 psi, as the at least one rebalancing cell may include a stack of internally shorted electrode assemblies and may accordingly utilize less H₂ gas to reduce greater amounts of Fe³⁺ as compared to rebalancing cell setups absent internally electrically shorted pairs of electrodes (see below). In certain examples, the upper threshold gauge pressure may be a maximum pressure capable of being handled by the electrode storage tank due to a shape and/or a composition thereof. Accordingly, in one example, a gauge pressure in the electrolyte storage tank may be maintained below 2 psi (e.g., the upper threshold gauge pressure may be 2 psi). In another example, the gauge pressure in the electrolyte storage tank may be maintained below 1 psi (e.g., the upper threshold gauge pressure may be 1 psi). In other examples, the gauge pressure in the electrolyte storage tank may be maintained below 5 psi (e.g., the upper threshold gauge pressure may be 5 psi). At such low internal pressures, the electrolyte storage tank may be configured in a range of shapes (e.g., non-cylindrical) and sizes, such that a packing density of the electrolyte storage tank may be optimized for inclusion in the redox flow battery pack (e.g., relative to larger, high-pressure, cylindrical electrolyte storage tanks.

At 1138, method 1130 may include pumping the electrolyte via the at least one electrolyte pump (e.g., from the electrolyte storage tank and to the redox flow battery cell). For example, the positive electrolyte may be pumped via the positive electrolyte pump and the negative electrolyte may be pumped via the negative electrolyte pump.

At 1140, method 1130 may include flowing the electrolyte through the redox flow battery cell (e.g., from the at least one electrolyte pump to the at least one rebalancing cell). For example, the positive electrolyte may be flowed through a positive electrode compartment of the redox flow battery cell, wherein Fe³⁺ in the positive electrolyte may be reduced during the discharge mode (see equation (6)), and the negative electrolyte may be flowed through a negative electrode compartment of the redox flow battery cell, wherein Fe⁰ may be oxidized and dissolve as Fe²⁺ in the negative electrolyte during the discharge mode (see equation (5)).

At 1142, method 1130 may include each of flowing the electrolyte through the at least one rebalancing cell (e.g., from the redox flow battery cell and to the electrolyte storage tank) and flowing the H₂ gas through the at least one rebalancing cell (e.g., from the electrolyte storage tank or another H₂ gas source). For example, the positive electrolyte may be flowed through a positive rebalancing cell and the negative electrolyte may be flowed through a negative rebalancing cell. In an exemplary embodiment, and as discussed in detail below with reference to FIG. 11C, each rebalancing cell of the at least one rebalancing cell may be the rebalancing cell of FIGS. 2A and 2B. Accordingly, each rebalancing cell of the at least one rebalancing cell may include a stack of internally shorted electrode assemblies, wherein each electrode assembly of the stack of internally shorted electrode assemblies may include an interfacing pair of positive and negative electrodes configured to drive electrolyte rebalancing of the electrolyte with the H₂ gas via internal electrical shorting. For example, the electrolyte and the H₂ gas may be flowed through a given rebalancing cell of the at least one rebalancing cells, such that the H₂ gas may react with positively charged ions in the electrolyte at respective interfaces of the positive electrodes (e.g., cathodes) of the given rebalancing cell with the negative electrodes (e.g., anodes) of each rebalancing cell of the given rebalancing cell to reduce the positively charged ions.

In some examples, such as when each rebalancing cell of the at least one rebalancing cell includes a hydrogen gas outlet port, any unreacted H₂ gas may flow from the at least one rebalancing cell back to a source of the H₂ gas (e.g., the electrolyte storage tank or another H₂ gas source). In additional or alternative examples, such as when each rebalancing cell of the at least one rebalancing cell is configured in a dead ended configuration (e.g., including no hydrogen gas outlet port), any unreacted H₂ gas may flow across negative electrodes of the at least one rebalancing cell into the electrolyte and may respectively be expelled from the at least one rebalancing cell via at least one pressure release outlet port (e.g., to atmosphere).

Referring now to FIG. 11C, a flow chart of a method 1160 for operating a rebalancing cell including a stack of internally shorted electrode assemblies (e.g., wherein electric current flowing through the stack of internally shorted electrode assemblies is not channeled through an external load) is shown. Specifically, the rebalancing cell may be implemented in a redox flow battery system for decreasing excess H₂ gas and rebalancing charge imbalances in an electrolyte therein, such that the redox flow battery system may be operated at a low internal pressure (e.g., a maximum pressure of the electrolyte and H₂ gas within the redox flow battery system may be maintained low, such as below a relatively low threshold pressure). In an exemplary embodiment, the redox flow battery system may be the redox flow battery system 10 of FIG. 1 and the rebalancing cell may be the rebalancing cell 202 of FIGS. 2A and 2B. Accordingly, method 1160 may be considered with reference to the embodiments of FIGS. 1-2B, alone or in combination with the embodiments and considerations of FIGS. 3-9B (though it may be understood that similar methods may be applied to other systems without departing from the scope of the present disclosure). For example, with method 1160, at least some steps or portions of steps (e.g., involving receiving the H₂ gas and the electrolyte for distribution at the rebalancing cell) may be carried out via the controller 88 of FIG. 1, and may be stored as executable instructions at a non-transitory storage medium (e.g., memory) communicably coupled to the controller 88. Further components described with reference to FIG. 11C may be examples of corresponding components of FIGS. 1-9B. In one embodiment, method 1160 may partially or wholly substitute 1142 in method 1130 as described in detail above at FIG. 11B. However, it will be appreciated that method 1160 constitutes one exemplary embodiment of rebalancing cell operation and that additional or alternative rebalancing cell operating methods may be implemented within the scope of this disclosure.

At 1162, method 1160 may include receiving the H₂ gas and the electrolyte at the rebalancing cell via respective inlet ports thereof. Specifically, the electrolyte may be received at the rebalancing cell via a first inlet port and the H₂ gas may be received at the rebalancing cell via a second inlet port. In one example, the first inlet port being positioned above the second inlet port with respect to a direction of gravity.

At 1164, method 1160 may include distributing the H₂ gas and the electrolyte throughout the stack of internally shorted electrode assemblies. Specifically, the electrolyte may be distributed via an inlet manifold including a plurality of first inlet channels respectively coupled to the electrode assemblies of the stack of internally shorted electrode assemblies and the H₂ gas may be distributed via a second inlet channel formed by the stack of internally shorted electrode assemblies and fluidically coupled to each electrode assembly of the stack of internally shorted electrode assemblies. In some examples, after distribution via the inlet manifold, the electrolyte may be distributed through first flow field plates respectively interfacing with positive electrodes of the stack of internally shorted electrode assemblies. In other examples, after distribution via the inlet manifold, the electrolyte may be distributed through activated carbon foams respectively interfacing with the positive electrodes. In some examples, after distribution via the second inlet channel, the H₂ gas may be distributed through second flow field plates respectively interfacing with negative electrodes of the stack of internally shorted electrode assemblies.

At 1166, method 1160 may include inducing flows (e.g., crosswise, parallel, or opposing flows) of the H₂ gas and the electrolyte at the low internal pressure to perform an electrolyte rebalancing reaction at the negative and positive electrodes of the stack of internally shorted electrode assemblies. The negative and positive electrodes may be distributed among the stack of internally shorted electrode assemblies in interfacing pairs of negative and positive electrodes. As discussed above, each positive electrode of the interfacing pairs of negative and positive electrodes may further interface with a respective activated carbon foam or a respective first flow field plate. In one example, the negative electrode may be a conductive carbon substrate having a Pt catalyst coated thereon and the positive electrode may be a carbon felt. In some examples, inducing flows of the H₂ gas and the electrolyte at the low internal pressure may include: (i) at 1168, inducing flow of the H₂ gas across the negative electrodes of the stack of internally shorted electrode assemblies via convection (e.g., forced convection via the second flow field plates interfacing with the negative electrodes of the stack of internally shorted electrode assemblies); and (ii) at 1170, inducing flow of the electrolyte across the positive electrodes of the stack of internally shorted electrode assemblies via one or more of gravity feeding (e.g., by tilting the rebalancing cell relative to a direction of gravity), capillary action (e.g., wicking up the electrolyte into the positive electrodes of the stack of internally shorted electrode assemblies), and convection (e.g., forced convection via the first flow field plates interfacing with the positive electrodes of the stack of internally shorted electrode assemblies). In one example, the flow of H₂ gas may be induced across the negative electrodes at the low internal pressure by convection and the flow of the electrolyte may be induced across the positive electrodes at the low internal pressure by each of gravity feeding and capillary action. Upon flowing the H₂ gas and the electrolyte across the negative and positive electrodes of the stack of internally shorted electrode assemblies, the electrolyte rebalancing reaction may be performed, including, at 1172, reacting the H₂ gas with positively charged ions in the electrolyte to reduce the positively charged ions (see equation (4)). When the rebalancing cell is configured as described herein, a partial pressure of the H₂ gas may be maintained at a relatively low value (e.g., below a threshold partial pressure, such as 25%) while still achieving sufficiently high reduction of the positively charged ions, such that the low internal pressure may be maintained correspondingly low, e.g., below the threshold pressure. As an example, the threshold pressure may be 5 psi. As another example, the threshold pressure may be 2 psi. As another example, the threshold pressure may be 1 psi.

At 1174, method 1160 may include expelling the electrolyte (having the reduced positively charged ions, e.g., a lower concentration of Fe³⁺ than upon being received at the first inlet port at 1162) and any unreacted H₂ gas from the rebalancing cell via outlet ports thereof. Specifically, at 1176, the electrolyte may be expelled from the rebalancing cell via a first outlet port and, in some examples, at 1178, the unreacted H₂ gas may be expelled from the rebalancing cell via a second outlet port. However, in other examples, the rebalancing cell may include a dead ended configuration for flowing the H₂ gas and no second outlet port may be included. In either case, at least some unreacted H₂ gas may flow through the negative electrodes of the stack of internally shorted electrode assemblies and into the electrolyte. Accordingly, expelling the unreacted H₂ gas from the rebalancing cell may include, at 1180, expelling the unreacted H₂ gas in the electrolyte via a pressure release outlet port (e.g., to prevent pressure from building up in the electrolyte and flooding the negative electrodes of the stack of internally shorted electrode assemblies).

Referring now to FIG. 12, an example plot 1200 depicting a normalized Fe³⁺ reduction rate as a function of an H₂ gas partial pressure in an exemplary rebalancing cell of an all-iron hybrid redox flow battery system is shown. Specifically, the normalized Fe³⁺ reduction rate refers to an Fe³⁺ reduction rate normalized against an Fe³⁺ reduction rate at an H₂ gas partial pressure of 25% (as indicated by dashed line 1204). As shown in plot 1200, an abscissa represents the H₂ gas partial pressure (in %) and an ordinate represents the Fe³⁺ reduction rate (in %), where curve 1202 represents the Fe³⁺ reduction rate as a function of the H₂ gas partial pressure.

Curve 1202 indicates that up to the H₂ gas partial pressure of 25% (e.g., dashed line 1204), the Fe³⁺ reduction rate rises relatively sharply with increasing H₂ gas partial pressure. However, at H₂ gas partial pressures above 25%, the Fe³⁺ reduction rate levels off (maxing out at ˜150% at an H₂ gas partial pressure of 100%) with increasing H₂ gas partial pressure (specifically, and as shown, at H₂ gas partial pressures above 25%, the normalized Fe³⁺ rate may be maintained greater than 100%). As such, the exemplary rebalancing cell may be operated as low as the H₂ gas partial pressure of 25% with relatively little impact on the normalized Fe³⁺ rate (that is, an electrolyte may be sufficiently rebalanced by the rebalancing cell at the H₂ gas partial pressure of 25% to achieve expected electrochemical performance of the all-iron hybrid redox flow battery system).

Referring now to FIGS. 13A-13D, schematic perspective views 1300, 1320, 1340, and 1360 are respectively shown, the schematic perspective views 1300, 1320, 1340, and 1360 respectively depicting first, second, third, and fourth exemplary electrolyte storage tank configurations for a redox flow battery system. In an exemplary embodiment, the integrated multi-chambered electrolyte storage tank 110 of FIG. 1 may be configured as any of the exemplary electrolyte storage tank configurations of FIGS. 13A-13D. A set of reference axes 1301 is provided for describing relative positioning of the components shown and for comparison between the views of FIGS. 13A-13D, the axes 1301 indicating an x-axis, a y-axis, and a z-axis. As further shown in dashing, an additional axis g may be parallel with a direction of gravity (e.g., in a positive direction along the axis g) and a vertical direction (e.g., in a negative direction along the axis g and opposite to the direction of gravity). It will be appreciated that other electrolyte storage tank configurations are considered within the scope of the present disclosure (e.g., having smaller or larger relative dimensions, differing three-dimensional shapes, or larger numbers of inlet and outlet ports, being formed from differing materials, etc.).

As shown in the schematic perspective view 1300 of FIG. 13A, the first exemplary electrolyte storage tank configuration may include an electrolyte storage tank 1306 positioned within an outer housing 1302 of an exemplary redox flow battery system. Specifically, the electrolyte storage tank 1306 may include an external housing 1308 having one or more outlet ports 1312a and one or more inlet ports 1312b positioned therein, wherein faces of the electrolyte storage tank 1306 may be formed by faces of the external housing 1308. The external housing 1308 may be cylindrical in shape (in some examples, the external housing 1308 may be regularly cylindrical, having a circular base face parallel to a like circular top face, while in other examples, the circular base and circular top faces of the external housing 1308 may be replaced with domes), while the outer housing 1302 may be prismatic in shape (as used herein, “prismatic” may be used in the geometric sense, referring to a polyhedron having a polygonal base parallel to a like polygonal top, the polygonal base and top coupled at corresponding corners thereof via straight, sharp edges so as to include continuous polygonal cross sections parallel to the polygonal base and top; as such, “prismatic” does not refer to curvilinear shapes, such as cylinders or modified cylinders). That is, the external housing 1308 may include at least one curve, while the outer housing 1302 may include no curves and only sharp, straight edges/vertices between contacting faces. In one example, the outer housing 1302 may be shaped as a rectangular prism (as shown in FIG. 13A). Accordingly, a gap or space 1310 may exist between a curved side face of the external housing 1308 and internal surfaces 1304 of the outer housing 1302, where the gap 1310 may not be completely avoidable from a geometric perspective. Specifically, the gap 1310 may include an empty volume of space internal to the outer housing 1302 and external to the electrolyte storage tank 1306. That is, the gap 1310 may be formed from a difference in swept out volumes parallel to the x-axis, the swept out volumes defined by a non-polygonal cross-section of the external housing 1308 of the electrolyte storage tank 1306 and a polygonal cross-section of the outer housing 1302 (each of the non-polygonal and polygonal cross sections parallel to a plane defined by the y- and z-axes). In this way, flush alignment of edges of the external housing 1308 with edges of the outer housing 1302 may be precluded by the cylindrical shape of the external housing 1308. Said another way, a packing density of the electrolyte storage tank 1306 may be limited by a presence of the gap 1310.

However, in some examples, and as shown in the schematic perspective view 1300, at least one of the circular base and circular top faces of the external housing 1308 may be a flat surface configured to flushly and interchangeably receive another flat surface, such as on an electrode assembly stack of a redox flow battery cell of the exemplary redox flow battery system (not shown at FIG. 13A), a flat surface of another electrolyte storage tank (e.g., 1306) of the exemplary redox flow battery system (not shown at FIG. 13A), and one of the internal surfaces 1304. Accordingly, in one example, at least one of the circular base and circular top faces of the external housing 1308 may be parallel to at least one face of the outer housing 1302 [and/or at least one flat surface corresponding to the electrode assembly stack and/or at least one face of another electrolyte storage tank (e.g., 1306)].

As shown in the schematic perspective view 1320 of FIG. 13B, the second exemplary electrolyte storage tank configuration may include an electrolyte storage tank 1326 positioned within the outer housing 1302 of the exemplary redox flow battery system. Specifically, the electrolyte storage tank 1326 may include an external housing 1328 having one or more outlet ports 1332a and one or more inlet ports 1332b positioned therein, wherein faces of the electrolyte storage tank 1326 may be formed by faces of the external housing 1328. Each of the external housing 1328 and the outer housing 1302 may be prismatic in shape. That is, each of the external housing 1328 and the outer housing 1302 may include no curves and only sharp, straight edges/vertices between contacting faces. As an example, the outer housing 1302 and/or the external housing 1328 may be rectangular prismatic in shape, e.g., the outer housing 1302 and/or the external housing 1328 may be cuboidal in shape. Accordingly, in some examples, no gap or space may exist between at least one face of the external housing 1328 and at least one of the internal surfaces 1304 of the outer housing 1302 (that is, geometric configurations of the external housing 1328 and the outer housing 1302 may not preclude flush alignment therebetween). In one example, the outer housing 1302 may be shaped as a rectangular prism substantially similar in size to the electrolyte storage tank 1326 (as shown in FIG. 13B). In this way, a packing density of the electrolyte storage tank 1326 may be increased relative to a cylindrical or otherwise non-prismatic electrolyte storage tank (such as the electrolyte storage tank 1306 of FIG. 13A).

For example, at least one edge of the external housing 1328 may be respectively flushly aligned with and received by (e.g., in physical contact with) at least one interior edge of the outer housing 1302, such that at least two faces forming the at least one edge of the external housing 1328 may respectively flushly receive (e.g., be positioned in physical contact with) at least two of the internal surfaces 1304 forming the at least one interior edge of the outer housing 1302. In some examples, and as shown in the schematic perspective view 1320, each of the at least two faces of the external housing 1328 forming the at least one edge of the external housing 1328 may be a flat surface configured to flushly and interchangeably receive another flat surface, such as on an electrode assembly stack of a redox flow battery cell of the exemplary redox flow battery system (not shown at FIG. 13B), a flat surface of another electrolyte storage tank (e.g., 1326) of the exemplary redox flow battery system (not shown at FIG. 13B), and the internal surface 1304. Accordingly, in one example, at least one face of the external housing 1328 may be parallel to at least one face of the outer housing 1302 [and/or at least one flat surface corresponding to the electrode assembly stack and/or at least one face of another electrolyte storage tank (e.g., 1326)]. In one example, and as further shown in the schematic perspective view 1320, a shape of each of the external housing 1328 and the outer housing 1302 may independently be a rectangular prism or a cube and the external housing 1328 may be clearance fit into the housing 1302, such that five faces of the outer housing 1302 may flushly receive five faces of the external housing 1328, respectively. In this way, by configuring the external housing 1328 to be prismatic (e.g., rectangular prismatic, such as cuboidal) in shape, at least two faces of the external housing 1328 and at least one edge defined by the at least two faces of the external housing 1328 may extend to a periphery of the outer housing 1302 (e.g., to at least two faces of the internal surface 1304 and at least one interior edge defined by the at least two faces of the internal surface 1304, respectively) with substantially no gap or space therebetween.

As respectively shown in the schematic perspective view 1340 of FIG. 13C and the schematic perspective view 1360 of FIG. 13D, the third and fourth exemplary electrolyte storage tank configurations may include a plurality of electrolyte storage tanks 1346 positioned within the outer housing 1302 of the exemplary redox flow battery system. Specifically, each of the electrolyte storage tanks 1346 may include an external housing 1348 having one or more outlet ports 1352a and one or more inlet ports 1352b positioned therein, wherein faces of each of the electrolyte storage tanks 1346 may be formed by faces of the external housing 1348. Each of the external housings 1348 and the outer housing 1302 may be prismatic in shape. That is, each of the external housing 1348 and the outer housing 1302 may include no curves and only sharp, straight edges/vertices between contacting faces. As an example, the outer housing 1302 and/or each of the external housings 1348 may be rectangular prismatic in shape, e.g., the outer housing 1302 and/or each of the external housings 1348 may be cuboidal in shape. Accordingly, in some examples, no gap or space may exist between at least one face of at least one external housing 1348 and at least one of the internal surfaces 1304 of the outer housing 1302 (that is, geometric configurations of the at least one external housing 1348 and the outer housing 1302 may not preclude flush alignment therebetween). In one example, the outer housing 1302 may be shaped as a rectangular prism substantially similar in size to a two- or three-dimensional array of the plurality of electrolyte storage tanks 1346 (as shown in FIGS. 13C and 13D). Specifically, the plurality of electrolyte storage tanks 1346 may be flushly stacked as the two- or three-dimensional array of closely packed rectangular prisms or cubes with no intervening internal void, space, or volume between each of the plurality of electrolyte storage tanks 1346. In this way, a packing density of the plurality of electrolyte storage tanks 1346 may be increased relative to a plurality of cylindrical or otherwise non-prismatic electrolyte storage tanks (such as the electrolyte storage tank 1306 of FIG. 13A).

For example, at least one edge of the at least one external housing 1348 may be respectively flushly aligned with and received by (e.g., in physical contact with) at least one interior edge of the outer housing 1302, such that at least two faces forming the at least one edge of the at least one external housing 1348 may respectively flushly receive (e.g., be positioned in physical contact with) at least two of the internal surfaces 1304 forming the at least one interior edge of the outer housing 1302. In some examples, and as shown in each of the schematic perspective views 1340 and 1360, each of the at least two faces of the at least one external housing 1348 may be a flat surface configured to flushly and interchangeably receive another flat surface, such as on an electrode assembly stack 1362 of a redox flow battery cell of the exemplary redox flow battery system (e.g., one of flat surfaces 1364), a flat surface of another electrolyte storage tank 1346 of the exemplary redox flow battery system (e.g., a face of the external housing 1348 of another electrolyte storage tank 1346), and the internal surface 1304. Accordingly, in one example, at least one face of the external housing 1348 may be parallel to at least one face of the outer housing 1302 (and/or the at least one flat surface 1364 corresponding to the electrode assembly stack 1362 and/or at least one face of another electrolyte storage tank 1346). In this way, by configuring the external housing 1348 to be prismatic (e.g., rectangular prismatic, such as cuboidal) in shape, at least two faces of the external housing 1348 and at least one edge defined by the at least two faces of the external housing 1348 may extend to a periphery of the outer housing 1302 (e.g., to at least two faces of the internal surface 1304 and at least one interior edge defined by the at least two faces of the internal surface 1304, respectively) with substantially no gap or space therebetween. Further, faces of adjacent pairs of the plurality of electrolyte storage tanks 1346 may be flushly aligned with one another along any of the x-, y-, and z-axes, such that a stackability and an overall compactness of the plurality of electrolyte storage tanks 1346 may be improved.

In one example, and as further shown in the schematic perspective view 1340 of FIG. 13C, a shape of each of the external housings 1348 and the outer housing 1302 may independently be a rectangular prism or a cube and each of the external housings 1348 may be fit into the outer housing 1302 and stacked against three or four other external housings 1348 so as to receive the three or four other external housings 1348 at respective stackable surfaces and form a composite rectangular prism or cube of electrolyte storage tanks 1346. In another example, and as further shown in the schematic perspective view 1360 of FIG. 13D, a shape of each of the external housings 1348, each of the electrode assembly stacks 1362, and the outer housing 1302, may independently be a rectangular prism or a cube and each of the external housings 1348 and stacked against one electrode assembly stack 1362 and two or three other external housings 1348 so as to receive the one electrode assembly stack 1362 and two or three other external housings 1348 at respective stackable surfaces and form a composite rectangular prism or cube of electrolyte storage tanks 1346 and electrode assembly stacks 1362. In this way, each of the electrolyte storage tanks 1346 may be associated with each of the electrode assembly stacks 1362, respectively, such that a total number of the electrolyte storage tanks 1346 may be equal to a total number of the electrode assembly stacks 1362.

Each of the external housings 1308, 1328, and 1348 may house a flowing liquid electrolyte and/or gas therein, the flowing liquid electrolyte and/or gas flowing through each of the external housings 1308, 1328, and 1348 via corresponding outlet and inlet ports. Specifically, the outlet ports 1312a, 1332a, and 1352a may be configured to expel the flowing liquid electrolyte and/or gas (as respectively indicated by arrows 1314a, 1334a, and 1354a) from respective interiors of the electrolyte storage tanks 1306, 1326, and 1346 respectively enclosed by the external housings 1308, 1328, and 1348. Similarly, the inlet ports 1312b, 1332b, and 1352b may be configured to respectively receive the flowing liquid electrolyte and/or gas (as respectively indicated by arrows 1314b, 1334b, and 1354b) into the respective interiors of the electrolyte storage tanks 1306, 1326, and 1346 respectively enclosed by the external housings 1308, 1328, and 1348. As such, excepting at the outlet ports 1312a, 1332a, and 1352a and the inlet ports 1312b, 1332b, and 1352b, the external housings 1308, 1328, and 1348 may be hermetically sealed. Further, each of the outlet ports 1312a, 1332a, and 1352a and each of the inlet ports 1312b, 1332b, and 1352b may be fitted with flange fittings such that the flowing liquid electrolyte and/or gas may only enter or exit the interior of each of the electrolyte storage tanks 1306, 1326, and 1346 via piping fluidically coupling the interior to other components of the exemplary redox flow battery system (e.g., electrolyte pumps, redox flow battery cells, rebalancing cells, etc.). As such, the electrolyte storage tanks 1306, 1326, and 1346 may be considered to maintain a continuously pressurized state (e.g., of an electrolyte and/or H₂ gas flow path) without leaks.

The walls of each of the external housings 1308, 1328, and 1348 may be manufactured with a wide range of thicknesses and compositions, such that the respective electrolyte storage tanks 1306, 1326, and 1346 may be rated for a correspondingly wide range of pressures. In some examples, a thickness of each wall of each of the external housings 1308, 1328, and 1348 may be greater than a lower threshold thickness, such as 5 mm, and less than an upper threshold thickness, such as 50 mm. In one example, the thickness of each wall of each of the external housings 1308, 1328, and 1348 may be less than 10 mm. In some examples, a composition of each wall of each of the external housings 1308, 1328, and 1348 may be selected from materials ranging in structural strength, including coated metal (e.g., metal coated with PTFE), polyethylene (such as HDPE), polypropylene, reinforced polypropylene, or reinforced fiberglass. In one example, each of the external housings 1308, 1328, and 1348 may be formed from polypropylene. In another example, each of the external housings 1308, 1328, and 1348 may be formed from reinforced polypropylene.

As indicated above, each of the electrolyte storage tanks 1306, 1326, and 1346 may be rated for a wide range of pressures, as dependent on an overall configuration (e.g., shape, relative size, wall thickness, wall composition, etc.) of the external housings 1308, 1328, and 1348. In some examples, each of the electrolyte storage tanks 1306, 1326, and 1346 may be rated up to 20 psi. In one example, each of the electrolyte storage tanks 1306, 1326, and 1346 may be rated up to 2 psi. Accordingly, in such an example, a gauge pressure in each of the electrolyte storage tanks 1306, 1326, and 1346 may be maintained below 2 psi. In another example, the gauge pressure in each of the electrolyte storage tanks 1306, 1326, and 1346 may be maintained below 1 psi. (e.g., each of the electrolyte storage tanks 1306, 1326, and 1346 may be rated up to 1 psi). In another example, the gauge pressure in each of the electrolyte storage tanks 1306, 1326, and 1346 may be maintained below 5 psi (e.g., each of the electrolyte storage tanks 1306, 1326, and 1346 may be rated up to 5 psi).

As further indicated above, the integrated multi-chambered electrolyte storage tank 110 of FIG. 1 may be configured as any of the electrolyte storage tanks 1306, 1326, and 1346 or with a combination of features therefrom. Correspondingly, the components and features of the integrated multi-chambered electrolyte storage tank 110 as described in detail above with reference to FIG. 1 may be included in any of the electrolyte storage tanks 1306, 1326, and 1346. As an example, the interior of each of the electrolyte storage tanks 1306, 1326, and 1346 may be partitioned into positive and negative electrolyte chambers (such as the positive and negative electrolyte chambers 52 and 50 of FIG. 1) by a bulkhead (such as the bulkhead 98 of FIG. 1). Further, in such an example, a spillover hole (such as the spillover hole 96 of FIG. 1) may be positioned in the bulkhead of each of the electrolyte storage tanks 1306, 1326, and 1346 at a threshold height above a fill height of the flowing liquid electrolyte. In this way, a pressure of the flowing gas (e.g., H₂ gas) in a gas head space (e.g., above the fill height) in each of the electrolyte storage tanks 1306, 1326, and 1346 may be equalized via the spillover hole. Further, in situations wherein the flowing electrolyte rises above the threshold height above the fill height in one of the positive and negative electrolyte chambers of any of the electrolyte storage tanks 1306, 1326, and 1346, fill levels of the flowing electrolyte in the positive and negative electrolyte chambers may be equalized via spillover of the flowing electrolyte from the one of the positive and negative electrolyte chambers into the other one of the positive and negative electrolyte chambers.

It will be appreciated that the various components and features of FIGS. 13A-13D having substantially similar function to one another may be labeled with numbers in increments of 20 (e.g., the outlet port 1312a may have a substantially similar function to the outlet ports 1332a and 1352a). It will further be appreciated that the various components and features of FIGS. 13A-13D may differ widely in configuration than as depicted therein. As one example, though the outlet ports 1312a, 1332a, and 1352a are depicted as respectively positioned on faces of the external housings 1308, 1328, and 1348 which are normal to the x-axis, the outlet ports 1312a, 1332a, and 1352a may be positioned on any face of the external housings 1308, 1328, and 1348, respectively. Similarly, though the inlet ports 1312b, 1332b, and 1352b are depicted as respectively positioned on faces of the external housings 1308, 1328, and 1348 which are normal to the x-axis, the inlet ports 1312b, 1332b, and 1352b may be positioned on any face of the external housings 1308, 1328, and 1348, respectively. Further, though the outlet ports 1312a, 1332a, and 1352a are depicted above the inlet ports 1312b, 1332b, and 1352b, respectively, with respect to the z-axis, in other examples, the outlet ports 1312a, 1332a, and 1352a may be below the inlet ports 1312b, 1332b, and 1352b, respectively, with respect to the z-axis, or the outlet ports 1312a, 1332a, and 1352a may be at a same height as the inlet ports 1312b, 1332b, and 1352b, respectively, with respect to the z-axis. Further, though the outlet ports 1312a, 1332a, and 1352a are depicted as respectively positioned on a same face of the external housings 1308, 1328, and 1348 as the inlet ports 1312b, 1332b, and 1352b, respectively, in other examples, the outlet ports 1312a, 1332a, and 1352a may be respectively positioned on different faces of the external housings 1308, 1328, and 1348 than the inlet ports 1312b, 1332b, and 1352b, respectively. Further, though one outlet port 1312a, 1332a, and 1352a is depicted as respectively positioned on each of the external housings 1308, 1328, and 1348, in other examples, multiple outlet ports 1312a, 1332a, and 1352a may be respectively positioned on each of the external housings 1308, 1328, and 1348. Similarly, though one inlet port 1312b, 1332b, and 1352b is depicted as respectively positioned on each of the external housings 1308, 1328, and 1348, in other examples, multiple inlet ports 1312b, 1332b, and 1352b may be respectively positioned on each of the external housings 1308, 1328, and 1348.

Referring now to FIG. 14, a schematic diagram 1400 depicting a first exemplary redox flow battery system 1402 electrically coupled to an electrical grid 1418 via a plurality of DC-to-DC boost converters 1414 and a power inverter 1416 is shown. In an exemplary embodiment, the first exemplary redox flow battery system 1402 may be the redox flow battery system 100 of FIG. 1. As such, it will be appreciated that features and components of the redox flow battery system 100 as described in detail above with reference to FIG. 1 may be included in, or may replace similarly labeled features or components of, the first exemplary redox flow battery system 1402. For example, the first exemplary redox flow battery system 1402 may be an all-iron hybrid redox flow battery system.

As shown in the schematic diagram 1400, the first exemplary redox flow battery system 1402 may include an electrolyte storage tank 1404 (wherein the electrolyte storage tank 1404 may be prismatic in shape, in some examples) which expels and receives an electrolyte along respective electrolyte flow paths 1406a and 1406c. Specifically, the electrolyte may be expelled from the electrolyte storage tank 1404 along the electrolyte flow path 1406a, as pumped therealong via an electrolyte pump 1408. The electrolyte pump 1408 may distribute the electrolyte along an electrolyte flow path 1406b to each of a plurality of electrode assembly stacks 1410 in parallel. In some examples, each of the plurality of electrode assembly stacks 1410 may include one or more redox flow battery cells (each of the one or more redox flow battery cells including a redox electrode and a plating electrode) and a rebalancing cell [the rebalancing cell including a stack of internally shorted electrode assemblies, where no electrical path is present to direct electric current away from the stack of internally shorted electrode assemblies (accordingly, in an exemplary embodiment, the rebalancing cell may be the rebalancing cell 202 of FIGS. 2A-3)]. For each of the plurality of electrode assembly stacks 1410, the electrolyte may flow through the one or more redox flow battery cells and the rebalancing cell in sequence, and back to the electrolyte storage tank 1404 along the electrolyte flow path 1406c. In this way, the electrolyte may be sequentially cycled through the electrolyte storage tank 1404, the electrolyte pump 1408, and the plurality of electrode assembly stacks 1410 (e.g., through each of the plurality of electrode assembly stacks 1410 in parallel).

As the plurality of electrode assembly stacks 1410 may be arranged in a parallel flow configuration, the electrolyte flow paths 1406b and 1406c may include parallel piping lengths fluidically coupled via various piping joints (e.g., tee joints, lateral joints, cross joints, etc.). Accordingly, additional piping lengths and piping joints may be employed to add on further electrode assembly stacks 1410, while removing electrode assembly stacks 1410 may result in a reduction of piping lengths or piping joints, or a replacement of the piping altogether with shorter piping (e.g., where piping lengths cannot be reduced).

As further shown in the schematic diagram 1400, the plurality of electrode assembly stacks 1410 may be respectively electrically coupled (e.g., at positive and negative terminals of each of the one of more redox flow battery cells included therein) to the plurality of DC-to-DC boost converters 1414 in parallel via electrical paths 1412a. The plurality of DC-to-DC boost converters 1414 may further be electrically coupled to the power inverter 1416 via an electrical path 1412b. The power inverter 1416 may further be electrically coupled to the electrical grid 1418 via an electrical path 1412c. In this way, an electric current may reversibly flow between the plurality of electrode assembly stacks 1410 and the electrical grid 1418 via the plurality of DC-to-DC boost converters 1414 and the power inverter 1416.

The plurality of DC-to-DC boost converters 1414 may be included in the first exemplary redox flow battery system 1402 to ramp up an output voltage of each of the plurality of electrode assembly stacks 1410 for compatibility with the power inverter 1416. For example, each of the plurality of electrode assembly stacks 1410 may be operated within a first potential difference range (e.g., 40 to 75 V), while the power inverter 1416 may be operated within a second potential difference range higher than the first potential difference range (e.g., 600 to 1000 V, 850 to 1000 V, etc.). As such, an additional DC-to-DC boost converter 1414 may be included for each electrode assembly stack 1410 which may be added to the first exemplary redox flow battery system 1402.

It will be appreciated that, in the first exemplary redox flow battery system 1402, and as shown in the schematic diagram 1400, n electrode assembly stacks 1410 electrically coupled to n DC-to-DC boost converters 1414 are included, each of the n electrode assembly stacks 1410 and each of the n DC-to-DC boost converters 1414 being labeled with an index running from 1 to n. Further, though four electrode assembly stacks 1410 and four DC-to-DC boost converters 1414 are shown in FIG. 14, it will be appreciated that a total number of each of the plurality of electrode assembly stacks 1410 and the plurality of DC-to-DC boost converters 1414, e.g., n, may be any number greater than one.

Referring now to FIG. 15, a schematic diagram 1500 depicting a second exemplary redox flow battery system 1502 electrically coupled to an electrical grid 1518 via a power inverter 1516 is shown. In an exemplary embodiment, the second exemplary redox flow battery system 1502 may be the redox flow battery system 100 of FIG. 1. As such, it will be appreciated that features and components of the redox flow battery system 100 as described in detail above with reference to FIG. 1 may be included in, or may replace similarly labeled features or components of, the second exemplary redox flow battery system 1502. For example, the second exemplary redox flow battery system 1502 may be an all-iron hybrid redox flow battery system.

As shown in the schematic diagram 1500, the second exemplary redox flow battery system 1502 may include a plurality of electrolyte storage tanks 1504 respectively fluidically coupled to a plurality of electrode assembly stacks 1510 via a plurality of electrolyte pumps 1508, respectively. Accordingly, the second exemplary redox flow battery system 1502 may be configured as a redox flow battery pack including a plurality of redox flow batteries 1552, where each of the plurality of redox flow batteries 1552 may respectively include one of the plurality of electrolyte storage tanks 1504, one of the plurality of electrolyte pumps 1508, and one of the plurality of electrode assembly stacks 1510.

Each of the plurality of electrolyte storage tanks 1504 may be prismatic in shape (e.g., so as to increase a packing density relative to other shapes, such as regular or modified cylinders) and may expel an electrolyte along a respective one of a plurality of electrolyte flow paths 1506a and may receive the electrolyte along a respective one of a plurality of electrolyte flow paths 1506c. The plurality of electrolyte storage tanks 1504 may be respectively fluidically coupled to the plurality of electrolyte pumps 1508 via the plurality of electrolyte flow paths 1506a, respectively. Accordingly, the electrolyte may be expelled from each of the plurality of electrolyte storage tanks 1504 via a respective one of the plurality of electrolyte flow paths 1506a, as pumped therealong by a respective one of the plurality of electrolyte pumps 1508. Each of the plurality of electrolyte pumps 1508 may deliver the electrolyte to a respective one of the plurality of electrode assembly stacks 1510 via a respective one of a plurality of electrolyte flow paths 1506b. In some examples, each of the plurality of electrode assembly stacks 1510 may include one or more redox flow battery cells (each of the one or more redox flow battery cells including a redox electrode and a plating electrode) and a rebalancing cell [the rebalancing cell including a stack of internally shorted electrode assemblies, where no electrical path is present to direct electric current away from the stack of internally shorted electrode assemblies (accordingly, in an exemplary embodiment, the rebalancing cell may be the rebalancing cell 202 of FIGS. 2A-3)]. For each of the plurality of electrode assembly stacks 1510, the electrolyte may flow through the one or more redox flow battery cells and the rebalancing cell in sequence, and back to a respective one of the plurality of electrolyte storage tanks 1504 along a respective one of the plurality of electrolyte flow paths 1506c. In this way, for each of the plurality of redox flow batteries 1552, the electrolyte may be sequentially cycled through a respective one of the plurality of electrolyte storage tanks 1504, a respective one of the plurality of electrolyte pumps 1508, and a respective one of the plurality of electrode assembly stacks 1510.

As each of the plurality of redox flow batteries 1552 may include a separate electrolyte storage tank 1504, a separate electrolyte pump 1508, and a separate electrode assembly stack 1510 from each other of the plurality of redox flow batteries 1552, each of the plurality of redox flow batteries 1552 (and components included therein) may be fluidically isolated from each other of the plurality of redox flow batteries 1552 (and components included therein) in some examples. As such, a modularity of the second exemplary redox flow battery system 1502 may be improved relative to redox flow battery systems in which each electrode assembly stack is fluidically coupled in parallel (e.g., the first exemplary redox flow battery system 1402 of FIG. 14), as redox flow batteries 1552 may be added without altering an existing piping configuration and redox flow batteries 1552 may be removed without replacing piping lengths or piping joints.

As further shown in the schematic diagram 1500, the plurality of electrode assembly stacks 1510 may be electrically coupled in series, such that each of the plurality of electrode assembly stacks 1510 may be directly electrically coupled (e.g., at positive and negative terminals of each of the one of more redox flow battery cells included therein) to at least one adjacent electrode assembly stack 1510 (e.g., at positive and negative terminals each of the one of more redox flow battery cells included therein) via at least one of a plurality of electrical paths 1512b, respectively. The plurality of electrode assembly stacks 1510 may further be electrically coupled to the power inverter 1516 via electrical paths 1512a and 1512c. Specifically, the power inverter 1516 may be directly electrically coupled to each of a first electrode assembly stack 1510 (indexed in the schematic diagram 1500 with “1′”) and a last (e.g., nth) electrode assembly stack 1510 (indexed in the schematic diagram 1500 with “n′”). Accordingly, each of the plurality of electrode assembly stacks 1510 may be directly electrically coupled to two adjacent electrode assembly stacks 1510 or to one adjacent electrode assembly stack 1510 and the power inverter 1516. The power inverter 1516 may further be electrically coupled to the electrical grid 1518 via an electrical path 1512d. In this way, an electric current may be sequentially cycled across the plurality of electrode assembly stacks 1510 and the power inverter 1516, wherefrom the electric current may reversibly flow to the electrical grid 1518 (e.g., between the power inverter 1516 and the electrical grid 1518).

By electrically coupling the plurality of electrode assembly stacks 1510 in series, a potential difference thereacross may be ramped up. Accordingly, an output voltage of the second exemplary redox flow battery system 1502 may be compatible with the power inverter 1516 without any DC-to-DC boost converter being present in the second exemplary redox flow battery system 1502 (e.g., no electrical path may be present to electrically couple a DC-to-DC boost converter to any of the plurality of electrode assembly stacks 1510 or components included therein). For example, the output voltage of the plurality of (series coupled) electrode assembly stacks 1510 may be within a potential difference range at which the power inverter 1516 may be operated (e.g., 600 to 1000 V, 850 to 1000 V, etc.). As such, both a complexity and a cost of the second exemplary redox flow battery system 1502 may be reduced relative to redox flow battery systems in which one or more DC-to-DC boost converters is provided to ramp up an output voltage of electrode assembly stack(s) included therein (e.g., the first exemplary redox flow battery system 1402 of FIG. 14).

It will be appreciated that, in the second exemplary redox flow battery system 1502, and as shown in the schematic diagram 1500, n′ electrode assembly stacks 1510 fluidically coupled to n′ electrode storage tanks 1504 are included, each of the n′ electrode assembly stacks 1510 and each of the n′ electrode storage tanks 1504 being labeled with an index running from 1 to n′. Further, though four electrode assembly stacks 1510 and four electrolyte storage tanks 1504 are shown in FIG. 15, it will be appreciated that a total number of each of the plurality of electrode assembly stacks 1510 and the plurality of electrolyte storage tanks 1504, e.g., n′, may be any number greater than one.

In this way, a redox flow battery system may be configured as a pack of fluidically isolated redox flow batteries, each fluidically isolated redox flow battery respectively including a redox flow battery cell, an electrolyte storage tank, and a rebalancing cell capable of a relatively high Fe³⁺ reduction rate at a relatively low H₂ gas partial pressure. In some examples, the electrolyte storage tanks may be rated up to the relatively low H₂ gas partial pressures utilized by the rebalancing cells, such that non-cylindrical (e.g., prismatic) shapes and relatively small sizes of the electrolyte storage tanks may be selected for distribution across the redox flow battery system and to increase an overall space efficiency thereof. In one example, the fluidically isolated redox flow batteries may be electrically coupled in series. A technical effect of utilizing a series electrical coupling configuration of fluidically isolated redox flow batteries is that relatively high voltage external loads may be powered by the redox flow battery system absent a DC-to-DC boost converter. As such, each of a cost and a complexity of the redox flow battery system may be reduced, while a modularity of the redox flow battery system may be improved. Further, by including fluidically isolated redox flow batteries, stack-to-stack shunting in the redox flow battery system may be eliminated.

In one example, a redox flow battery system, comprising: a plurality of redox flow battery cells electrically coupled in series, such that each of the plurality of redox flow battery cells is directly electrically coupled to at least one adjacent redox flow battery cell, wherein each of the plurality of redox flow battery cells comprises positive and negative electrode compartments respectively housing redox and plating electrodes. A first example of the redox flow battery system further comprises a plurality of electrolyte storage tanks, wherein each of the plurality of electrolyte storage tanks is fluidically coupled to the positive and negative electrode compartments of a respective one of the plurality of redox flow battery cells. A second example of the redox flow battery system, optionally including the first example of the redox flow battery system, further includes wherein each of the plurality of electrolyte storage tanks is prismatic in shape. A third example of the redox flow battery system, optionally including one or more of the first and second examples of the redox flow battery system, further includes wherein each of the plurality of redox flow battery cells is fluidically isolated from each other of the plurality of redox flow battery cells. A fourth example of the redox flow battery system, optionally including one or more of the first through third examples of the redox flow battery system, further includes wherein no electrical path electrically coupling any one of the plurality of redox flow battery cells to a DC-to-DC boost converter is present in the redox flow battery system. A fifth example of the redox flow battery system, optionally including one or more of the first through fourth examples of the redox flow battery system, further comprises a plurality of rebalancing cells respectively fluidically coupled to the plurality of redox flow battery cells, each of the plurality of rebalancing cells comprising a stack of internally shorted electrode assemblies, where no electrical path is present in the redox flow battery system to direct electric current away from the stack of internally shorted electrode assemblies, and where each electrode assembly of the stack of internally shorted electrode assemblies is fluidically coupled in parallel. A sixth example of the redox flow battery system, optionally including one or more of the first through fifth examples of the redox flow battery system, further includes wherein the redox flow battery system is an all-iron hybrid redox flow battery system.

In another example, a system, comprising: an electrolyte subsystem; a redox flow battery cell fluidically coupled to the electrolyte subsystem; a power inverter directly electrically coupled to the redox flow battery cell; and an electrical grid directly electrically coupled to the power inverter. A first example of the system further includes wherein the redox flow battery cell operates in a first voltage range of 40 to 75 V, and wherein the power inverter operates in a second voltage range of 600 to 1000 V. A second example of the system, optionally including the first example of the system, further includes wherein the redox flow battery cell is electrically coupled to at least one additional redox flow battery cell in series. A third example of the system, optionally including one or more of the first and second examples of the system, further includes wherein the electrolyte subsystem comprises an electrolyte storage tank, and wherein the system further comprises a closed electrolyte flow path passing through the electrolyte storage tank and the redox flow battery cell. A fourth example of the system, optionally including one or more of the first through third examples of the system, further includes wherein the closed electrolyte flow path comprises a positive electrolyte flow loop and a negative electrolyte flow loop. A fifth example of the system, optionally including one or more of the first through fourth examples of the system, further includes wherein the electrolyte storage tank is partitioned into positive and negative electrolyte chambers by a bulkhead, wherein the redox flow battery cell comprises positive and negative electrode compartments respectively housing redox and plating electrodes, wherein the positive electrolyte flow loop cycles through the positive electrolyte chamber and the positive electrode compartment, and wherein the negative electrolyte flow loop cycles through the negative electrolyte chamber and the negative electrode compartment. A sixth example of the system, optionally including one or more of the first through fifth examples of the system, further includes wherein the positive and negative electrolyte chambers are fluidically coupled via a spillover hole positioned in the bulkhead. A seventh example of the system, optionally including one or more of the first through sixth examples of the system, further includes wherein the electrolyte subsystem further comprises a positive rebalancing cell, where the positive rebalancing cell comprises positive and negative electrodes in face-sharing contact with one another such that the positive and negative electrodes of the positive rebalancing cell are continuously electrically conductive, and wherein the positive electrolyte flow loop sequentially cycles through the positive electrolyte chamber, the positive electrode compartment, and the positive rebalancing cell. An eighth example of the system, optionally including one or more of the first through seventh examples of the system, further includes wherein the electrolyte subsystem further comprises a negative rebalancing cell, where the negative rebalancing cell comprises positive and negative electrodes in face-sharing contact with one another such that the positive and negative electrodes of the negative rebalancing cell are continuously electrically conductive, and wherein the negative electrolyte flow loop sequentially cycles through the negative electrolyte chamber, the negative electrode compartment, and the negative rebalancing cell.

In yet another example, a method for a redox flow battery system, the method comprising: coupling a plurality of redox flow battery cells in series; circulating an electrolyte across each of the plurality of series coupled redox flow battery cells of the redox flow battery system, where each of the plurality of series coupled redox flow battery cells is fluidically isolated from each other of the plurality of series coupled redox flow battery cells; and while the electrolyte is circulating across each of the plurality of series coupled redox flow battery cells, circulating a first electric current across the plurality of series coupled redox flow battery cells and a power inverter. A first example of the method further comprises reversibly flowing the first electric current between the power inverter and an electrical grid. A second example of the method, optionally including the first example of the method, further includes wherein the plurality of series coupled redox flow battery cells is respectively fluidically coupled to a plurality of electrolyte storage tanks of the redox flow battery system, and wherein the electrolyte circulated across each of the plurality of series coupled redox flow battery cells is further circulated across each of the plurality of electrolyte storage tanks, respectively. A third example of the method, optionally including one or more of the first and second examples of the method, further includes wherein the plurality of series coupled redox flow battery cells is respectively fluidically coupled to a plurality of rebalancing cells of the redox flow battery system, wherein the electrolyte circulated across each of the plurality of series coupled redox flow battery cells is further circulated across each of the plurality of rebalancing cells, respectively, and wherein the method further comprises, for each rebalancing cell of the plurality of rebalancing cells, flowing a second electric current across the rebalancing cell without channeling the second electric current through an external load.

FIGS. 2A-4B and 6A-9B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2A-4B and 6A-9B are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
a plurality of redox flow battery cells electrically coupled in series, such that each of the plurality of redox flow battery cells is directly electrically coupled to at least one adjacent redox flow battery cell,
wherein each of the plurality of redox flow battery cells comprises positive and negative electrode compartments respectively housing redox and plating electrodes.

2. The redox flow battery system of claim 1, further comprising a plurality of electrolyte storage tanks,
wherein each of the plurality of electrolyte storage tanks is fluidically coupled to the positive and negative electrode compartments of a respective one of the plurality of redox flow battery cells.

3. The redox flow battery system of claim 2, wherein each of the plurality of electrolyte storage tanks is prismatic in shape.

4. The redox flow battery system of claim 1, wherein each of the plurality of redox flow battery cells is fluidically isolated from each other of the plurality of redox flow battery cells.

5. The redox flow battery system of claim 1, wherein no electrical path electrically coupling any one of the plurality of redox flow battery cells to a DC-to-DC boost converter is present in the redox flow battery system.

6. The redox flow battery system of claim 1, further comprising a plurality of rebalancing cells respectively fluidically coupled to the plurality of redox flow battery cells, each of the plurality of rebalancing cells comprising a stack of internally shorted electrode assemblies, where no electrical path is present in the redox flow battery system to direct electric current away from the stack of internally shorted electrode assemblies, and where each electrode assembly of the stack of internally shorted electrode assemblies is fluidically coupled in parallel.

7. The redox flow battery system of claim 1, wherein the redox flow battery system is an all-iron hybrid redox flow battery system.

8. A system, comprising:
an electrolyte subsystem;
a redox flow battery cell fluidically coupled to the electrolyte subsystem;
a power inverter directly electrically coupled to the redox flow battery cell; and
an electrical grid directly electrically coupled to the power inverter.

9. The system of claim 8, wherein the redox flow battery cell operates in a first voltage range of 40 to 75 V, and
wherein the power inverter operates in a second voltage range of 600 to 1000 V.

10. The system of claim 8, wherein the redox flow battery cell is electrically coupled to at least one additional redox flow battery cell in series.

11. The system of claim 8, wherein the electrolyte subsystem comprises an electrolyte storage tank, and
wherein the system further comprises a closed electrolyte flow path passing through the electrolyte storage tank and the redox flow battery cell.

12. The system of claim 11, wherein the closed electrolyte flow path comprises a positive electrolyte flow loop and a negative electrolyte flow loop.

13. The system of claim 12, wherein the electrolyte storage tank is partitioned into positive and negative electrolyte chambers by a bulkhead,
wherein the redox flow battery cell comprises positive and negative electrode compartments respectively housing redox and plating electrodes,
wherein the positive electrolyte flow loop cycles through the positive electrolyte chamber and the positive electrode compartment, and
wherein the negative electrolyte flow loop cycles through the negative electrolyte chamber and the negative electrode compartment.

14. The system of claim 13, wherein the positive and negative electrolyte chambers are fluidically coupled via a spillover hole positioned in the bulkhead.

15. The system of claim 13, wherein the electrolyte subsystem further comprises a positive rebalancing cell, where the positive rebalancing cell comprises positive and negative electrodes in face-sharing contact with one another such that the positive and negative electrodes of the positive rebalancing cell are continuously electrically conductive, and
wherein the positive electrolyte flow loop sequentially cycles through the positive electrolyte chamber, the positive electrode compartment, and the positive rebalancing cell.

16. The system of claim 13, wherein the electrolyte subsystem further comprises a negative rebalancing cell, where the negative rebalancing cell comprises positive and negative electrodes in face-sharing contact with one another such that the positive and negative electrodes of the negative rebalancing cell are continuously electrically conductive, and
wherein the negative electrolyte flow loop sequentially cycles through the negative electrolyte chamber, the negative electrode compartment, and the negative rebalancing cell.

17. A method for a redox flow battery system, the method comprising:
coupling a plurality of redox flow battery cells in series;
circulating an electrolyte across each of the plurality of series coupled redox flow battery cells of the redox flow battery system, where each of the plurality of series coupled redox flow battery cells is fluidically isolated from each other of the plurality of series coupled redox flow battery cells; and
while the electrolyte is circulating across each of the plurality of series coupled redox flow battery cells, circulating a first electric current across the plurality of series coupled redox flow battery cells and a power inverter.

18. The method of claim 17, further comprising reversibly flowing the first electric current between the power inverter and an electrical grid.

19. The method of claim 17, wherein the plurality of series coupled redox flow battery cells is respectively fluidically coupled to a plurality of electrolyte storage tanks of the redox flow battery system, and
wherein the electrolyte circulated across each of the plurality of series coupled redox flow battery cells is further circulated across each of the plurality of electrolyte storage tanks, respectively.

20. The method of claim 17, wherein the plurality of series coupled redox flow battery cells is respectively fluidically coupled to a plurality of rebalancing cells of the redox flow battery system,
wherein the electrolyte circulated across each of the plurality of series coupled redox flow battery cells is further circulated across each of the plurality of rebalancing cells, respectively, and
wherein the method further comprises, for each rebalancing cell of the plurality of rebalancing cells, flowing a second electric current across the rebalancing cell without channeling the second electric current through an external load.
